(19) United States
(12) Patent Application Publication
(10) Pub. No.: US 2004/0146772 A1
(43) Pub. Date: Jul. 29, 2004

(54) Fuel cell casing, fuel cell and electronic apparatus

(75) Inventors: Takayuki Miyao, Kokubu-shi (JP); Koichiro Sugai, Kokubu-shi (JP); Akifumi Sata, Kokubu-shi (JP); Kuninori Yokomine, Kokubu-shi (JP); Hidekazu Otomaru, Kokubu-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/691,451

(22) Filed: Oct. 20, 2003

(30) Foreign Application Priority Data
Oct. 21, 2002 (JP) P2002-306283
Dec. 24, 2002 (JP) P2002-372362
Dec. 26, 2002 (JP) P2002-375757
Feb. 13, 2003 (JP) P2003-035702
Feb. 25, 2003 (JP) P2003-048347
Mar. 27, 2003 (JP) P2003-089272
Jun. 26, 2003 (JP) P2003-183145
Jun. 26, 2003 (JP) P2003-183147
Jun. 27, 2003 (JP) P2003-185919
Jul. 18, 2003 (JP) P2003-199021
Aug. 28, 2003 (JP) P2003-304797
May 28, 2003 (JP) P2003-151621
Jan. 29, 2003 (JP) P2003-021162

(51) Int. Cl. H01M 8/02; H01M 8/04

(52) U.S. Cl. 429/38; 429/26

(57) ABSTRACT

A fuel cell casing comprises a base body having a concavity for housing a membrane electrode assembly having first and second electrodes, a first fluid channel formed so as to extend from a bottom surface of the concavity facing the membrane electrode assembly to an outer surface of the base body, a first wiring conductor having its one end disposed on the bottom surface of the concavity, and its other end led out toward the outer surface of the base body, a lid body mounted on an upper surface of the base body, a second fluid channel formed so as to extend from a lower surface of the lid body to an outer surface of the lid body, and a second wiring conductor having its one end disposed on the lower surface of the lid body, and its other end led out toward the outer surface of the lid body.

### BACKGROUND OF THE INVENTION

1. Field of the Invention

The present invention relates to a fuel cell casing that is capable of accommodating a membrane electrode assembly, made of ceramics, small and highly reliable, a fuel cell using the same and electronic apparatus, and further relates to electronic apparatus having a fuel cell as a power source which fuel cell is a small, highly reliable, capable of accommodating a membrane electrode assembly and made of multilayer ceramics.

2. Description of the Related Art

In recent years, development of a compact fuel cell which is operated at lower temperature than ever before has been briskly under way. Fuel cells are classified according to their electrolytes in use. For example, there have been known Polymer Electrolyte Fuel Cell (hereinafter abbreviated to “PEFC”); Phosphoric-acid Fuel Cell; and Solid-oxide Fuel Cell.

In recent years, in accordance with an increase of functions of mobile electronic apparatus, consumed electric power has increased. Moreover, since a secondary battery needs charging after use of a fixed amount of electric power and needs a battery charger and charging time, there remain a lot of problems in long driving of mobile electronic apparatus.

From these demands, electronic apparatus such as a mobile phone or a laptop PC (personal computer) provided with a small fuel cell as a power source is proposed. A fuel cell can be used continuously as far as supply of fuel and oxygen is continued. As a small fuel cell, PEFC, a direct methanol fuel cell (referred to as a DMFC hereafter) and the like are known.

These fuel cells, whose operation temperatures are as low as approximately 80 to 100° C., have outstanding merits as follows:

(1) their power densities are high, and miniaturization and weight reduction are allowed;

(2) since an electrolyte is not corrosive, their operation temperatures are low and therefore the constitution materials of the cells are constrained little from the aspect of corrosion-resistance, cost reduction is easy; and

(3) in comparison with other fuel cells, actuation at ordinary temperatures is allowed, and therefore, actuation time is short. Therefore, making the best use of the merits as mentioned above, it has been considered to not only apply a PEFC and a DMFC to a driving power source for a vehicle, a household cogeneration system and the like but also use as a power source for mobile electronic apparatus such as a mobile phone, a PDA (personal digital assistant), a laptop PC (personal computer) or a digital camera or video whose outputs are a few watts to several tens of watts.

Roughly, a PEFC and a DMFC comprise, for example, a fuel electrode (a cathode) made of a carbon electrode on which fine particles of a catalyst such as platinum or platinum-ruthenium are attached, an air electrode (an anode) made of a carbon electrode on which fine particles of a catalyst such as platinum are attached, and a film-like membrane electrode assembly interposed between the fuel electrode and the air electrode (referred to as a membrane electrode assembly hereafter).

Here, the fuel electrode is supplied with hydrogen gas (H₂) extracted through a reforming section, whereas the air electrode is supplied with oxygen gas (O₂) present in the air. Consequently, certain electric energy is generated through an electrochemical reaction (electricity production), and thereby electric energy acting as driving power (voltage/current) for a load is produced.

Specifically, when hydrogen gas (H₂) is supplied to the fuel electrode, as shown in the following chemical equation (1), with the action of the catalyst, an electron (e⁻)-separated hydrogen ion (proton; H⁺) is generated, and the proton passes through the membrane electrode assembly toward the air electrode. Moreover, the electron (e⁻) is ejected by the carbon electrode constituting the fuel electrode and is supplied to the load.

3H₂→6H⁺+6e⁻ (1)

On the other hand, when air is supplied to the air electrode, as shown in the following chemical equation (2), with the action of the catalyst, the electron (e⁻) having passed through the load, the hydrogen ion (H⁺) having passed through the membrane electrode assembly, and oxygen gas (O₂) present in the air react with one another to form water (H₂O).

6H⁺+3/2O₂+6e⁻→3H₂O (2)

Such a series of electrochemical reactions (equations (1) and (2)) commonly take place at a relatively low temperature of 80 to 100° C. Basically, a by-product material other than electric power is water (H₂O) alone.

In the case of a DMFC, here, a methanol (CH₃OH) aqueous solution is supplied to the fuel electrode, and on the other hand, (O₂) in the air is supplied to the air electrode, whereby specific electric energy is generated by an electrochemical reaction, and electric energy to become a driving power source (voltage/current) to a load is generated.

In concrete, when a methanol (CH₃OH) aqueous solution is supplied to the fuel electrode, as shown by the following chemical reaction formula (3), hydrogen ions (proton; H⁺) from which electrons (e⁻) are separated by the catalyst are evolved and passed through to the side of the air electrode via the membrane electrode assembly, and the electrons (e⁻) are taken out by the carbon electrode constituting the fuel electrode and supplied to the load.

CH₃OH+H₂O→CO₂+6H⁺+6e⁻ (3)

On the other hand, when the air is supplied to the air electrode, as shown by the following chemical reaction formula (4), electrons (e⁻) passed through a load by the catalyst, hydrogen ions (H⁺) passed through the membrane electrode assembly, and oxygen gas (O₂) in the air react, and water (H₂O) is generated.

6H⁺+3/2O₂+6e⁻→3H₂O (4)

Such a series of electrochemical reactions (formula (3) and formula (4)) proceed under the temperature condition of relatively low temperature of room temperature to 100° C. largely, and a by-product other than electric power is only water (H₂O) basically.

As an ion conduction membrane (exchange membrane) constituting a membrane electrode assembly, a cation-exchange membrane of polystyrene-base having a sulfonic acid group, a mixed membrane of fluorocarbon sulfonic acid and polyvinylidene fluoride, a membrane obtained by grafting trifluoroethylene to fluorocarbon matrix, and the like are known, and recently, a perfluorocarbon sulfonic acid membrane (for example, Nafion: a product name, produced by DuPont) or the like is used.

In FIG. 58, the constitution of a conventional fuel cell (PEFC) is shown in a sectional view. In this view, reference numeral 1 denotes a PEFC, reference numeral 3 denotes a membrane electrode assembly, reference numerals 4, 5 denote a pair of porous electrodes that are placed on the membrane electrode assembly 3 so as to sandwich the membrane electrode assembly and that have functions as a gas diffusing layer and a catalyst layer, that is, a fuel electrode and an air electrode, reference numeral 6 denotes a gas separator, reference numeral 8 denotes a fuel duct, and reference numeral 9 denotes an air duct.

The gas separator 6 is constituted by a stacked portion and a gas input/output frame that form the outer shape of the gas separator 6, a separator portion that separates the fuel duct 8 and the air duct 9, and electrodes that are disposed so as to pierce the separator portion and placed so as to correspond to the fuel electrode 4 and the air electrode 5 of the membrane electrode assembly 3. By stacking in large numbers via the gas separators 6 so that the fuel electrodes 4 and the air electrodes 5 of the membrane electrode assemblys 3 are electrically connected in series and/or in parallel to become a stack of fuel cells as the minimum unit of a cell, and storing this stack of fuel cells in a box, a general PEFC main body is made.

Fuel gas that contains water vapor (gas that is rich in hydrogen) is supplied from a reforming device to the fuel electrode 4 through the fuel duct 8 formed in the gas separator 6 and the air is supplied as oxidant gas from the air to the air electrode 5 through the air duct 9, and electric power is generated by a chemical reaction in the membrane electrode assembly 3. Related art is disclosed in Japanese Unexamined Patent Publications JPA 2001-266910 and 2001-507501.

However, this fuel cell 1 that has been proposed and developed up to now as a high-voltage and high-capacity cell is a heavy and large cell which has a stack structure and whose constitution elements have large areas, and use of a fuel cell as a small cell has been hardly considered so far.

That is to say, the conventional gas separator 6 in the fuel cell 1 has a problem that since the side surfaces of the membrane electrode assemblys 3 are exposed outside in a stacked body made by stacking the membrane electrode assemblys 3 by the use of the gas separators, they are easily damaged because of a fall at the time of carrying, and it is hard to guarantee mechanical reliability of the whole fuel cell 1.

Further, in order to install the fuel cell 1 in mobile electronic apparatus, a fuel cell casing that is excellent in compactness, convenience and safety unlike a conventional large fuel cell casing is necessary. In other words, although it is necessary, in order to apply as a portable power source such as a general-purpose chemical cell, to miniaturize and low-profile a fuel cell casing for the purpose of shortening time for increasing temperature up to operation temperature and making a thermal capacity small, the gas separator 6 that dominates a large proportion of a thermal capacity in the conventional fuel cell 1, specifically, the gas separator 6 where the ducts are formed on the surface of a carbon plate by cutting processing becomes fragile when becoming thin-walled, and therefore, it needs thickness of a few millimeters. Therefore, there is also a problem that it is hard to miniaturize and low-profile.

Furthermore, an output voltage of the fuel cell 1 is determined by partial pressures of gases supplied to the respective electrodes 4, 5 on both faces of the membrane electrode assembly 3. That is to say, when fuel gas supplied to the membrane electrode assembly 3 goes through the gas duct 8 and is consumed in an electric power generation reaction, partial pressure of fuel gas on the face of the fuel electrode 4 decreases and an output voltage decreases. In the same manner, when the air goes through the air duct 9 and is consumed, partial pressure of oxygen on the face of the air electrode 5 decreases and an output voltage decreases. Although it is therefore necessary to supply fuel gas equally, the ducts are formed on the surface of a carbon plate by cutting processing specifically in the gas separator 6 of the conventional fuel cell 1, and therefore, grooves of the ducts become narrow at the time of low-profiling, so that there is also a problem that duct resistance becomes large and uniform fuel supply is difficult.

Further, although it is required that combinations of a plurality of membrane electrode assemblys 3, the fuel electrodes 4 and the air electrodes 5 facing thereto and the gas separators 6 are connected in series or connected in parallel arbitrarily and efficiently and the entire output voltage and output current are regulated, the conventional fuel cell 1 has also a problem that there is no method of taking out electricity from the fuel electrode and the air electrode sandwiching the membrane electrode assembly 3 other than a method of drawing outside and connecting or a method of stacking the gas separators 6 as conductive materials and connecting in series, and at the time of using by installing in mobile electronic apparatus, it is hard to connect to a motherboard or the like for forming an electronic circuit as a main part of electronic apparatus in a limited space.

Further, electronic apparatus using the conventional fuel cell 1 need a lot of components such as a collector board that takes out electricity generated in the membrane electrode assembly 3 to a motherboard or the like for forming electronic circuit as a main part of electronic apparatus, an insulative material such as silicon rubber for insulating the collector board from the housing for storing the fuel cell, and screws and clamps (not shown in the drawing) for mounting the gas separator 6, the membrane electrode assembly 3, the collector board and the insulative material to the fuel cell casing, and it has a problem that miniaturization and low-profiling are difficult.

As a method of causing the entire output voltage and output current to be regulated, a method of arranging a plurality of combinations of the membrane electrode assemblys 3, the fuel electrodes 4 and the air electrodes 5 facing thereto and the gas separators 6 on the same plane is considered. This arrangement on the same plane is effective for low-profiling as compared with the stack structure frequently used up to now, whereas it causes a problem that an insulative member for securing insulation between the adjacent membrane electrode assemblys 3 is required additionally and the parts count increases further. Moreover, there are also problems that interlayer duct processing in the plane direction to connect the adjacent fuel cells cannot be done because the ducts are processed by machining or molding, it is impossible to install electronic parts or the like in the gas separator 6 to integrate functions of an electric circuit or the like because a conductive material is used, and so on.

Further, although, at the time of mounting such a fuel cell to mobile electronic apparatus, it is necessary to provide the fuel cell with a terminal for connection to a motherboard or the like for forming an electronic circuit as a main part of the electronic apparatus and dispose a terminal corresponding to the connection terminal to the mobile electronic apparatus, there is a problem that both the terminal on the mobile electronic apparatus and the terminal on the fuel cell casing need relatively complicated designing in the structure. Besides, since, in the case of using a cartridge type of fuel cell that can be freely attached and detached from the viewpoint of convenience at the time of using and carrying the mobile electronic apparatus, it is required to devise the terminals so as to enable such free attachment and detachment, there is a problem that there are more difficulties.

Furthermore, fuel supplied to the side of the fuel electrode is consumed in accordance with electric power generation, and when the density thereof decreases, the efficiency of electric power generation also decreases. Therefore, in order to increase the efficiency of electric power generation in a fuel cell, an oxygen supplying mechanism that forcibly circulates and supplies oxygen to the air electrode and a fuel supplying mechanism that forcibly circulates and supplies fuel to the fuel electrode are needed. However, since the mechanisms for forcibly supplying oxygen and fuel becomes bulky, the whole fuel cell also becomes large, and it is unsuitable for use as a small power source for mobile electronic apparatus.

Moreover, when electricity is produced in the membrane electrode assembly 3 through a series of electrochemical reactions, the membrane electrode assembly 3 is heated to high temperatures, and simultaneously the fuel cell 1 gets hot. In this case, for example, if the hot fuel cell 1 is inadvertently touched by user's skin, a skin burn is caused. This leads to inconvenience in practice.

Further, since, in this structure, radiation of heat to the outside cannot be suppressed easily, undesirable temperature-distribution variations tend to occur in the membrane electrode assembly 3. Thus, for example, it is impossible to minimize electricity-production efficiency variation between the fuel electrode 4 and the air electrode 5 in the fuel cell 1, resulting in electricity-production variation between the fuel electrode 4 and the air electrode 5.

Further, in the fuel cell 1, there occurs a difference in temperature between the endmost-side fuel and air electrode 4, 5 and the midmost fuel and air electrode 4, 5. Specifically, the endmost fuel and air electrode 4, 5 has a lower temperature relatively to the midmost fuel and air electrode 4, 5, and is thus susceptible to unduly high humidity. Thus, the endmost fuel and air electrode 4, 5 offers poorer efficiency in electricity production, etc., as compared with the midmost fuel and air electrode 4, 5.

Moreover, in Japanese Unexamined Patent Publication JPA 8-180883 (1996) are disclosed proposes forming the gas separator 6 from a metal sheet by stamping, punching, or the like process. If a metallic gas separator is applicable, the gas separator 6 can be made thin-walled by exploiting its mechanical properties, resulting in an advantage in making the fuel cell casing both smaller in size and lower in profile. However, the use of a metallic gas separator presents the problem of susceptibility to corrosion.

Moreover, a plurality of membrane electrode assemblys 3 need to be arbitrarily connected in series or parallel with their corresponding fuel electrode 4, air electrode 5, and gas separator 6 with efficiency to adjust the output voltage and output current as a whole. In the conventional fuel cell 1, however, electric power cannot be obtained from the fuel electrode and the air electrode having sandwiched therebetween the membrane electrode assembly 3 without connecting the components externally, or connecting the components in series stackedly using the gas separator 6 as a conductive material. Inconveniently, such operations are difficult to perform in a compact fuel cell.

Further, when humidifying water vapor is supplied to the fuel duct 8 and the air duct 9, if the moisture is unduly large in quantity, water droplets are produced within the duct of the gas separator 6 due to condensation of water vapor. As the amount of the water droplets is increased, the water droplets block the fuel duct 8 and the air duct 9, resulting in difficulty in supplying fuel and air into the membrane electrode assembly 3. This hinders electrochemical reactions from taking place properly in the membrane electrode assembly 3, leading to deterioration in the electricity-production efficiency.

The phenomenon described just above tends to occur particularly in the air electrode 5-side part of the membrane electrode assembly 3 because of the presence of water (H₂O) produced through the electrochemical reaction. Thus, it is necessary to impart a condensation-discharge property to the duct to facilitate the discharge of the condensation.

Further, water (H₂O) produced through an electrochemical reaction in the membrane electrode assembly 3 blocks the air duct 9, resulting in difficulty in supplying air, obtained from atmosphere as oxidant gas, through the air duct 9 into the air electrode 5. This hinders electrochemical reactions from taking place properly in the membrane electrode assembly 3, leading to deterioration in the electricity-production efficiency.

### SUMMARY OF THE INVENTION

The invention has been devised in view of the above-described problems with the conventional art, and accordingly its object is to provide a compact, sturdy fuel cell casing capable of housing membrane electrode assemblys; a highly-reliable fuel cell casing that allows even gas supply, uniformization of temperature gradients within the fuel cell casing, highly-efficient electrical connection, and highly-efficient electricity production; and a fuel cell employing said fuel cell casing.

The invention was completed in consideration of the problems of the related art as mentioned above, and an object thereof is to provide a fuel cell casing that is capable of equal supply of fuel and highly efficient electrical connection and is reliable, and a fuel cell using the same, and electronic apparatus using the fuel cell that is small, short in height and high-performance and that allows stable use.

The invention provides a fuel cell casing comprising:

a base body made of ceramics having a concavity for housing a membrane electrode assembly formed on one surface thereof, the membrane electrode assembly having a first electrode and a second electrode disposed on one principal surface and another principal surface thereof, respectively;

a first fluid channel formed so as to extend from a bottom surface of the concavity facing the one principal surface of the membrane electrode assembly to an outer surface of the base body;

a first wiring conductor having its one end disposed on the bottom surface of the concavity facing the first electrode of the membrane electrode assembly, and its other end led out toward the outer surface of the base body;

a lid body mounted on the one surface of the base body near the concavity so as to cover the concavity, for air-tightly sealing the concavity;

a second fluid channel formed so as to extend from one surface of the lid body facing the the other principal surface of the membrane electrode assembly to an outer surface of the lid body; and

a second wiring conductor having its one end disposed on the one surface of the lid body facing the second electrode of the membrane electrode assembly, and its other end led out toward the outer surface of the lid body.

According to the invention, the fuel cell casing is composed of the membrane electrode assembly having the first and second electrodes disposed on the one and other principal surfaces thereof, respectively; the base body made of ceramics having the concavity for housing the membrane electrode assembly formed on the one surface thereof; and the lid body mounted on the one surface of the base body near the concavity so as to cover the concavity, for air-tightly sealing the concavity. With this construction, by air-tightly sealing the fuel cell casing, leakage of fluid such as gas can be prevented. Moreover, since there is no need to prepare an extra package in addition to the casing, the fuel cell can be operated with high efficiency, and miniaturization can be achieved. Further, the fuel cell is constructed by housing a plurality of membrane electrode assemblys in the casing composed of the ceramic-made base body having the concavity formed on its one surface and the lid body for sealing the concavity. With this construction, it never occurs that the membrane electrode assembly is exposed outside, and thus the casing can be protected against damage. As a result, the mechanical reliability of the fuel cell casing as a whole can be enhanced. Besides, the first and second wiring conductors, each of which has its one end disposed in the inner part of the casing composed of the concavity and the lid body, are the only components that make electrical contact with the membrane electrode assembly. This frees the membrane electrode assembly itself from unnecessary electrical connection, whereby making it possible to obtain a fuel cell which is excellent in reliability and safety. In addition, by using ceramics as a material for constituting the fuel cell casing, a fuel cell which is highly resistant to corrosion by fluid, typified by various gas, can be obtained.

Further, since first fluid channels that are formed from the bottom surface of the concavity facing the one principal surface of the membrane electrode assembly to the outer surface of the base body and second fluid channels that are formed from the one surface of the lid body facing the other principal surface of the membrane electrode assembly to the outer surface of the lid body are provided, and the respective fluid channels are disposed on the inner wall surfaces facing each other on both sides of the membrane electrode assembly, it is possible to increase uniformity of supply of a fluid supplied to the membrane electrode assembly. According to these fluid channels, since a fluid flows vertically to the membrane electrode assembly, there is an effect that in a case where, for example, a fluid is hydrogen gas and air (oxygen) gas, partial pressures of the respective gases supplied to the first and second electrodes formed on the one and other principal surfaces the membrane electrode assembly, respectively, do not decrease, and a specified stable output voltage can be obtained.

Furthermore, since pressure of a supplied fluid, for example, partial pressure of gas is stabilized, the distribution of temperatures inside the fuel cell casing becomes uniform, with the result that it is possible to control thermal stress caused in the membrane electrode assembly, and it is possible to increase reliability of a fuel cell.

Still further, since the respective fluid channels are formed in the base body and the lid body, the respective fluid channels are excellent in hermeticity, there is no possibility that a function as a fuel cell does not appear because two kinds of fluid materials (for example, oxygen gas and hydrogen gas or methanol or the like) whose ducts should be isolated originally are mixed, and there is no risk that combustible fluids are ignited and exploded after mixed at high temperatures, with the result that it is possible to provide a safe fuel cell.

In the invention, it is preferable that at least one of the first and second wiring conductors is formed around the opening of the first fluid channel disposed on the bottom surface of the concavity, or around the opening of the second fluid channel disposed on the one surface of the lid body, so as to abut against the first electrode or the second electrode.

According to the invention, at least one of the first and second wiring conductors is formed around the opening of the first fluid channel disposed on the concavity bottom surface, or around the opening of the second fluid channel disposed on the one surface of the lid body, so as to abut against the first electrode or the second electrode of the membrane electrode assembly. With this arrangement, the first or second wiring conductor can be in immediate electric contact with the entire area of the first or second electrode of the membrane electrode assembly, with the exception of the area corresponding to the first or second fluid channel. This makes it possible to increase the contact area between the first electrode of the membrane electrode assembly and the first wiring conductor, as well as the contact area between the second electrode and the second wiring conductor, and also to establish direct connection therebetween. As a result, an increase in electrical resistance and occurrence of improper contact can be effectively prevented, thus achieving a fuel cell that succeeds in providing high electricity-production efficiency.

In the invention, it is preferable that the fuel cell casing further comprises:

a heating element for heating the one or other principal surface of the membrane electrode assembly, which is formed on the periphery of at least one of the opening of the first fluid channel disposed on the bottom surface of the concavity and the opening of the second fluid channel disposed on the one surface of the lid body.

According to the invention, the heating element for heating the one or other principal surface of the membrane electrode assembly is provided on the periphery of at least one of the opening of the first fluid channel disposed on the bottom surface of the concavity and the opening of the second fluid channel disposed on the one surface of the lid body. In this case, the thermal capacity is kept small compared to the case of using a conventional gas separator. Besides, since the heating element is arranged in the region near the membrane electrode assembly, in the fuel cell, the membrane electrode assembly and the electrode can be arbitrarily temperature-adjusted with excellent responsivity and controllability. Note that, to achieve chemical reactions efficiently, the temperature of the membrane electrode assembly should preferably be raised up to 80 to 100° C. In this respect, according to the fuel cell casing embodying the invention, the use of such a heating element eliminates the addition of an extra device for raising fuel temperature. Thus, temperature control can be achieved with ease, and chemical reaction efficiency can be enhanced. Since the incorporated heating element provides remarkable temperature-control performance, the fuel cell casing of the invention is desirable particularly for a methanol-powered DMFC (Direct Methanol Fuel Cell) in which the membrane electrode assembly is cooled by a fuel to be supplied. In addition, satisfactory miniaturization and portability can be attained.

When, at the air electrode, water is produced through a chemical reaction expressed by the chemical reaction equation (2), (4) and builds up in the porous electrode, air supply is hindered, and this leads to an undesirable decrease in the chemical reaction efficiency. However, according to the fuel cell casing embodying the invention, since the build-up water evaporates by the action of the heating element, the decrease in the efficiency can be prevented.

There is another problem. In a case where, in the DMFC, at the fuel electrode (anode), methanol is attached to Pt of the electrode and is thereby oxidized, resulting in generation of CO, whereas, in the PEFC, CO is largely contained in reformed H₂, when CO is absorbed by Pt, the electrode potential rises, resulting in an undesirable decrease in available electrical potentials (hereafter referred to as “CO poisoning”). However, according the invention, since CO can be oxidized to CO₂ by heating the electrode to high temperatures, occurrence of CO poisoning can be prevented.

In the invention, it is preferable that the fuel cell casing further comprises:

a hygroscopic member which is coated on at least one of the inner surface of the first fluid channel and the inner surface of the second fluid channel.

According to the invention, Since the hygroscopic member is coated on at least one of the inner surface of the first fluid channel and the inner surface of the second fluid channel, water vapor or water drop thereof (H₂O) produced through an electrochemical reaction in the membrane electrode assembly can be absorbed and removed by the hygroscopic member, resulting in an advantage in effectively preventing a blockage from occurring in the first and second fluid channels acting as fluid paths for air. Further, water vapor or water drop thereof (H₂O) produced after an electrochemical reaction in the membrane electrode assembly can be removed by the hygroscopic member. This helps prevent the electrode surfaces of the first and second electrodes from being covered by water vapor or water drop thereof (H₂O), and thus allow effective supply of air acting as oxidant gas, obtained from atmosphere, through the first and second fluid channels. In addition, As a result, chemical reactions can be facilitated in the membrane electrode assembly, making highly-efficient electricity production possible.

In the invention, it is preferable that the fuel cell casing further comprises:

a heat-insulating layer which is formed in at least one of a part of the base body and a part of the lid body, the parts being in a vicinity of the concavity.

According to the invention, the heat-insulating layer is formed in at least one of the part of the base body and the part of the lid body, the parts being in the vicinity of the concavity. In this case, since the heat-insulating layer is arranged in the region near the membrane electrode assembly, the membrane electrode assembly and the electrode can be maintained at a desired temperature. Besides, the outer wall of the fuel cell casing can be prevented from getting hot, and occurrence of undesirable temperature-distribution variations can be effectively prevented in the membrane electrode assembly. Hence, even if the membrane electrode assembly is heated to high temperatures, since the resultant heat is inhibited from being transmitted to the outer surface of the fuel cell casing by the heat-insulating layer, the fuel cell can be prevented from getting so hot as to cause a skin burn when the fuel cell is inadvertently touched by user's skin, for example. Further, it is possible to effectively minimize electricity-production efficiency variation between the fuel electrode and the air electrode in the fuel cell, and thereby prevent occurrence of electricity-production variation between these electrodes. In addition, the fuel cell is free from a difference in temperature between the endmost-side electrode and the midmost electrode, and more specifically it never occurs that the endmost electrode has a lower temperature relatively to the midmost electrode. Thus, a decrease of efficiency in electricity production, etc. caused by unduly high humidity can be prevented successfully.

Note that, to achieve chemical reactions efficiently, the temperature of the membrane electrode assembly should preferably be raised up to 80 to 100° C. In this respect, according to the fuel cell casing embodying the invention, the use of such a heat-insulating layer eliminates the addition of an extra device for raising fuel temperature. Thus, the membrane electrode assembly can be maintained at an optimum temperature, and chemical reaction efficiency can be enhanced. Since the incorporated heat-insulating layer provides remarkable temperature-control performance to maintain the optimum temperature of the membrane electrode assembly, the fuel cell casing of the invention is desirable particularly for a methanol-powered DMFC (Direct Methanol Fuel Cell) in which the membrane electrode assembly is cooled by a fuel to be supplied. In addition, satisfactory miniaturization and portability can be attained in the fuel cell casing.

When, at the air electrode, water is produced through a chemical reaction expressed by the chemical reaction equation (2), (4) and builds up in the porous electrode, air supply is hindered, and this leads to an undesirable decrease in the chemical reaction efficiency. However, according to the fuel cell casing embodying the invention, since the liquefaction of the resultant water vapor is prevented in the fuel cell by the heat-insulating layer, the decrease in the efficiency can be prevented.

In the invention, it is preferable that the fuel cell casing further comprises:

a hydrophobic coating which is coated on at least one of the inner surface of the first fluid channel and the inner surface of the second fluid channel.

According to the invention, Since at least one of the first and second fluid channels has its inner surface fully or partly coated with a hydrophobic coating, the fluid path surrounded by the hydrophobic coating exhibits satisfactory water repellency. Thereby, condensation of water occurring inside the first and second fluid channels, as well as water (H₂O) produced through an electrochemical reaction in the membrane electrode assembly, can be easily discharged and removed from the duct under the pressure of fuel and air supplied, resulting in an advantage in effectively preventing clogging of water droplets in the first and second fluid channels. This helps prevent the electrode surfaces of the first and second electrodes from being covered by water (H₂O), and thus allow effective supply of air acting as oxidant gas, obtained from fuel and atmosphere, through the first and second fluid channels. As a result, chemical reactions can be facilitated in the membrane electrode assembly, making highly-efficient electricity production possible.

According to this method, since the hydrophobic coating is made of a metal film, the hydrophobic coating can be readily formed by means of metallization and plating that have been widely used in the field of conventional multi-layer ceramic technology.

Moreover, at least one of the first and second fluid channels has its inner surface coated with a hydrophobic coating. Therefore, water droplets caused by condensation of water vapor can be discharged and removed by the hydrophobic coating, resulting in an advantage in effectively preventing a blockage from occurring in the first and second fluid channels acting as fluid paths for fuel and air. Besides, water vapor and partly-dripping water produced through an electrochemical reaction in the membrane electrode assembly can also be discharged and removed by the hydrophobic coating. This helps prevent effectively the electrode surfaces of the first and second electrodes from being covered by water vapor and partly-dripping water, and thus allow effective supply of air acting as oxidant gas, obtained from fuel and atmosphere, through the first and second fluid channels. As a result, chemical reactions can be facilitated in the membrane electrode assembly, making highly-efficient electricity production possible.

In the invention, it is preferable that at least one of the first and second wiring conductors is formed around the opening of the first fluid channel disposed on the bottom surface of the concavity, or around the opening of the second fluid channel disposed on the one surface of the lid body, so as to abut against the first or second electrode, and has its surface coated with a corrosion-resistant metal.

According to the invention, at least one of the first and second wiring conductors is formed around the opening of the first fluid channel disposed on the bottom surface of the concavity, or around the opening of the second fluid channel disposed on the one surface of the lid body, so as to abut against the first or second electrode, and also has its surface coated with a corrosion-resistant metal. With this structure, the first or second wiring conductor can be in immediate electric contact with the entire area of the first or second electrode of the membrane electrode assembly, with the exception of the area corresponding to the opening of the first or second fluid channel. This makes it possible to increase the contact area between the first electrode of the membrane electrode assembly and the first wiring conductor, as well as the contact area between the second electrode and the second wiring conductor, and also to establish direct connection therebetween. As a result, an increase in electrical resistance and occurrence of improper contact can be effectively prevented, thus achieving a fuel cell that succeeds in providing high electricity-production efficiency. Besides, since the metal material for coating the surface of the first and second wiring conductors is selected from among gold, platinum, and palladium, the first or second wiring conductor can be protected from corrosion.

In the invention, it is preferable that the first wiring conductor is formed around the opening of the first fluid channel disposed on the bottom surface of the concavity so as to abut against the first electrode; in a part of the base body which is located on another surface side from the first wiring conductor is formed a third wiring conductor in parallel with the first wiring conductor; and a first connecting conductor is formed between the first fluid channels disposed in the base body, for connecting the first wiring conductor to the third wiring conductor,

and that the second wiring conductor is formed around the opening of the second fluid channel disposed on the one surface of the lid body so as to abut against the second electrode; in a part of the lid body which is located on another surface side from the second wiring conductor is formed a fourth wiring conductor in parallel with the second wiring conductor; and a second connecting conductor is formed between the second fluid channels disposed in the lid body, for connecting the second wiring conductor to the fourth wiring conductor.

According to the invention, since the first wiring conductors and the second wiring conductors are formed around openings of the first fluid channels on the bottom surface of the concavity and around openings of the second fluid channels on the one surface of the lid body so as to abut against the first electrode and the second electrode of the membrane electrode assembly, all parts of the first and second electrodes of the membrane electrode assembly except the openings of the first and second fluid channels, and the first and second wiring conductors can be made in direct contact and electrically connected. Therefore, the first electrode and the first wiring conductors, and the second electrode and the second wiring conductors can be made in contact in large areas of the membrane electrode assembly, and can be connected directly, and an increase of electric resistance and a contact failure can be effectively controlled, so that it is possible to provide a fuel cell whose electric power generation efficiency is high.

Further, since in the first fuel cell of the invention, via the first connection conductors and the second connection conductors formed between the first fluid channels of the base body and between the second fluid channels of the lid body, the first wiring conductors and the second wiring conductors are connected to the third wiring conductors formed in parallel with the first wiring conductors at regions of the base body locating on the other surface side from the first wiring conductors and the fourth wiring conductors formed in parallel with the second wiring conductors at regions of the lid body locating on the other surface side from the second wiring conductors, it is possible to make the wiring conductors disposed in the fuel cell casing considerably low-resistance, and it is possible to connect a motherboard or the like for forming an electronic circuit as a main part of electronic apparatus provided with the fuel cell and the membrane electrode assembly at low resistance. As a result, it is possible to provide a fuel cell that enables taking out electricity electrochemically generated in the membrane electrode assembly to the outside in a good state.

Furthermore, since the first connection conductors and the second connection conductors are formed between the first fluid channels of the base body and between the second fluid channels of the lid body, respectively, it is possible to effectively prevent that the first connection conductors and the second connection conductors are corroded by fuel or the like, and it is possible to enable stably taking out electricity electrochemically generated in the membrane electrode assembly to the outside over the long run.

In the invention, it is preferable that the first wiring conductor is formed around the opening of the first fluid channel disposed on the bottom surface of the concavity so as to abut against the first electrode; in a part of the base body which is located on another surface side from the first wiring conductor is formed a third wiring conductor in parallel with the first wiring conductor; and a first connecting conductor is formed on the inner circumferential surface of the first fluid channel disposed in the base body, for connecting the first wiring conductor to the third wiring conductor,

and that the second wiring conductor is formed around the opening of the second fluid channel disposed on the one surface of the lid body so as to abut against the second electrode; in a part of the lid body which is located on another surface side from the second wiring conductor is formed a fourth wiring conductor in parallel with the second wiring conductor; and a second connecting conductor is formed on the inner circumferential surface of the second fluid channel disposed in the lid body, for connecting the second wiring conductor to the fourth wiring conductor.

According to the invention, since in the second fuel cell of the invention, via the first connection conductors and the second connection conductors formed on the inner peripheral surfaces of the first fluid channels of the base body and on the inner peripheral surfaces of the second fluid channels of the lid body, the first wiring conductors and the second wiring conductors are connected to the third wiring conductors formed in parallel with the first wiring conductors at regions of the base body locating on the other surface side from the first wiring conductors and the fourth wiring conductors formed in parallel with the second wiring conductors at regions of the lid body locating on the other surface side than the second wiring conductors, it is possible to make the wiring conductors disposed in the fuel cell casing considerably low-resistance, and it is possible to connect a motherboard or the like for forming an electronic circuit as a main part of electronic apparatus provided with the fuel cell and the membrane electrode assembly at low resistance. As a result, it is possible to provide a fuel cell that enables taking out electricity electrochemically generated in the membrane electrode assembly to the outside in a good state.

Furthermore, since the first connection conductors and the second connection conductors are formed on the inner peripheral surfaces of the first fluid channels and on the inner peripheral surfaces of the second fluid channels, the first connection conductors and the second connection conductors can strengthen the base body and the lid body, and it is possible to effectively prevent the base body and the lid body from being damaged. Moreover, it is possible to further narrow the distances between the first fluid channels and between the second fluid channels, and it becomes possible to form the first fluid channels and the second fluid channels in higher density.

Further, according to the invention, a membrane electrode assembly is accommodated in the concavity of the fuel cell casing of the invention and the one and other principal surfaces of the membrane electrode assembly are placed so that fluids can be exchanged between the first and second fluid channels, respectively, and the first and second wiring conductors are electrically connected to the first and second electrodes, respectively, and the lid body is mounted on the one surface of the base body around the concavity so as to cover the respective concavities, it is possible to obtain a reliable fuel cell that has the aforementioned merits by the fuel cell casing of the invention and that is small, sturdy, and capable of equal supply of fuel and highly efficient electrical connection.

The invention provides a fuel cell casing comprising:

a base body made of ceramics for housing therein at least a first electrode of a membrane electrode assembly, the membrane electrode assembly being made of a platy solid electrolyte having the first electrode and a second electrode which are formed on one principal surface and another principal surface thereof, respectively, in such a way that the solid electrolyte overhangs peripherally, the base body having a first concavity formed on one surface thereof, the first concavity having a placement portion formed in an outer periphery thereof for placing thereon an overhanging portion of the solid electrolyte;

a first fluid channel formed so as to extend from a bottom surface of the first concavity facing the one principal surface of the membrane electrode assembly to an outer surface of the base body;

a first wiring conductor having its one end disposed on the bottom surface of the first concavity facing the first electrode of the membrane electrode assembly, and its other end led out toward the outer surface of the base body;

a lid body mounted on the one surface of the base body near the first concavity so as to cover the first concavity, for housing therein the second electrode, the lid body having a second concavity formed on a bottom surface thereof, the second concavity having an abutment portion formed in an outer periphery thereof so as to abut against the overhanging portion, for allowing the overhanging portion to be grippingly interposed between the abutment portion and the placement portion, the lid body sealing the first concavity hermetically;

a second fluid channel formed so as to extend from one surface of the lid body facing the other principal surface of the membrane electrode assembly to an outer surface of the lid body; and

a second wiring conductor having its one end disposed on the one surface of the lid body facing the second electrode of the membrane electrode assembly, and its other end led out toward the outer surface of the lid body.

The invention provides a fuel cell casing comprising:

a base body made of ceramics for housing therein at least a first electrode of a membrane electrode assembly, the membrane electrode assembly being made of a platy solid electrolyte having the first electrode and a second electrode which are formed on one principal surface and another principal surface thereof, respectively, in such a way that the solid electrolyte overhangs peripherally, the base body having a concavity formed on one surface thereof, the concavity having a placement portion formed in an outer periphery thereof for placing thereon an overhanging portion of the solid electrolyte;

a first fluid channel formed so as to extend from a bottom surface of the concavity facing the one principal surface of the membrane electrode assembly to an outer surface of the base body;

a first wiring conductor having its one end disposed on the bottom surface of the concavity facing the first electrode of the membrane electrode assembly, and its other end led out toward the outer surface of the base body;

a lid body mounted on the one surface of the base body near the concavity so as to cover the concavity, for air-tightly sealing the concavity;

a second fluid channel formed so as to extend from one surface of the lid body facing the other principal surface of the membrane electrode assembly to an outer surface of the lid body; and

a second wiring conductor having its one end disposed on the one surface of the lid body facing the second electrode of the membrane electrode assembly, and its other end led out toward the outer surface of the lid body.

According to the invention, the fuel cell casing is composed of the membrane electrode assembly having the first and second electrodes disposed on the one and other principal surfaces thereof, respectively; the base body made of ceramics having the first concavity or the concavity for housing the membrane electrode assembly formed on the one surface thereof; and the lid body mounted on the one surface of the base body near the first concavity or the concavity so as to cover the first concavity or the concavity, for air-tightly sealing the first concavity or the concavity. With this construction, by air-tightly sealing the fuel cell casing, leakage of fluid such as gas can be prevented. Moreover, since there is no need to prepare an extra package in addition to the casing, the fuel cell can be operated with high efficiency, and miniaturization can be achieved. Further, the fuel cell is constructed by housing a plurality of membrane electrode assemblys in the casing composed of the ceramic-made base body having the first concavity or the concavity formed on its one surface and the lid body for sealing the first concavity or the concavity. With this construction, it never occurs that the membrane electrode assembly is exposed outside, and thus the casing can be protected against damage. As a result, the mechanical reliability of the fuel cell casing as a whole can be enhanced. Besides, the first and second wiring conductors, each of which has its one end disposed in the inner part of the casing composed of the first concavity or the concavity and the lid body, are the only components that make electrical contact with the membrane electrode assembly. This frees the membrane electrode assembly itself from unnecessary electrical connection, whereby making it possible to obtain a fuel cell which is excellent in reliability and safety. In addition, by using ceramics as a material for constituting the fuel cell casing, a fuel cell which is highly resistant to corrosion by fluid, typified by various gas, can be obtained.

Further, since first fluid channels that are formed from the bottom surface of the first concavity or the concavity facing the one principal surface of the membrane electrode assembly to the outer surface of the base body and second fluid channels that are formed from the one surface of the lid body facing the other principal surface of the membrane electrode assembly to the outer surface of the lid body are provided, and the respective fluid channels are disposed on the inner wall surfaces facing each other on both sides of the membrane electrode assembly, it is possible to increase uniformity of supply of a fluid supplied to the membrane electrode assembly. According to these fluid channels, since a fluid flows vertically to the membrane electrode assembly, there is an effect that in a case where, for example, a fluid is hydrogen gas, or a methanol aqueous solution or the like and air (oxygen) gas, partial pressures of the respective gases supplied to the first and second electrodes formed on the one and other principal surfaces the membrane electrode assembly, respectively, do not decrease, and a specified stable output voltage can be obtained. Furthermore, since pressure of a supplied fluid, for example, partial pressure of gas is stabilized, the distribution of temperatures inside the fuel cell casing becomes uniform, with the result that it is possible to control thermal stress caused in the membrane electrode assembly, and it is possible to increase reliability of a fuel cell.

Still further, since the respective fluid channels are formed in the base body and the lid body, the respective fluid channels are excellent in hermeticity. Moreover, since the overhanging portion of the solid electrolyte is placed on the placement portion formed in the outer periphery of the first concavity or the concavity of the one surface of the base body, the first and second fluid channels are isolated from each other by the membrane electrode assembly, there is no possibility that a function as a fuel cell does not appear because two kinds of fluid materials (for example, oxygen gas and hydrogen gas or methanol or the like) are mixed, and there is no risk that combustible fluids are ignited and exploded after mixed at high temperatures, with the result that it is possible to provide a safe fuel cell.

In the invention, it is preferable that at least one of the first and second wiring conductors is formed around the opening of the first fluid channel disposed on the bottom surface of the first concavity, or around the opening of the second fluid channel disposed on a bottom surface of the second concavity, so as to abut against the first electrode or the second electrode.

In the invention, it is preferable that at least one of the first and second wiring conductors is formed around the opening of the first fluid channel disposed on the bottom surface of the concavity, or around the opening of the second fluid channel disposed on the one surface of the lid body, so as to abut against the first or second electrode.

According to the invention, since at least one of the first wiring conductors and the second wiring conductors is formed around openings of the first fluid channels on the bottom surface of the first concavity or the concavity and around openings of the second fluid channels on the one surface of the lid body so as to abut against the first electrode and the second electrode of the membrane electrode assembly, all parts of the first and second electrodes of the membrane electrode assembly except the openings of the first and second fluid channels, and the first and second wiring conductors can be made in direct contact and electrically connected. Therefore, the first electrode and the first wiring conductors, and the second electrode and the second wiring conductors can be made in contact in large areas of the membrane electrode assembly, and can be connected directly, and an increase of electric resistance and a contact failure can be effectively controlled, so that it is possible to provide a fuel cell whose electric power generation efficiency is high.

In the invention, it is preferable that the fuel cell casing further comprises:

a heating element for heating the one or other principal surface of the membrane electrode assembly, which is formed on the periphery of at least one of the opening of the first fluid channel disposed on the bottom surface of the first concavity and the opening of the second fluid channel disposed on the bottom surface of the second concavity.

In the invention, it is preferable that the fuel cell casing further comprises:

a heating element for heating the one or other principal surface of the membrane electrode assembly, which is formed on the periphery of at least one of the opening of the first fluid channel disposed on the bottom surface of the concavity and the opening of the second fluid channel disposed on the one surface of the lid body.

According to the invention, the heating element for heating the one or other principal surface of the membrane electrode assembly is provided on the periphery of at least one of the opening of the first fluid channel disposed on the bottom surface of the first concavity or the concavity and the opening of the second fluid channel disposed on the one surface of the lid body. In this case, the thermal capacity is kept small compared to the case of using a conventional gas separator. Besides, since the heating element is arranged in the region near the membrane electrode assembly, in the fuel cell, the membrane electrode assembly and the electrode can be arbitrarily temperature-adjusted with excellent responsivity and controllability. Note that, to achieve chemical reactions efficiently, the temperature of the membrane electrode assembly should preferably be raised up to 80 to 100° C. In this respect, according to the fuel cell casing embodying the invention, the use of such a heating element eliminates the addition of an extra device for raising fuel temperature. Thus, temperature control can be achieved with ease, and chemical reaction efficiency can be enhanced. Since the incorporated heating element provides remarkable temperature-control performance, the fuel cell casing of the invention is desirable particularly for a methanol-powered DMFC (Direct Methanol Fuel Cell) in which the membrane electrode assembly is cooled by a fuel to be supplied. In addition, satisfactory miniaturization and portability can be attained.

When, at the air electrode, water is produced through a chemical reaction expressed by the chemical reaction equations (2), (4) and builds up in the porous electrode, air supply is hindered, and this leads to an undesirable decrease in the chemical reaction efficiency. However, according to the fuel cell casing embodying the invention, since the build-up water evaporates by the action of the heating element, the decrease in the efficiency can be prevented.

There is another problem. In a case where, in the DMFC, at the fuel electrode (anode), methanol is attached to Pt of the electrode and is thereby oxidized, resulting in generation of CO, whereas, in the PEFC, CO is largely contained in reformed H₂, when CO is absorbed by Pt, the electrode potential rises, resulting in an undesirable decrease in available electrical potentials (hereafter referred to as “CO poisoning”). However, according the invention, since CO can be oxidized to CO₂ by heating the electrode to high temperatures, occurrence of CO poisoning can be prevented.

In the invention, it is preferable that the fuel cell casing further comprises:

a hygroscopic member which is coated on at least one of the inner surface of the first fluid channel and the inner surface of the second fluid channel.

According to the invention, since the hygroscopic member is coated on at least one of the inner surface of the first fluid channel and the inner surface of the second fluid channel, water (H₂O) produced through an electrochemical reaction in the membrane electrode assembly can be absorbed and removed by the hygroscopic member, resulting in an advantage in effectively preventing a blockage from occurring in the first and second fluid channels acting as fluid paths for air. This helps prevent the electrode surfaces of the first and second electrodes from being covered by water (H₂O), and thus allow effective supply of air acting as oxidant gas, obtained from atmosphere, through the first and second fluid channels. As a result, chemical reactions can be facilitated in the membrane electrode assembly, making highly-efficient electricity production possible.

In the invention, it is preferable that the fuel cell casing further comprises:

a heat-insulating layer which is formed in at least one of a part of the base body which part is in a vicinity of the first concavity and a part of the lid body which part is in a vicinity of the second concavity.

In the invention, it is preferable that the fuel cell casing further comprises:

a heat-insulating layer which is formed in at least one of a part of the base body and a part of the lid body, the parts being in a vicinity of the concavity.

According to the invention, the heat-insulating layer is formed in at least one of the part of the base body which part is in the vicinity of the bottom surface of the concavity and the part of the lid body which part is in the vicinity of the second concavity or the concavity. In this case, since the heat-insulating layer is arranged in the region near the membrane electrode assembly, the membrane electrode assembly and the electrode can be maintained at a desired temperature. Besides, the outer wall of the fuel cell casing can be prevented from getting hot, and occurrence of undesirable temperature-distribution variations can be effectively prevented in the membrane electrode assembly. Hence, even if the membrane electrode assembly is heated to high temperatures, since the resultant heat is inhibited from being transmitted to the outer surface of the fuel cell casing by the heat-insulating layer, the fuel cell can be prevented from getting so hot as to cause a skin burn when the fuel cell is inadvertently touched by user's skin, for example. Further, it is possible to effectively minimize electricity-production efficiency variation between the fuel electrode and the air electrode in the fuel cell 21, and thereby prevent occurrence of electricity-production variation between these electrodes. In addition, the fuel cell is free from a difference in temperature between the endmost-side electrode and the midmost electrode, and more specifically it never occurs that the endmost electrode has a lower temperature relatively to the midmost electrode. Thus, a decrease of efficiency in electricity production, etc. caused by unduly high humidity can be prevented successfully.

Note that, to achieve chemical reactions efficiently, the temperature of the membrane electrode assembly should preferably be raised up to 80 to 100° C. In this respect, according to the fuel cell casing embodying the invention, the use of such a heat-insulating layer eliminates the addition of an extra device for raising fuel temperature. Thus, the membrane electrode assembly can be maintained at an optimum temperature, and chemical reaction efficiency can be enhanced. Since the incorporated heat-insulating layer provides remarkable temperature-control performance to maintain the optimum temperature of the membrane electrode assembly, the fuel cell casing of the invention is desirable particularly for a methanol-powered DMFC (Direct Methanol Fuel Cell) in which the membrane electrode assembly is cooled by a fuel to be supplied. In addition, satisfactory miniaturization and portability can be attained in the fuel cell casing.

When, at the air electrode, water is produced through a chemical reaction expressed by the chemical reaction equations (2), (4) and builds up in the porous electrode, air supply is hindered, and this leads to an undesirable decrease in the chemical reaction efficiency. However, according to the fuel cell casing embodying the invention, since the liquefaction of the resultant water vapor is prevented in the fuel cell by the heat-insulating layer, the decrease in the efficiency can be prevented.

The invention provides a fuel cell comprising:

a membrane electrode assembly having a first electrode and a second electrode disposed on one principal surface and another principal surface thereof, respectively; and

the fuel cell casing mentioned above,

wherein the membrane electrode assembly is housed in the concavity of the fuel cell casing, the one and other principal surfaces of the membrane electrode assembly are arranged such that fluid can be exchanged between the one and other principal surfaces and their corresponding first and second fluid channels, the first and second electrodes are electrically connected to the first and second wiring conductors, respectively, and the lid body is mounted on the one surface of the base body near the concavity so as to cover the concavity.

According to the invention, the fuel cell is constructed by housing the membrane electrode assembly in the concavity of the fuel cell casing embodying the invention; followed by arranging the one and other principal surfaces of the membrane electrode assembly such that fluid can be exchanged between them and the first and second fluid channels; followed by electrically connecting the first and second electrodes to the first and second wiring conductors, respectively; and followed by mounting the lid body on the one surface of the base body near the concavity so as to cover the concavity. With this construction, it is possible to provide a compact, sturdy, and highly-reliable fuel cell that allows even gas supply, uniformization of temperature gradients within the fuel cell casing, and highly-efficient electrical connection by exploiting the advantages of the fuel cell casing embodying the invention.

According to the invention, the fuel cell is constructed by housing the membrane electrode assembly in the concavity of the fuel cell casing embodying the invention; followed by arranging the lower and upper principal surfaces of the membrane electrode assembly such that fluid can be exchanged between them and the first and second fluid channels; followed by electrically connecting the first and second electrodes to the first and second wiring conductors, respectively; and followed by mounting the lid body on the one surface of the base body near the concavity so as to cover the concavity. With this construction, it never occurs that the membrane electrode assembly is exposed outside and suffers from damage. Moreover, the first and second wiring conductors, each of which has its one end disposed inside the casing composed of the concavity and the lid body, are the only components that make electrical contact with the membrane electrode assembly. This frees the membrane electrode assembly from unnecessary electrical connection, whereby making it possible to obtain a fuel cell which is excellent in reliability and safety. Further, the first and second fluid channels are formed on their corresponding inner wall surfaces of the casing, that is, formed on the concavity bottom surface of the base body and the one surface of the lid body, respectively, so as to have sandwiched therebetween the membrane electrode assembly. With this arrangement, it is possible to enhance the uniform suppliability of the gas to be supplied to the membrane electrode assembly, and also to prevent a decrease in the partial pressure of the gas supplied to the first and second electrodes of the membrane electrode assembly. Thus, a predetermined stable output voltage can be attained. Further, a stress occurring in the membrane electrode assembly can be suppressed, leading to enhancement of the reliability of the fuel cell.

The invention provides a fuel cell comprising:

a membrane electrode assembly made of a platy solid electrolyte having a first electrode and a second electrode which are formed on one principal surface and another principal surface thereof, respectively, in such a way that the solid electrolyte overhangs peripherally; and

the fuel cell casing mentioned above,

wherein the membrane electrode assembly is placed on the placement portion of the fuel cell casing, the one and other principal surfaces of the membrane electrode assembly are arranged such that fluid can be exchanged between the one and other principal surfaces and their corresponding first and second fluid channels, the first and second electrodes are electrically connected to the first and second wiring conductors, respectively, and the lid body is mounted on the one surface of the base body near the first concavity so as to cover the first concavity.

The invention provides a fuel cell comprising:

a membrane electrode assembly made of a platy solid electrolyte having a first electrode and a second electrode which are formed on one principal surface and another principal surface thereof, respectively, in such a way that the solid electrolyte overhangs peripherally; and

the fuel cell casing mentioned above,

wherein the membrane electrode assembly is placed on the placement portion of the fuel cell casing, the one and other principal surfaces of the membrane electrode assembly are arranged such that fluid can be exchanged between the one and other principal surfaces and their corresponding first and second fluid channels, the first and second electrodes are electrically connected to the first and second wiring conductors, respectively, and the lid body is mounted on the one surface of the base body near the concavity so as to cover the concavity.

According to the invention, the fuel cell is constructed by placing the membrane electrode assembly on the placement portion of the fuel cell casing of the invention; followed by arranging the one and other principal surfaces of the membrane electrode assembly such that fluid can be exchanged between them and the first and second fluid channels; followed by electrically connecting the first and second electrodes to the first and second wiring conductors, respectively; and followed by mounting the lid body on the one surface of the base body near the first concavity or the concavity so as to cover the first concavity or the concavity. With this construction, it is possible to provide a compact, sturdy, and highly-reliable fuel cell that allows even gas supply, uniformization of temperature gradients within the fuel cell casing, highly-efficient electrical connection, and prevention of a mixture of fluid materials, by exploiting the advantages of the fuel cell casing embodying the invention.

The invention provides an electronic apparatus comprising:

the fuel cell mentioned above, acting as a power source,

wherein the base body is made of multi-layer ceramics, and an external connection terminal is formed in at least one of the base body and the lid body.

According to the invention, because the base body made of multilayer ceramics that has, on the upper surface, the concavity for containing the membrane electrode assembly having the first and second electrodes on the one and other principal surfaces and the lid body that is mounted on the one surface of the base body around the concavity so as to cover the concavity and that hermetically seals the concavity are provided, a fuel cell casing is hermetically sealed and leakage of a fluid such as gas is thereby prevented, and there is no need to dispose a casing such as a package other than this casing, with the result that it is possible to realize electronic apparatus that can be operated efficiently and safely and can be used with high performance and stability, which is effective for miniaturization and low-profiling.

Further, since the fuel cell can be made by storing a plurality of membrane electrode assemblys in a box formed by the base body made of multilayer ceramics that has the concavity on the one surface and the lid body that seals the concavity, it is avoided that the membrane electrode assembly is exposed outside the housing and damaged, and mechanical reliability as the whole fuel cell increases.

Further, since, other than the first and second wiring conductors one ends of which are disposed inside the casing constituted by the concavity and the lid body, nothing comes in electrical contact with the membrane electrode assembly itself uselessly, it is possible to obtain a fuel cell that is highly reliable and safe, and it is possible to provide electronic apparatus that has long-term reliability and security.

Further, since this fuel cell is provided with external connection terminals (a positive terminal and a negative terminal) on at least either the base body or the lid body, it can be electrically connected to a circuit board of electronic apparatus with ease, and freely attached and detached. Therefore, it is possible to replace the fuel cell with a new one without using a facility or the like provided with a special safe facility, and it is possible to make electronic apparatus highly convenient.

Furthermore, as a result of using multilayer ceramics as a constitution material of a fuel cell casing, it is possible to use various kinds of gases and liquids without considering corrosiveness, and it is easy to increase efficiency of supply of electric power. Moreover, since it is possible to freely form wiring conductors by a well-known metallization method on ceramics of the respective layers forming the multilayer ceramics and therefore electric wiring of a fuel cell can be freely done, it is easy to connect a plurality of cells in series and in parallel, and it is possible to dramatically advance miniaturization, low-profiling and weight-reduction of electronic apparatus.

Further, according to the invention, since the base body is made of multilayer ceramics and therefore a metal layer can be formed on the surface of a ceramic layer locating inside by a metallization method or the like in various shapes and electric characteristics, it is possible to form an electronic circuit device that functions as a resistor, a capacitance, an inductance or the like. Therefore, for example, by forming a large-capacity capacitor in parallel with the fuel cell, in a case where an electric current outputted from the fuel cell is lacking, a shortfall of the electric current is compensated and supply of an electric current responsive to a target output electric current can be secured. Moreover, since a boosting circuit can be formed, it is possible to secure a voltage necessary for electronic apparatus.

The invention provides an electronic apparatus comprising:

the fuel cell mentioned above, acting as a power source,

wherein the base body is made of multi-layer ceramics, and an external connection terminal is formed in at least one of the base body and the lid body.

According to the invention, because the base body made of multilayer ceramics that has, on the one surface, the first concavity or the concavity for housing a membrane electrode assembly having first and second electrodes on the one and other principal surfaces and the lid body that is mounted on the one surface of the base body around the first concavity or the concavity so as to cover the first concavity or the concavity and that hermetically seals the first concavity or the concavity are provided, the fuel cell casing is hermetically sealed and leakage of a fluid such as gas is thereby prevented, and there is no need to dispose a casing such as a package other than this casing, with the result that it is possible to realize electronic apparatus that can be operated efficiently and safely and can be used with high performance and stability, which is effective for miniaturization and low-profiling.

Further, since the fuel cell can be made by storing a plurality of membrane electrode assemblys in a box formed by the base body made of multilayer ceramics that has the first concavity or the concavity on the one surface and the lid body that seals the first concavity or the concavity, it is avoided that the membrane electrode assembly is exposed outside the housing and damaged, and mechanical reliability as the whole fuel cell increases. Therefore, a protection member for the fuel cell is unnecessary, and it is possible to provide electronic apparatus that is small and short in height.

Further, since, other than the first and second wiring conductors one ends of which are disposed inside the casing constituted by the first concavity or the concavity and the lid body, nothing comes in electrical contact with the membrane electrode assembly itself uselessly, it is possible to obtain a fuel cell that is highly reliable and safe, and it is possible to provide electronic apparatus that has long-term reliability and security.

Further, since this fuel cell is provided with external connection terminals (a positive terminal and a negative terminal) on at least either the base body or the lid body, it can be electrically connected to a circuit board of electronic apparatus with ease, and freely attached and detached. Therefore, it is possible to replace the fuel cell with a new one without using a facility or the like provided with a special safe facility, and it is possible to make electronic apparatus highly convenient.

Furthermore, as a result of using multilayer ceramics as a constitution material of the fuel cell casing, it is possible to use various kinds of gases and liquids without considering corrosiveness, and it is easy to increase efficiency of supply of electric power. Moreover, since it is possible to freely form wiring conductors by a well-known metallization method on ceramics of the respective layers forming the multilayer ceramics and therefore electric wiring of a fuel cell can be freely done, it is easy to connect a plurality of cells in series and in parallel, and it is possible to dramatically advance miniaturization, low-profiling and weight-reduction of electronic apparatus.

Further, according to the invention, since the base body is made of multilayer ceramics and therefore a metal layer can be formed on the surface of a ceramic layer locating inside by a metallization method or the like in various shapes and electric characteristics, it is possible to form an electronic circuit device that functions as a resistor, a capacitance, an inductance or the like. Therefore, for example, by forming a large-capacity capacitor in parallel with the fuel cell, in a case where an electric current outputted from the fuel cell is lacking, a shortfall of the electric current is compensated and supply of an electric current responsive to a target output electric current can be secured. Moreover, since a boosting circuit can be formed, it is possible to secure a voltage necessary for electronic apparatus.

In the invention, it is preferable that the electronic apparatus further comprises:

an internal circuit which is formed in the base body.

Further, according to the invention, since the internal circuit is formed in the base body, it is possible to mount an electronic part electrically connected to the internal circuit on the surface of the base body. Therefore, it is possible to increase functionality of electronic apparatus by the electronic part mounted on the surface of the base body.

In the invention, it is preferable that the electronic apparatus further comprises:

an electronic part which is formed on the surface of the base body so as to be electrically connected to the internal circuit.

Further, according to the invention, since an electronic part electrically connected to the internal circuit is disposed to the surface of the base body, by detecting the density of fuel in the fluid channels by a density sensor by using a sensor, a control IC or the like as the electronic part, optimum circulation, fuel dilution and suppress of a decrease of fuel use efficiency are enabled. In addition, by using electronic parts, a boosting circuit can be formed, it becomes possible to control a voltage necessary for electronic apparatus. Further, by using a temperature sensor or the like, it becomes possible to manage and control the temperature of the membrane electrode assembly.

In the invention, it is preferable that the electronic apparatus further comprises:

a piezoelectric pump which is disposed partway along one of the first and second fluid channels.

Further, according to the invention, since piezoelectric pumps are disposed in at least either the first fluid channels or the second fluid channels, the small piezoelectric pumps mounted in the fluid channels can prevent backflow of fuel and consequently prevent that unused fuel is polluted by reaction substances or the like, and it is possible to avoid that residual air affects an operation of the electronic apparatus because the residual air is discharged. Besides, since fuel is supplied constantly, electric power is stably generated consequently, and since fuel is supplied smoothly, it is possible to shorten actuation time. Consequently, for example, even after replacing a fuel cell or a fuel cartridge with a new one or even after replenishing with fuel, it is possible to use electronic apparatus at once, and it is possible to provide electronic apparatus that compares favorably in convenience with conventional electronic apparatus that uses a chemical battery or the like.

Further, in the fuel cell embodying the invention, it is preferable that at least one of the first and second wiring conductors is formed around the opening of the first fluid channel disposed on the concavity bottom surface, or around the opening of the second fluid channel disposed on the one surface of the lid body, so as to abut against the first or second electrode. This arrangement makes it possible to increase the contact area between the first electrode of the membrane electrode assembly and the first wiring conductor, as well as the contact area between the second electrode and the second wiring conductor, and also to establish direct connection therebetween. As a result, an increase in electrical resistance and occurrence of improper contact can be effectively prevented, thus achieving a fuel cell that succeeds in providing high electricity-production efficiency.

Further, in the fuel cell embodying the invention, it is preferable that the heating element for heating the one or other principal surface of the membrane electrode assembly is provided on the periphery of at least one of the opening of the first fluid channel disposed on the bottom surface of the concavity and the opening of the second fluid channel disposed on the one surface of the lid body. In this case, the temperatures of the membrane electrode assembly and the electrode can be properly controlled in accordance with the concentration and flow rate of to-be-supplied fuel (hydrogen or methanol) or air (oxygen), the temperature of the membrane electrode assembly, and ambient conditions (temperature and humidity). Thus, chemical reactions can be achieved with high efficiency. Moreover, since build-up water in the electrode can be removed and the CO poisoning problem can be avoided, the fuel cell succeeds in providing high electricity-production efficiency.

In the fuel cell casing embodying the invention, it is preferable that the heat-insulating layer is made of porous ceramics. By employing porous ceramics having a multiplicity of fine pores inside, the heat-insulating layer is capable of exhibiting satisfactory heat-retaining property, and thereby the outer surface of the fuel cell casing can be prevented from getting hot. Hence, even if the membrane electrode assembly is heated to high temperatures, the fuel cell casing can be prevented from getting so hot as to cause a skin burn when it is inadvertently touched by user's skin, for example, and occurrence of undesirable temperature-distribution variations can be effectively prevented in the membrane electrode assembly. Moreover, it is possible to minimize electricity-production efficiency variation between the fuel electrode and the air electrode in the fuel cell, and thereby prevent occurrence of electricity-production variation between these electrodes.

In the fuel cell casing embodying the invention, it is preferable that the heat-insulating layer is made of hollow components. By employing hollow components having a void therein, the heat-insulating layer is capable of exhibiting satisfactory heat-retaining property, and thereby the outer surface of the fuel cell casing can be prevented from getting hot. Hence, even if the membrane electrode assembly is heated to high temperatures, the fuel cell casing can be prevented from getting so hot as to cause a skin burn when it is inadvertently touched by user's skin, for example, and occurrence of undesirable temperature-distribution variations can be effectively prevented in the membrane electrode assembly. Moreover, it is possible to minimize electricity-production efficiency variation between the fuel electrode and the air electrode in the fuel cell, and thereby prevent occurrence of electricity-production variation between these electrodes.

In the invention, it is preferable that the fuel cell is constructed by housing the membrane electrode assembly in the concavity of the fuel cell casing embodying the invention; followed by arranging the one and other principal surfaces of the membrane electrode assembly such that fluid can be exchanged between them and the first and second fluid channels; followed by electrically connecting the first and second electrodes to the first and second wiring conductors, respectively; and followed by mounting the lid body on the one surface of the base body near the concavity so as to cover the concavity. With this construction, it is possible to provide a compact, sturdy, and highly-reliable fuel cell that allows even gas supply, uniformization of temperature gradients within the fuel cell casing, and highly-efficient electrical connection by exploiting the advantages of the fuel cell casing embodying the invention.

Further, in the fuel cell embodying the invention, it is preferable that at least one of the first and second wiring conductors is formed around the opening of the first fluid channel disposed on the bottom surface of the concavity, or around the opening of the second fluid channel disposed on the one surface of the lid body, so as to abut against the first or second electrode, and also has its surface coated with any of gold, platinum, and palladium. This structure makes it possible to increase the contact area between the first electrode of the membrane electrode assembly and the first wiring conductor, as well as the contact area between the second electrode and the second wiring conductor, and also to establish direct connection therebetween. As a result, an increase in electrical resistance and occurrence of improper contact can be effectively prevented, and the first and second wiring conductors can be protected from corrosion, thus achieving a fuel cell that succeeds in providing high electricity-production efficiency.

Further, in the electronic apparatus of the invention, it is preferable that in the base body, a plurality of first concavities are formed, and third wiring conductors one ends of which face the first electrode of the membrane electrode assembly on the bottom surface of one of the first concavities and the other ends of which face the first electrode of the membrane electrode assembly on the bottom surface of another one of the first concavities are formed.

According to the electronic apparatus of the invention, because third wiring conductors one ends of which face the first electrode of the membrane electrode assembly on the bottom surface of one of the concavities and the other ends of which face the first electrode of the membrane electrode assembly on the bottom surface of another one of the concavities are provided on the base body, it is possible to electrically connect the plural membrane electrode assemblys and thereby connect them in parallel. As a result, it is possible to regulate output electric currents of the whole fuel cell, it is possible to take out electricity electrochemically generated in the membrane electrode assemblys to the outside in a good state.

Further, in the electronic apparatus of the invention, it is preferable that a plurality of concavities are formed, and fourth wiring conductors one ends of which face the first electrode of the membrane electrode assembly on the bottom surface of one of the concavities and the other ends of which are led out to the one surface of the base body where the lid body is mounted and fifth wiring conductors one ends of which face the second electrode of the membrane electrode assembly of another one of the concavities on the one surface of the lid body and the other ends of which are led out to the one surface of the lid body mounted to the one surface of the base body so as to face the other ends of the fourth wiring conductors are formed.

Further, according to the electronic apparatus of the invention, since fourth wiring conductors one ends of which face the first electrode of the membrane electrode assembly on the bottom surface of one of the the concavities and the other ends of which are led out to the one surface of the base body where the lid body is mounted and fifth wiring conductors one ends of which face the second electrode of the membrane electrode assembly of one of the concavities on the one surface of the lid body and the other ends of which are led out to the one surface of the lid body mounted to the one surface of the base body so as to face the other ends of the fourth wiring conductors are formed on the base body, it is possible to electrically connect the plural membrane electrode assemblys and thereby connect them in series. As a result, since it is possible to regulate the total voltage by connecting in series even though a voltage is minute in electric power generation of each membrane electrode assembly, it is possible to take out electricity electrochemically generated in the membrane electrode assemblys to the outside in a good state.

Further, in the electronic apparatus of the invention, it is preferable that, in the base body, a concavity that contains a plurality of membrane electrode assemblys is formed, and sixth wiring conductors one ends of which face the first electrode of one of the membrane electrode assemblys on the bottom surface of the concavity and the other ends of which face the first electrode of another one of the membrane electrode assemblys on the bottom surface of the first concavity are formed.

Further, according to the electronic apparatus of the invention, because sixth wiring conductors one ends of which face the first electrode of one of the membrane electrode assemblys on the bottom surface of the concavity and the other ends of which face the first electrode of another one of the membrane electrode assemblys on the bottom surface of the concavity are provided on the base body, it is possible to electrically connect the plural membrane electrode assemblys and thereby connect them in parallel. As a result, it is possible to regulate an output electric current of the whole fuel cell, it is possible to take out electricity electrochemically generated in the membrane electrode assemblys to the outside in a good state.

Further, in the electronic apparatus of the invention, it is preferable that, in the base body, a concavity that contains a plurality of membrane electrode assemblys is formed, and seventh wiring conductors one ends of which face the first electrode of one of the membrane electrode assemblys on the bottom surface of the concavity and the other ends of which are led out to the one surface of the base body where the lid body is mounted and eighth wiring conductors one ends of which face the second electrode of another one of the membrane electrode assemblys on the one surface of the lid body and the other ends of which are led out to the one surface of the lid body mounted to the one surface of the base body so as to face the other ends of the seventh wiring conductors are formed.

Further, according to the electronic apparatus of the invention, as a result of using a fuel cell provided with, on the base body, seventh wiring conductors one ends of which face the first electrode of one of the membrane electrode assemblys on the bottom surface of the concavity and the other ends of which are led out to the one surface of the base body where the lid body is mounted and eighth wiring conductors one ends of which face the second electrode of one of the membrane electrode assemblys on the one surface of the lid body and the other ends of which are led out to the one surface of the lid body mounted to the one surface of the base body so as to face the other ends of the seventh wiring conductors, it is possible, in this fuel cell, to electrically connect the plural membrane electrode assemblys and thereby connect them in series. As a result, since it is possible to regulate the total voltage by connecting in series even though a voltage is minute in electric power generation of each membrane electrode assembly, it is possible to take out electricity electrochemically generated in the membrane electrode assemblys to the outside in a good state, and it is possible to provide electronic apparatus in which a voltage is stable for a long term and which is excellent in reliability.

Further, in the electronic apparatus of the invention, it is preferable that at least either the first wiring conductors or the second wiring conductors are formed around openings of the first fluid channels on the bottom surface of the concavity or around openings of the second fluid channels on the one surface of the lid body so as to abut against the first electrode or the second electrode.

Further, according to the invention, the membrane electrode assembly is placed on the placement portion of the fuel cell casing and the one and other principal surfaces of the membrane electrode assembly are placed so that the respective fluids can be exchanged between the first and second fluid channels, the first and second electrodes are electrically connected respectively to the first and second wiring conductors, the first to third wiring conductors, the first, second, fourth and fifth wiring conductors, the first, second and sixth wiring conductors, or the first, second, seventh and eighth wiring conductors and electrically connected to the external connection terminals respectively, and the lid body is mounted on the one surface of the base body around the first concavity or the concavity so as to cover the first concavity or the concavity so that it is possible to obtain electronic apparatus that can be low-profiled and made to be high-performance and highly efficient, using a reliable fuel cell that has merits by the fuel cell casing of the invention as described above and that is small, sturdy and capable of equal supply of fuel and highly efficient electric connection.

Further, according to the equipment of the invention, since at least either the first wiring conductors or the second wiring conductors are formed around the openings of the first fluid channels on the bottom surface of the first concavity or the concavity or around the openings of the second fluid channels on the one surface of the lid body so as to abut against the first electrode or the second electrode of the membrane electrode assembly, it is possible to make the whole area of a region except the openings of the first fluid channels or the second fluid channels of the first electrode or the second electrode of the membrane electrode assembly in contact with the first wiring conductors or the second wiring conductors directly, and electrically connect. Therefore, it is possible to secure a large contact area of the first electrode and the first wiring conductors and a large contact area of the second electrode and the second wiring conductors of the membrane electrode assembly and connect directly, and it is possible to effectively prevent an increase of electric resistance and a contact failure, so that it is possible to provide electronic apparatus whose efficiency of electric power generation is high.

Further, in the electronic apparatus of the invention, it is preferable that, in the base body, a plurality of the first concavities are formed, and third wiring conductors one ends of which face the first electrode of the membrane electrode assembly on the bottom surface of one of the first concavities and the other ends of which face the first electrode of the membrane electrode assembly on the bottom surface of another one of the first concavities are formed.

Further, in the electronic apparatus of the invention, it is preferable that, in the base body, a plurality of first concavities are formed, and fourth wiring conductors one ends of which face the first electrode of the membrane electrode assembly on the bottom surface of one of the first concavities and the other ends of which are led out to the one surface of the base body where the lid body is mounted and fifth wiring conductors one ends of which face the second electrode of the membrane electrode assembly of another one of the first concavities on the one surface of the lid body and the other ends of which are led out to the one surface of the lid body mounted to the one surface of the base body so as to face the other ends of the fourth wiring conductors are formed.

Further, in the electronic apparatus of the invention, it is preferable that, in the base body, the first concavity that contains a plurality of membrane electrode assemblys is formed, and sixth wiring conductors one ends of which face the first electrode of one of the membrane electrode assemblys on the bottom surface of the first concavity and the other ends of which face the first electrode of another one of the membrane electrode assemblys on the bottom surface of the concavity are formed.

Further, in the electronic apparatus of the invention, it is preferable that, in the base body, the first concavity that contains a plurality of membrane electrode assemblys is formed, and seventh wiring conductors one ends of which face the first electrode of one of the membrane electrode assemblys on the bottom surface of the first concavity and the other ends of which are led out to the one surface of the base body where the lid body is mounted and eighth wiring conductors one ends of which face the second electrode of another one of the membrane electrode assemblys on the one surface of the lid body and the other ends of which are led out to the one surface of the lid body mounted to the one surface of the base body so as to face the other ends of the seventh wiring conductors are formed.

Further, in the equipment of the invention, it is preferable that, in the base body, a plurality of concavities are formed, and third wiring conductors one ends of which face the first electrode of the membrane electrode assembly on the bottom surface of one of the concavities and the other ends of which face the first electrode of the membrane electrode assembly on the bottom surface of another one of the concavities are formed.

Further, in the equipment of the invention, it is preferable that, in the base body, a plurality of concavities are formed, and fourth wiring conductors one ends of which face the first electrode of the membrane electrode assembly on the bottom surface of one of the concavities and the other ends of which are led out to the one surface of the base body where the lid body is mounted and fifth wiring conductors one ends of which face the second electrode of the membrane electrode assembly of another one of the concavities on the one surface of the lid body and the other ends of which are led out to the one surface of the lid body mounted to the one surface of the base body so as to face the other ends of the fourth wiring conductors are formed.

Further, in the equipment of the invention, it is preferable that, in the base body, a concavity that contains a plurality of membrane electrode assemblys is formed, and sixth wiring conductors one ends of which face the first electrode of one of the membrane electrode assemblys on the bottom surface of the concavity and the other ends of which face the first electrode of another one of the membrane electrode assemblys on the bottom surface of the concavity are formed.

Further, in the equipment of the invention, it is preferable that, in the base body, a concavity that contains a plurality of membrane electrode assemblys is formed, and seventh wiring conductors one ends of which face the first electrode of one of the membrane electrode assemblys on the bottom surface of the concavity and the other ends of which are led out to the one surface of the base body where the lid body is mounted and eighth wiring conductors one ends of which face the second electrode of another one of the membrane electrode assemblys on the one surface of the lid body and the other ends of which are led out to the one surface of the lid body mounted to the one surface of the base body so as to face the other ends of the seventh wiring conductors are formed.

Further, in the electronic apparatus of the invention, it is preferable that at least either the first wiring conductors or the second wiring conductors are formed around openings of the first fluid channels on the bottom surface of the first concavity or around openings of the second fluid channels on the one surface of the lid body so as to abut against the first electrode or the second electrode.

Further, in the electronic apparatus of the invention, it is preferable that at least either the first wiring conductors or the second wiring conductors are formed around openings of the first fluid channels on the bottom surface of the concavity or around openings of the second fluid channels on the one surface of the lid body so as to abut against the first electrode or the second electrode.

According to the invention, because third wiring conductors one ends of which face the first electrode of the membrane electrode assembly on the bottom surface of one of the first concavities or the concavities and the other ends of which face the first electrode of the membrane electrode assembly on the bottom surface of another one of the first concavities or the concavities are provided on the base body, it is possible to electrically connect the plural membrane electrode assemblys and thereby connect them in parallel. As a result, it is possible to regulate output electric currents of the whole fuel cell, it is possible to take out electricity electrochemically generated in the membrane electrode assemblys to the outside in a good state, and it is possible to provide electronic apparatus in which an electric current is stable for a long term and which is excellent in reliability.

Further, according to the invention, since fourth wiring conductors one ends of which face the first electrode of the membrane electrode assembly on the bottom surface of one of the first concavities or the concavities and the other ends of which are led out to the one surface of the base body where the lid body is mounted and fifth wiring conductors one ends of which face the second electrode of the membrane electrode assembly of one of the first concavities or the concavities on the one surface of the lid body and the other ends of which are led out to the one surface of the lid body mounted to the one surface of the base body so as to face the other ends of the fourth wiring conductors are formed on the base body, it is possible to electrically connect the plural membrane electrode assemblys and thereby connect them in series. As a result, since it is possible to regulate the total voltage by connecting in series even though a voltage is minute in electric power generation of each membrane electrode assembly, it is possible to take out electricity electrochemically generated in the membrane electrode assemblys to the outside in a good state, and it is possible to provide electronic apparatus in which a voltage is stable for a long term and which is excellent in reliability.

Further, according to the invention, because sixth wiring conductors one ends of which face the first electrode of one of the membrane electrode assemblys on the bottom surface of the first concavity or the concavity and the other ends of which face the first electrode of another one of the membrane electrode assemblys on the bottom surface of the first concavity or the concavity are provided on the base body, it is possible to electrically connect the plural membrane electrode assemblys and thereby connect them in parallel. As a result, it is possible to regulate an output electric current of the whole fuel cell, it is possible to take out electricity electrochemically generated in the membrane electrode assemblys to the outside in a good state, and it is possible to provide electronic apparatus in which an electric current is stable for a long term and which is excellent in reliability.

Further, according to the invention, as a result of using a fuel cell provided with, on the base body, seventh wiring conductors one ends of which face the first electrode of one of the membrane electrode assemblys on the bottom surface of the first concavity or the concavity and the other ends of which are led out to the one surface of the base body where the lid body is mounted and eighth wiring conductors one ends of which face the second electrode of one of the membrane electrode assemblys on the one surface of the lid body and the other ends of which are led out to the one surface of the lid body mounted to the one surface of the base body so as to face the other ends of the seventh wiring conductors, it is possible, in this fuel cell, to electrically connect the plural membrane electrode assemblys and thereby connect them in series. As a result, since it is possible to regulate the total voltage by connecting in series even though a voltage is minute in electric power generation of each membrane electrode assembly, it is possible to take out electricity electrochemically generated in the membrane electrode assemblys to the outside in a good state, and it is possible to provide electronic apparatus in which a voltage is stable for a long term and which is excellent in reliability.

Further, since this fuel cell is provided with first fluid channels formed from the bottom surface of the first concavity or the concavity facing the one principal surface of the membrane electrode assembly to the outer surface of the base body and second fluid channels formed from the one surface of the lid body facing the other principal surface of the membrane electrode assembly to the outer surface of the lid body, and the respective fluid channels are disposed on the facing inner wall faces respectively on both sides of the membrane electrode assembly, it is possible to increase uniformity of supply of a fluid supplied to the membrane electrode assembly. According to such fluid channels, a fluid flows vertically to the membrane electrode assembly, so that, in a case where, for example, the fluid is hydrogen gas, or a methanol aqueous solution or the like and air (oxygen) gas, partial pressures of the respective gases supplied to the first and second electrodes of the membrane electrode assembly formed on the one and other principal surfaces thereof do not decrease, and there is an effect that a specified stable output voltage can be obtained.

Furthermore, since pressure of a supplied fluid, for example, partial pressure of gas is stabilized, the distribution of temperatures inside a fuel cell casing is uniformized, with the result that thermal stress caused in the membrane electrode assembly can be controlled, reliability of a fuel cell can be increased, and therefore, it is possible to provide electronic apparatus that is more excellent in reliability.

Still further, since the respective fluid channels are formed on the base body and the lid body, the respective ducts are excellent in hermeticity, and since the overhanging portion of the solid electrolyte is placed on the placement portion disposed to the outer peripheral portion of the first concavity or the concavity on the one surface of the base body, the first fluid channels and the second fluid channels are isolated by the membrane electrode assembly, so that it is prevented that two kinds of fluid materials (for example, oxygen gas and hydrogen gas or a methanol aqueous solution or the like) are mixed and thereby a function as a fuel cell does not appear, there is no risk that combustible fluids are mixed at high temperatures and thereafter ignited or exploded, and therefore, it is possible to provide safe electronic apparatus.

Further, according to the invention, the membrane electrode assembly is placed on the placement portion of the fuel cell casing and the one and other principal surfaces of the membrane electrode assembly are placed so that the respective fluids can be exchanged between the first and second fluid channels, the first and second electrodes are electrically connected respectively to the first and second wiring conductors, the first to third wiring conductors, the first, second, fourth and fifth wiring conductors, the first, second and sixth wiring conductors, or the first, second, seventh and eighth wiring conductors and electrically connected to the external connection terminals respectively, and the lid body is mounted on the one surface of the base body around the first concavity or the concavity so as to cover the first concavity or the concavity so that it is possible to obtain electronic apparatus that can be low-profiled and made to be high-performance and highly efficient, using a reliable fuel cell that has merits by the fuel cell casing of the invention as described above and that is small, sturdy and capable of equal supply of fuel and highly efficient electric connection.

Further, according to the invention, since at least either the first wiring conductors or the second wiring conductors are formed around the openings of the first fluid channels on the bottom surface of the first concavity or the concavity or around the openings of the second fluid channels on the one surface of the lid body so as to abut against the first electrode or the second electrode of the membrane electrode assembly, it is possible to make the whole area of a region except the openings of the first fluid channels or the second fluid channels of the first electrode or the second electrode of the membrane electrode assembly in contact with the first wiring conductors or the second wiring conductors directly, and electrically connect. Therefore, it is possible to secure a large contact area of the first electrode and the first wiring conductors and a large contact area of the second electrode and the second wiring conductors of the membrane electrode assembly and connect directly, and it is possible to effectively prevent an increase of electric resistance and a contact failure, so that it is possible to provide electronic apparatus whose efficiency of electric power generation is high.

In the first fuel cell casing of the invention, it is preferable that at least one of the first and second fluid channels comprises:

an opening portion composed of a plurality of equally-spaced groove-like openings that are identical in length and width, the opening portion being arranged on the bottom surface of the concavity or the one surface of the lid body face to face with the one or other principal surface of the membrane electrode assembly;

a coupling portion for coupling together one ends, as well as the other ends, of a plurality of openings formed within the base body or the lid body;

a fluid introducing portion which is so formed as to extend from one side of the coupling portion to the outer surface of the base body or the lid body; and

a fluid discharge portion which is so formed as to extend from the other side of the coupling portion to the outer surface of the base body or the lid body.

In the fuel cell casing of the invention, it is preferable that the coupling portion is made larger in fluid-path cross-sectional area than the opening.

In the fuel cell casing of the invention, it is preferable that both the introducing portion and the discharge portion are disposed at one end of the array of a plurality of openings, and the openings are arranged in order of increasing fluid-path cross-sectional area from the one end to the other end of the array.

In the fuel cell casing of the invention, it is preferable that the introducing portion is disposed at one end of the array of a plurality of openings, whereas the discharge portion is disposed at the other end of the array, and the openings are arranged in order of increasing fluid-path cross-sectional area from each end to the center of the array.

In the fuel cell casing of the invention, it is preferable that both the introducing portion and the discharge portion are disposed at the center of the array of a plurality of openings, and the openings are arranged in order of increasing fluid-path cross-sectional area from the center to each end of the array.

The invention provides a fuel cell comprising:

the electrolyte mentioned above; and

the fuel cell casing mentioned above,

wherein the membrane electrode assembly is housed in the concavity of fuel cell casing of the invention, the one and other principal surfaces of the membrane electrode assembly is arranged such that fluid can be exchanged between the one and other principal surfaces and their corresponding first and second fluid channels, the first and second electrodes are electrically connected to the first and second wiring conductors, respectively, and the lid body is mounted on the one surface of the base body near the concavity so as to cover the concavity.

According to the invention, the first fuel cell casing includes: the first fluid channel formed so as to extend from the bottom surface of the concavity facing the one principal surface of the membrane electrode assembly to the outer surface of the base body; and the second fluid channel formed so as to extend from the one surface of the lid body facing the other principal surface of the membrane electrode assembly to the outer surface of the lid body. In this construction, at least one of the first and second fluid channels is composed of the opening portion, the coupling portion, the fluid introducing portion, and the fluid discharge portion. The opening portion includes a plurality of equally-spaced groove-like openings that are identical in length and width, and is arranged on the bottom surface of the concavity or the one surface of the lid body face to face with the one or other principal surface of the membrane electrode assembly. The coupling portion serves to couple together one ends, as well as the other ends, of a plurality of openings formed within the base body or the lid body. The fluid introducing portion is so formed as to extend from one side of the coupling portion to the outer surface of the base body or the lid body. The fluid discharge portion is so formed as to extend from the other side of the coupling portion to the outer surface of the base body or the lid body. In this case, a fluid can be readily supplied to the opening portion taking on the form of a plurality of grooves, by the fluid introducing portion and the coupling portion. Moreover, a plurality of groove-like openings constituting the opening portion are identical in length and width, and are equally spaced. Thus, even if a fluid flows at high speed, since the distance between the introducing portion and the discharge portion is short, the resistance as observed in the fluid path is decreased. As a result, the uniform suppliability of the fluid to be supplied to the membrane electrode assembly can be enhanced. Further, in this construction, in contrast to the case where the fluid channel is so formed as to meander at length intricately without branching off, it never occurs that fuel gas or air is gradually consumed as it finds its way through the fluid channel. Thus, the output voltage can be prevented from decreasing.

The fuel cell casings of the invention afford the following advantages. In general, since a larger amount of fluid tends to flow into the openings located near the introducing portion and the discharge portion in particular, if the openings are equal in dimension, the fluid supply from the opening portion having such openings may become nonuniform. In light of this, in the fuel cell casings of the invention, in response to the change of the arrangement of the introducing portion and the discharge portion, the fluid-path cross-sectional areas of the coupling portion and the opening are changed relatively to the arrangement of the introducing portion and the discharge portion, or the fluid resistance in the coupling portion and the opening is controlled properly. This makes it possible to attain uniform suppliability of fluid for the individual groove-like openings constituting the opening portion. Hence, chemical reactions can be stabilized in the membrane electrode assembly without being unequal depending on positions, and the temperature distribution within the fuel cell casing can accordingly be made uniform. As a result, thermal stress occurring in the membrane electrode assembly can be suppressed, leading to enhancement of the reliability of the fuel cell.

Still further, according to the invention, since the respective fluid channels are formed in the base body and the lid body, the respective fluid channels are excellent in hermeticity, there is no possibility that a function as a fuel cell does not appear because two kinds of fluid materials (for example, oxygen gas and hydrogen gas or methanol or the like) whose ducts should be isolated originally are mixed, and there is no risk that combustible fluids are ignited and exploded after mixed at high temperatures, with the result that it is possible to provide a safe fuel cell.

According to the invention, the fuel cell is constructed by housing the membrane electrode assembly in the concavity of the fuel cell casing embodying the invention; followed by arranging the one and other principal surfaces of the membrane electrode assembly such that fluid can be exchanged between them and the first and second fluid channels; followed by electrically connecting the first and second electrodes to the first and second wiring conductors, respectively; and followed by mounting the lid body on the one surface of the base body near the concavity so as to cover the concavity. With this construction, it is possible to provide a compact, sturdy, and highly-reliable fuel cell that allows even gas supply, uniformization of temperature gradients within the fuel cell casing, and highly-efficient electrical connection by exploiting the advantages of the fuel cell casing embodying the invention.

In the fuel cell casing of the invention, it is preferable that at least one of the first and second fluid channels is so configured that an opening at its membrane electrode assembly-side end is made smaller in width than an opening at its other opposite end.

In the invention, it is preferable that at least one of the first and second fluid channels is so shaped that its cross-sectional area becomes smaller gradually toward the membrane electrode assembly.

In the invention, it is preferable that at least one of the first and second fluid channels, which is so configured that the opening at its membrane electrode assembly-side end is made smaller in width than the opening at its other opposite end, has its inner wall covered with a hygroscopic member.

The invention provides a fuel cell comprising:

the electrolyte mentioned above; and

the fuel cell casing mentioned above,

wherein the membrane electrode assembly is housed in the concavity of any of the fuel cell casing of the invention, the one and other principal surfaces of the membrane electrode assembly is arranged such that fluid can be exchanged between the one and other principal surfaces and their corresponding first and second fluid channels, the first and second electrodes are electrically connected to the first and second wiring conductors, respectively, and the lid body is mounted on the one surface of the base body near the concavity so as to cover the concavity.

According to the invention, at least one of the first and second fluid channels is so configured that the opening at its membrane electrode assembly-side end is made smaller in width than the opening at its other opposite end. This facilitates evaporation of water vapor or water produced through an electrochemical reaction in the membrane electrode assembly, resulting in an advantage in preventing a blockage from occurring in the air duct. Thus, it is possible to achieve effective supply of air acting as oxidant gas obtained from atmosphere, and thereby chemical reactions can be facilitated, making highly-efficient electricity production possible.

According to the fuel cell casing of the invention, at least one of the first and second fluid channels is preferably so shaped that its cross-sectional area becomes smaller gradually toward the membrane electrode assembly. This facilitates evaporation of water vapor or water produced through an electrochemical reaction in the membrane electrode assembly, resulting in an advantage in preventing a blockage from occurring in the air duct. Thus, it is possible to achieve effective supply of air acting as oxidant gas obtained from atmosphere, and thereby chemical reactions can be facilitated, making highly-efficient electricity production possible.

According to the fuel cell casing of the invention, at least one of the first and second fluid channels, which is so configured that the opening at its membrane electrode assembly-side end is made smaller in width than the opening at its other opposite end, has its inner wall covered with a hygroscopic member. Since water vapor or water produced through an electrochemical reaction in the membrane electrode assembly is absorbed by the hygroscopic member, a blockage can be prevented from occurring in the air duct. Thus, it is possible to achieve effective supply of air acting as oxidant gas obtained from atmosphere, and thereby chemical reactions can be facilitated, making highly-efficient electricity production possible.

According to the invention, the fuel cell is constructed by housing the membrane electrode assembly in the concavity of the fuel cell casing embodying the invention; followed by arranging the one and other principal surfaces of the membrane electrode assembly such that fluid can be exchanged between them and the first and second fluid channels; followed by electrically connecting the first and second electrodes to the first and second wiring conductors, respectively; and followed by mounting the lid body on the one surface of the base body near the concavity so as to cover the concavity. With this construction, it is possible to provide a compact, sturdy, and highly-reliable fuel cell that allows even gas supply, uniformization of temperature gradients within the fuel cell casing, and highly-efficient electrical connection by exploiting the advantages of the fuel cell casing embodying the invention.

In the fuel cell casing of the invention, it is preferable that at least one of the first and second fluid channels is so configured that an opening at its membrane electrode assembly-side end is made larger in width than an opening at its other opposite end.

In the invention, it is preferable that at least one of the first and second fluid channels is so shaped that its cross-sectional area becomes larger gradually toward the membrane electrode assembly.

In the invention, it is preferable that at least one of the first and second fluid channels, which is so configured that the opening at its membrane electrode assembly-side end is made larger in width than the opening at its other opposite end, has its inner wall covered with a hygroscopic member.

According to the invention, since an area of a contact portion between the first wiring conductor and the first electrode and an area of a contact portion between the second wiring conductor and the second electrode become small, when the base body and the lid body is brought into pressure-contact with the membrane electrode assembly, it is possible to make larger a load per unit area applied to the contact portion between the first wiring conductor and the first electrode and the contact portion between the second wiring conductor and the second electrode, leading to enhancement of the reliability of the connection. As a result, even if a load applied to the base body and the lid body is made small, it is possible to effectively prevent the occurrence of crack or fracture in the base body and the lid body.

In addition, since an area where the air and the fuel gas are contacted with the first and second electrodes can be made larger, electrochemical reactions can be facilitated, which makes highly-efficient electricity production possible.

Hence, according to the fuel cell casing and the fuel cell embodying the invention, there is provided a fuel cell that is excellent in compactness, convenience, and safety; that allows even fluid supply, highly-efficient electrical connection; and that is operated with stability for a longer period of time.

Based on the above, according to the electronic apparatus of the invention, as a result of using a fuel cell that is excellent in compactness, simplicity and safety and capable of equal supply of a fluid and highly efficient electrical connection, it is possible to provide electronic apparatus that is small, short in height, capable of operating stably over the long run, and excellent in safety and convenience.

### BRIEF DESCRIPTION OF THE DRAWINGS

Other and further objects, features, and advantages of the invention will be more explicit from the following detailed description taken with reference to the drawings wherein:

FIG. 1 is a sectional view showing a fuel cell casing and a fuel cell employing the same according to one embodiment of the invention;

FIG. 2 is a sectional view showing a fuel cell casing and a fuel cell employing the same according to another embodiment of the invention;

FIG. 3 is a sectional view showing a fuel cell casing and a fuel cell employing the same according to still another embodiment of the invention;

FIG. 4 is a sectional view showing a fuel cell casing and a fuel cell employing the same according to still another embodiment of the invention;

FIG. 5 is a sectional view showing a fuel cell casing and a fuel cell employing the same according to still another embodiment of the invention;

FIG. 6 is a sectional view showing a fuel cell casing and a fuel cell employing the same according to still another embodiment of the invention;

FIG. 7 is a sectional view showing a fuel cell casing and a fuel cell employing the same according to still another embodiment of the invention;

FIG. 8 is a sectional view showing a fuel cell casing and a fuel cell employing the same according to still another embodiment of the invention;

FIG. 9 is a sectional view showing a fuel cell casing and a fuel cell employing the same according to still another embodiment of the invention;

FIG. 10 is a sectional view showing a fuel cell casing and a fuel cell employing the same according to still another embodiment of the invention;

FIG. 11 is a sectional view showing a fuel cell casing and a fuel cell employing the same according to still another embodiment of the invention;

FIG. 12 is a sectional view showing a fuel cell casing and a fuel cell employing the same according to still another embodiment of the invention;

FIG. 13 is a sectional view showing a fuel cell casing and a fuel cell employing the same according to still another embodiment of the invention;

FIG. 14 is a sectional view showing a fuel cell casing and a fuel cell employing the same according to still another embodiment of the invention;

FIG. 15 is a sectional view showing a fuel cell casing and a fuel cell employing the same according to still another embodiment of the invention;

FIG. 16 is a sectional view showing a fuel cell casing and a fuel cell employing the same according to still another embodiment of the invention;

FIG. 17 is a sectional view showing a fuel cell casing and a fuel cell employing the same according to still another embodiment of the invention;

FIG. 18 is a sectional view showing a fuel cell casing and a fuel cell employing the same according to still another embodiment of the invention;

FIG. 19 is a sectional view showing a fuel cell installed in the electronic apparatus, according to one embodiment of the invention;

FIG. 20 is a sectional view showing a fuel cell installed in the electronic apparatus, according to another embodiment of the invention;

FIG. 21 is a sectional view showing a fuel cell installed in the electronic apparatus, according to still another embodiment of the invention;

FIG. 22 is a sectional view showing a fuel cell installed in the electronic apparatus, according to still another embodiment of the invention;

FIG. 23 is a sectional view showing a fuel cell installed in the electronic apparatus, according to still another embodiment of the invention;

FIG. 24 is a block diagram showing an electronic apparatus according to one embodiment of the invention.

FIG. 25 is a sectional view showing a fuel cell casing and a fuel cell employing the same according to still another embodiment of the invention;

FIG. 26 is a sectional view showing a fuel cell casing and a fuel cell employing the same according to still another embodiment of the invention;

FIG. 27 is a sectional view showing a fuel cell casing and a fuel cell employing the same according to still another embodiment of the invention;

FIG. 28 is a sectional view showing a fuel cell casing and a fuel cell employing the same according to still another embodiment of the invention;

FIG. 29 is a sectional view showing a fuel cell casing and a fuel cell employing the same according to still another embodiment of the invention;

FIG. 30 is a sectional view showing a fuel cell casing and a fuel cell employing the same according to still another embodiment of the invention;

FIG. 31 is a sectional view showing a fuel cell casing and a fuel cell employing the same according to still another embodiment of the invention;

FIG. 32 is a sectional view showing a fuel cell installed in the electronic apparatus, according to still another embodiment of the invention;

FIG. 33 is a sectional view showing a fuel cell installed in the electronic apparatus, according to still another embodiment of the invention;

FIG. 34 is a sectional view showing a fuel cell installed in the electronic apparatus, according to still another embodiment of the invention;

FIG. 35 is a sectional view showing a fuel cell installed in the electronic apparatus, according to still another embodiment of the invention;

FIG. 36 is a sectional view showing a fuel cell installed in the electronic apparatus, according to still another embodiment of the invention;

FIG. 37 is a sectional view showing a fuel cell installed in the electronic apparatus, according to still another embodiment of the invention;

FIG. 38 is a sectional view showing a fuel cell installed in the electronic apparatus, according to still another embodiment of the invention;

FIG. 39 is a sectional view showing a fuel cell installed in the electronic apparatus, according to still another embodiment of the invention;

FIG. 40 is a sectional view showing a fuel cell installed in the electronic apparatus, according to still another embodiment of the invention;

FIG. 41 is a sectional view showing a fuel cell installed in the electronic apparatus, according to still another embodiment of the invention;

FIG. 42 is a sectional view showing a fuel cell installed in the electronic apparatus, according to still another embodiment of the invention;

FIG. 43 is a sectional view showing a fuel cell installed in the electronic apparatus, according to still another embodiment of the invention;

FIG. 44 is a block diagram showing an electronic apparatus according to another embodiment of the invention;

FIG. 45 is a sectional view showing a fuel cell casing and a fuel cell employing the same according to still another embodiment of the invention;

FIG. 46 is a sectional view showing a fuel cell casing and a fuel cell employing the same according to still another embodiment of the invention;

FIG. 47 is a sectional view showing a fuel cell casing and a fuel cell employing the same according to still another embodiment of the invention;

FIG. 48 is a sectional view showing a fuel cell casing and a fuel cell employing the same according to still another embodiment of the invention;

FIG. 49 is a sectional view showing a fuel cell casing and a fuel cell employing the same according to still another embodiment of the invention;

FIG. 50 is a sectional view showing a fuel cell casing and a fuel cell employing the same according to still another embodiment of the invention;

FIG. 51 is a sectional view showing a fuel cell casing and a fuel cell employing the same according to still another embodiment of the invention;

FIG. 52 is a sectional view showing a fuel cell employing a fuel cell casing according to still another embodiment of the invention;

FIG. 53 is a sectional view showing a fuel cell employing a fuel cell casing according to still another embodiment of the invention;

FIG. 54 is a sectional view showing a fuel cell employing a fuel cell casing according to still another embodiment of the invention;

FIG. 55 is a sectional view showing a fuel cell employing a fuel cell casing according to still another embodiment of the invention;

FIG. 56 is a sectional view showing a fuel cell employing a fuel cell casing according to still another embodiment of the invention;

FIG. 57 is a sectional view showing a fuel cell employing a fuel cell casing according to still another embodiment of the invention; and

FIG. 58 is a sectional view showing an example of a conventional fuel cell.

### DETAILED DESCRIPTION OF THE PREFERRED EMBODIMENTS

Now referring to the drawings, preferred embodiments of the invention are described below.

FIG. 1 is a sectional view showing a fuel cell casing and a fuel cell employing the same according to one embodiment of the invention. In FIG. 1, reference numeral 11 denotes a fuel cell; reference numeral 12 denotes a fuel cell casing; reference numeral 13 denotes a membrane electrode assembly; reference numeral 14 denotes a first electrode; reference numeral 15 denotes a second electrode; reference numeral 16 denotes a base body; reference numeral 17 denotes a lid body; reference numeral 18 denotes a first fluid channel; reference numeral 19 denotes a second fluid channel; reference numeral 20 denotes a first wiring conductor; and reference numeral 21 denotes a second wiring conductor.

On the membrane electrode assembly 13, for example, on both principal surfaces of an ion conduction membrane (exchange membrane) which is made of a platy solid electrolyte, a fuel electrode (not shown in the drawing) to become an anode electrode and an air electrode (not shown in the drawing) to become a cathode electrode are formed into one body so as to face the first electrode 14 formed on the lower principal surface as one principal surface and the second electrode 15 formed on the upper principal surface as another principal surface, respectively. Then, it is possible to flow an electric current generated in the membrane electrode assembly 13 to the first electrode 14 and the second electrode 15 and take it to the outside.

Such an ion conduction membrane (exchange membrane) of the membrane electrode assembly 13 is constituted by a proton conductive ion exchange membrane such as a perfluorocarbon sulfonic acid resin, for example, Nafion (a product name, produced by DuPont). Moreover, the fuel electrode and the air electrode are porous-state gas diffusing electrodes, and have both functions of a porous catalyst layer and a gas diffusing layer. The fuel electrode and the air electrode are constituted by a porous material that holds conductive fine particles carrying a catalyst such as platinum, palladium or alloy thereof, for example, carbon fine particles by a hydrophobic resin binder such as polytetrafluoroethylene.

The first electrode 14 and the second electrode 15 on the lower principal surface and the upper principal surface of the membrane electrode assembly 13 are formed by a method of hot pressing a carbon electrode on which fine particles of a catalyst such as platinum or platinum-ruthenium are attached on the membrane electrode assembly 13, a method of applying or transferring a mixture of a carbon electrode material on which fine particles of a catalyst such as platinum or platinum-ruthenium are attached and a solution in which an electrolyte material is dispersed onto an electrolyte, or the like.

The fuel cell casing 12 comprises the base body 16 that has a concavity and the lid body 17, has a function of storing the membrane electrode assembly 13 inside the concavity and hermetically sealing, and is made of a ceramics material such as sintered aluminum oxide (Al₂O₃), sintered mullite (3Al₂O₃.2SiO₂), sintered silicon carbide (SiC), sintered aluminum nitride (AlN), sintered silicon nitride (Si₃N₄) or sintered glass ceramics.

For example, sintered glass ceramics is made of a glass component and filler, and a glass component is, for example, SiO₂—B₂O₃, SiO₂—B₂O₃—Al₂O₃, SiO₂—B₂O₃—Al₂O₃—Mo (M denotes Ca, Sr, Mg, Ba or Zn), SiO₂—Al₂O₃-M¹O-M²O (M¹ and M² are the same or different, and denote Ca, Sr, Mg, Ba or Zn), SiO₂—B₂O₃—Al₂O₃-M¹O-M²O (M¹ and M² are the same as described before), SiO₂—B₂O₃-M³₂O (M³ denotes Li, Na or K), SiO₂—B₂O₃—Al₂O₃-M³₂O (M³ is the same as described before), Pb glass, or Bi glass.

Further, filler is, for example, a composite oxide of Al₂O₃, SiO₂, ZrO₂ and an alkaline-earth metal oxide, a composite oxide of TiO₂ and an alkaline-earth metal oxide, or a composite oxide containing at least one of Al₂O₃ and SiO₂ (for example, spinel, mullite, cordierite).

Since the fuel cell casing 12 comprises the base body 16 having a concavity and the lid body 17, and the concavity is hermetically sealed by mounting the lid body 17 around the concavity of the base body 16 so as to cover the concavity, the lid body 17 is mounted to the base body 16 by bonding with a metal bonding material such as solder or silver brazing filler, by bonding with a resin material such as epoxy, or by a method of bonding a sealant or the like made of ferroalloy or the like on the upper surface as one surface around the concavity and welding by seam weld, electron beam, laser or the like. Here, the lid body 17 may be also provided with a concavity in the manner as the base body 16. In addition, a peripheral portion of the base body and the lid body may be provided with through holes and the base body and the lid body may be mechanically secured by screwing via the through holes.

The base body 16 and the lid body 17 are made to be thin, respectively, and in order to enable low-profiling of the fuel cell 11, it is preferable that flexural strength as mechanical strength is 200 MPa or more.

It is preferable that the base body 16 and the lid body 17 are made of sintered aluminum oxide of a close-packed substance whose relative density is 95% or more, for example. In this case, for example, in the case of sintered aluminum oxide, firstly, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser, press-molding or the like, through holes as the first fluid channels 18 and the second fluid channels 19, openings as fluid passages and through holes for disposing the first connection conductors 20 and the second connection conductors 21 are formed on the green sheet.

The first and second wiring conductors 20 and 21 should preferably be composed of tungsten and/or molybdenum to prevent oxidation. In this case, for example, as an inorganic substance, Al₂O₃ in an amount of 3 to 20% by mass and Nb₂O₅ in an amount of 0.5 to 5% by mass is added to 100 mass percent tungsten and/or molybdenum powder to form a conductor paste. The conductor paste is filled in the through hole pierced in the green sheet to form a via hole acting as a through conductor.

Into the conductor paste, for the purpose of increasing close adhesion of the base body 16 and the lid body 17 to ceramics, aluminum oxide powder or powder of the same composite with a ceramics component forming the base body 16 and the lid body 117 can be added, for example, in the ratio of 0.05-2 volume %.

The first and second wiring conductors 20 and 21 are formed in the outer and inner layers of the base body 16 and the lid body 17 before, after, or concurrently with the formation of the via conductor achieved by filling the conductor paste into the through hole. The formation of the wiring conductors is achieved by print-coating a similar conductor paste in a predetermined pattern on the green sheet in accordance with the screen printing method, gravure printing method, or the like method.

Thereafter, a predetermined number of sheet-like molded bodies carrying the printed, filled conductor paste are subjected to positional alignment, and are then stacked on top of each other under pressure. The stacked body is then fired, in a non-oxidative atmosphere, at a high temperature of approximately 1200 to 1500° C. Thereby, the desired ceramic base body 16, the lid body 17, and the first and second wiring conductors 20 and 21 are obtained.

Further, it is preferable that the base body 16 and the lid body 17 made of ceramics have thickness of 0.2 mm or more. In a case where the thickness is less than 0.2 mm, because the strengths are apt to cover, the base body 16 and the lid body 17 tend to be easily cracked by stress caused when the base body 16 and the lid body 17 are mounted. On the other hand, in a case where the thickness is more than 5 mm, because slenderizing and low-profiling are difficult, it is hard to use as a fuel cell installed in small mobile equipment, and because a thermal capacity is large, it is likely to become hard to instantly set to appropriate temperature corresponding to an electrochemical reaction condition of the membrane electrode assembly 13.

The first wiring conductors 20 and the second wiring conductors 21 are electrically connected to the first electrode 14 and the second electrode 15 of the membrane electrode assembly 13, respectively, thereby functioning as conductive paths for taking out an electric current generated in the membrane electrode assembly 13 to the outside of the fuel cell casing 12.

The first wiring conductor 20 has its one end disposed in that part of the concavity bottom surface of the base body 16 which faces the first electrode 14 of the membrane electrode assembly 13, and its other end led out toward the outer surface of the base body 16. As described above, it is preferable that the first wiring conductor 20 is formed integrally with the base body 16 and is made 10 μm or above higher than the concavity bottom surface of the base body 16. This allows the first wiring conductor 20 to make contact with the first electrode 14 with ease. The desired height of the first wiring conductor 20 can be achieved by adjusting the printing condition such that the conductor paste is print-coated in a larger thickness during the print-coating process as described above. Further, the first wiring conductor 20 should preferably be arranged in plural face to face with the first electrode 14. This helps reduce electric loss in the first wiring conductor 20. That part of the first wiring conductor 20 which penetrates through the base body 16 should preferably be Φ50 μm or above in diameter.

The second wiring conductor 21 has its one end disposed in a part of a lower surface as one surface of the lid body 17 which faces the second electrode 15 of the membrane electrode assembly 13, and its other end led out toward the outer surface of the lid body 17. It is preferable that, like the first wiring conductor 20, the second wiring conductor 21 is formed integrally with the lid body 17 and is made 10 μm or above higher than the lower surface of the lid body 17. This allows the second wiring conductor 21 to make contact with the second electrode 15 with ease. The desired height of the second wiring conductor 21 can be achieved by adjusting the printing condition such that the conductor paste is print-coated in a larger thickness during the print-coating process as described above. Further, the second wiring conductor 21 should preferably be arranged in plural face to face with the second electrode 15. This helps reduce electric loss in the second wiring conductor 21. That part of the second wiring conductor 21 which penetrates through the lid body 17 should preferably be Φ50 μm or above in diameter.

It is preferable that the first and second wiring conductors 20 and 21 each have its exposed surface coated with a highly-conductive metal material such as nickel or gold which is highly corrosion-resistant and exhibits excellent wettability with respect to a brazing filler material, using the plating method. This makes it possible to establish satisfactory electrical connection between the first and second wiring conductors 20 and 21, as well as between the first, second wiring conductor 20, 21 and an external electric circuit.

The first and second wiring conductors 20 and 21 can be electrically connected to the first and second electrodes 14 and 15, respectively, by grippingly inserting the membrane electrode assembly 13 between the base body 16 and the lid body 17. By so doing, the first and second wiring conductors 20 and 21 are brought into pressure-contact with the first and second electrodes 14 and 15, respectively.

Arranged on the concavity bottom surface of the base body 16 facing the first electrode 14 and on the lower surface of the lid body 17 facing the second electrode 15 are the first fluid channel 18 and the second fluid channel 19, respectively. The first fluid channel 18 is so formed as to extend toward the outer surface of the base body 16, whereas the second fluid channel 19 is so formed as to extend toward the outer surface of the lid body 17. The first and second fluid channels 18 and 19 are constituted by the through holes pierced in the base body 16 and the lid body 17, grooves. The first and second fluid channels 18 and 19 each serve as a passage for a fluid to be supplied to the membrane electrode assembly 13, such as fuel gas for example hydrogen-rich reforming gas or oxidant gas for example oxygen or air, and besides serves as a passage for a fluid to be discharged from the membrane electrode assembly 13 after reactions, such as water or carbon dioxide produced through reactions.

Regarding a through hole or a groove which is pierced in the base body 16 and the lid body 17 as the first and second fluid channels 18 and 19, the diameter and number of the through hole, or the width, depth, and arrangement of the groove are determined according to the specifications of the fuel cell 11 in such a way that a fluid such as fuel gas or oxidant gas can be evenly supplied to the membrane electrode assembly 13.

In the fuel cell casing 12 and the fuel cell 11 embodying the invention, the first and second fluid channels 18 and 19 should preferably have a hole diameter of Φ0.1 mm or above and be equally spaced. Alternatively, in a case of forming grooves, the first and second fluid channels 18 and 19 should preferably have a width of 0.2 mm or above and a depth of 0.1 mm or above. This allows a fluid to flow into the membrane electrode assembly 13 under uniform pressure.

In this way, the first fluid channel 18 is disposed face to face with the lower principal surface of the membrane electrode assembly 13 having the first electrode 14, whereas the second fluid channel 19 is disposed face to face with the upper principal surface of the membrane electrode assembly 13 having the second electrode 15. With this arrangement, a fluid can be exchanged between the lower and upper principal surfaces of the membrane electrode assembly 13 and their corresponding first and second fluid channels 18 and 19, and thus the fluid can be supplied and discharged through the respective fluid path. Moreover, in the case of supplying gas as a fluid, it is possible to prevent a decrease in the partial pressure of the gas supplied to the first and second electrodes 14 and 15 of the membrane electrode assembly 13, and thus obtain a predetermined stable output voltage. Further, since the partial pressure of the supplied gas is stabilized, the inner pressure within the fuel cell 11 is made uniform. As a result, thermal stress occurring in the membrane electrode assembly 13 can be suppressed, leading to enhancement of the reliability of the fuel cell 11.

With the construction thus far described, it is possible to provide the compact and sturdy fuel cell casing 12 capable of housing the membrane electrode assembly 13 as shown in FIG. 1 and the fuel cell 11 that allows highly-efficient control according to the invention.

It should be noted that the invention need not be limited to the above-described embodiments and examples, and therefore various changes and modifications are possible without departing from the spirit or scope of the invention. For example, the first and second fluid channels may alternatively be constructed by forming an inlet on the side surface of the base body or the lid body. In this case, the fuel cell is slenderized as a whole, and the down-sized fuel cell can be effectively adopted in a portable electronic device. Moreover, the other ends of the first and second wiring conductors may be led out toward one common side surfaces of the base body and the lid body, respectively, instead of being led out toward the outer surfaces thereof. In this case, the wiring lines and the ducts can be put together only on one side of the fuel cell. This helps facilitate miniaturization and protection of the externally-connected portions. Thus, the fuel cell can be designed with high reliability, and operated with stability for a longer period of time.

Further, a plurality of membrane electrode assemblys are housed within the concavity of the base body, and these membrane electrode assemblys may be electrically connected to one another by the first and second wiring conductors. In this case, high-voltage or high-current output can be obtained, taken altogether.

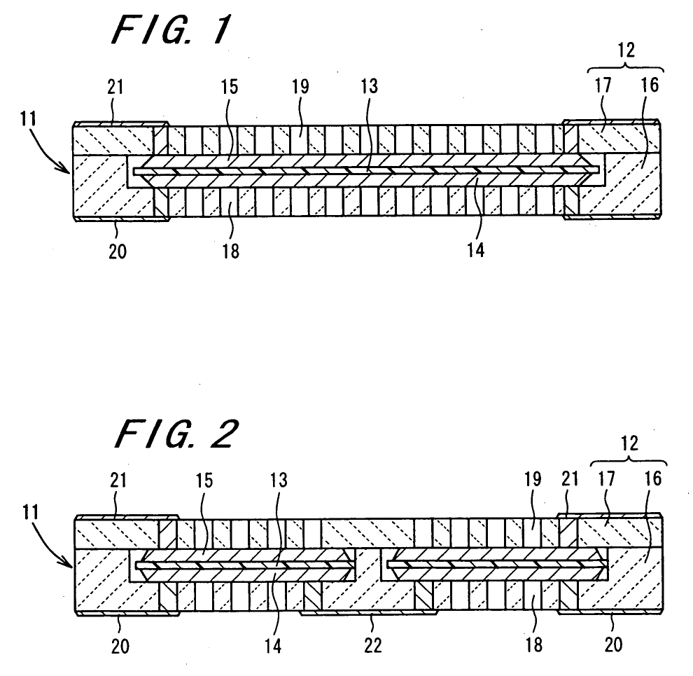

FIG. 2 is a sectional view showing a fuel cell casing and a fuel cell employing the same according to another embodiment of the invention. As seen from FIG. 2, in this embodiment, the membrane electrode assembly 13 is housed in each concavity of the base body 16 having a plurality of concavities. Moreover, a third wiring conductor 22 is so disposed as to extend across the region between the adjacent concavities. Thus, in a plurality of membrane electrode assemblys 13, their respective first electrodes 14, as well as their first and second electrodes 14 and 15, are electrically connected with one another. To obtain the overall output through the endmost membrane electrode assemblys 13, the first and second wiring conductors 20 and 21 are each electrically connected thereto. In this case, since the first to third wiring conductors allow free three-dimensional wiring, a plurality of membrane electrode assemblys can be arbitrarily connected in series or parallel to one another. This makes it possible to efficiently adjust the entire output voltage and output current. Thus, there are realized the fuel cell with which electricity electrochemically produced in the membrane electrode assemblys can be externally extracted satisfactorily.

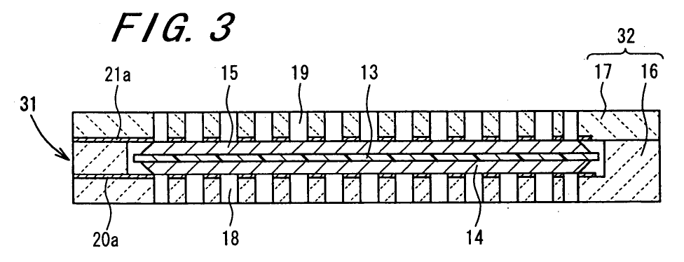

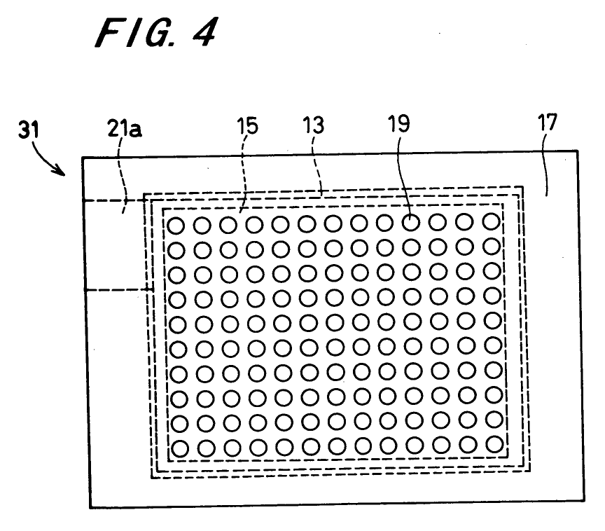

FIG. 3 is a sectional view showing a fuel cell casing and a fuel cell employing the same according to still another embodiment of the invention. FIG. 4 is a top view showing the fuel cell casing and the fuel cell employing the same according to still another embodiment of the invention. In this embodiment, the same components as those of the aforementioned embodiment will be denoted by the same reference numerals, and it will be omitted to describe in detail. In these figures, reference numeral 31 denotes a fuel cell; reference numeral 32 denotes a fuel cell casing; reference numeral 13 denotes a membrane electrode assembly; reference numeral 14 denotes a first electrode; reference numeral 15 denotes a second electrode; reference numeral 16 denotes a base body; reference numeral 17 denotes a lid body; reference numeral 18 denotes a first fluid channel; reference numeral 19 denotes a second fluid channel; reference numeral 20a denotes a first wiring conductor; reference numeral 21a denotes a second wiring conductor. In FIG. 4, the lid body 17 is drawn in perspective to aid in the understanding of the inner structure. The fuel cell casing 32 comprises the base body 16 and the lid body 17.

The first wiring conductor 20a has its one end disposed around the opening of the first fluid channel 18 facing the first electrode 14 of the membrane electrode assembly 13 on the bottom surface of the concavity of the base body 16, or more preferably, disposed over the entire area of the surface with which the first electrode 14 of the membrane electrode assembly 13 makes contact, and its other end led out toward the outer surface (i.e. bottom surface in the example of FIG. 3) of the base body 16. With this arrangement, the first wiring conductor 20a can be in immediate contact with the entire area of the principal surface of the first electrode 14 of the membrane electrode assembly 13, with the exception of the area facing with the opening of the first fluid channel 18. This makes it possible to increase the contact area between the first electrode 14 of the membrane electrode assembly 13 and the first wiring conductor 20a. As a result, an increase in electrical resistance and occurrence of improper contact can be effectively prevented, thus achieving a fuel cell that succeeds in providing high electricity-production efficiency. As described above, it is preferable that the first wiring conductor 20a is formed integrally with the base body 16 and is made 10 μm or above higher than the concavity bottom surface of the base body 16. This allows the first wiring conductor 20a to abut against the first electrode 14 with ease. The desired height of the first wiring conductor 20a can be achieved by adjusting the printing condition such that the conductor paste is print-coated in a larger thickness during the print-coating process as described above. Further, the first wiring conductor 20a should preferably be arranged in plural face to face with the first electrode 14. This helps reduce electric loss in the first wiring conductor 20a. That part of the first wiring conductor 20a which penetrates through the base body 16 should preferably be Φ50 μm or above in diameter.

The second wiring conductor 21a has its one end disposed around the opening of the second fluid channel 19 facing the second electrode 15 of the membrane electrode assembly 13 on the lower surface of the lid body 17, or equivalently disposed over the entire area of the surface with which the second electrode 15 of the membrane electrode assembly 13 makes contact, and its other end led out toward the outer surface (i.e. side surface in the example of FIG. 3 and FIG. 4) of the lid body 17. With this arrangement, the second wiring conductor 21a can be in immediate contact with the entire area of the principal surface of the second electrode 15 of the membrane electrode assembly 13, with the exception of the area facing with the opening of the second fluid channel 19. This makes it possible to increase the contact area between the second electrode 15 of the membrane electrode assembly 13 and the second wiring conductor 21a. As a result, an increase in electrical resistance and occurrence of improper contact can be effectively prevented, thus achieving a fuel cell that succeeds in providing high electricity-production efficiency. It is preferable that, like the first wiring conductor 20a, the second wiring conductor 21a is formed integrally with the lid body 17 and is made 10 μm or above higher than the lower surface of the lid body 17. This allows the second wiring conductor 21a to make contact with the second electrode 15 with ease. The desired height of the second wiring conductor 11 can be achieved by adjusting the printing condition such that the conductor paste is print-coated in a larger thickness during the print-coating process as described above. Further, the second wiring conductor 21a should preferably be arranged in plural face to face with the second electrode 15. This helps reduce electric loss in the second wiring conductor 21a. That part of the second wiring conductor 21a which penetrates through the lid body 17 should preferably be Φ50 μm or above in diameter.

It is preferable that the first and second wiring conductors 20a and 21a each have its exposed surface coated with a highly-conductive metal material such as nickel or gold which is highly corrosion-resistant and exhibits excellent wettability with respect to a brazing filler material, using the plating method. This makes it possible to establish satisfactory electrical connection between the first and second wiring conductors 20a and 21a, as well as between the first, second wiring conductor 20a, 21a and an external electric circuit.

The first and second wiring conductors 20a and 21a can be electrically connected to the first and second electrodes 14 and 15, respectively, by grippingly inserting the membrane electrode assembly 13 between the base body 16 and the lid body 17. By so doing, the first and second wiring conductors 20a and 21a are brought into pressure-contact with the first and second electrodes 14 and 15, respectively.

In this embodiment thus far described, the first and second wiring conductors 20a and 21a are formed on the entire concavity bottom surface around the opening of the first fluid channel 18 and on the entire lower surface of the lid body 17 around the opening of the second fluid channel 19, respectively, so as to abut against the first and second electrodes 14 and 15, respectively. This is because, such an arrangement makes it possible to increase the contact area between the first electrode 14 of the membrane electrode assembly 13 and the first wiring conductor 20a, as well as the contact area between the second electrode 15 and the second wiring conductor 20a, and also to reduce electrical resistance. By contrast, to increase the amount of electricity production, the membrane electrode assembly 3-side openings of the first and second fluid channels 18 and 19 may be made larger so as to increase fluid supply to the membrane electrode assembly 13. To achieve this, for example, on the periphery of the opening of the first, second fluid channel 18, 19 is provided a section free of the first, second wiring conductor 20a, 21a, i.e., a wiring conductor-absent section. This helps increase the area of the opening on the membrane electrode assembly 13 side; wherefore a fluid can be supplied more smoothly to the membrane electrode assembly 13. Alternatively, in accordance with the required quantity of fluid, at least one of the first and second wiring conductors 20a and 21a is designed as is described just above, whereas the other one is partially formed as to be electrically connected to part of the first or second electrode 14 or 15, or is arranged in plural.

Further, a plurality of membrane electrode assemblys are housed within the concavity of the base body, and these membrane electrode assemblys may be electrically connected to one another by the first and second wiring conductors. In this case, high-voltage or high-current output can be obtained, taken altogether.

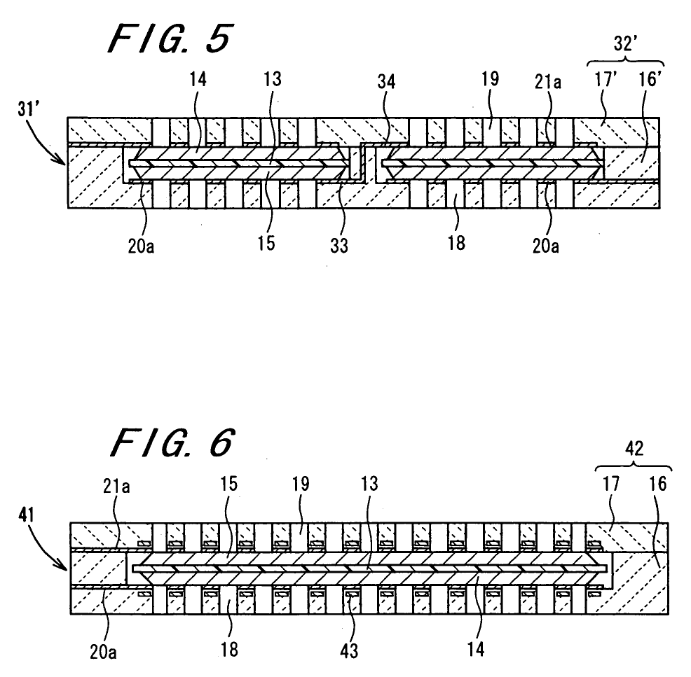

FIG. 5 is a sectional view showing a fuel cell casing and a fuel cell employing the same according to still another embodiment of the invention. As seen from FIG. 5, in this embodiment, the membrane electrode assembly 13 is housed in each concavity of the base body 16′ having a plurality of concavities. Moreover, a third wiring conductor 33 is disposed in the base body 16′ so as to extend across the region between the adjacent concavities, and a fourth wiring conductor 34 is disposed in the lid body 17′. The third and fourth wiring conductors are electrically connected to each other. Thus, in a plurality of membrane electrode assemblys 13, their respective first electrodes 14, as well as their first and second electrodes 14 and 15, are electrically connected with one another. To obtain the overall output through the endmost membrane electrode assemblys 13 connected in series with each other by the third and fourth wiring conductors 33 and 34, the first and second wiring conductors 20a and 21a are each electrically connected thereto. In this case, since the first to fourth wiring conductors 20a, 21a, 33, 34 allow free three-dimensional wiring, a plurality of membrane electrode assemblys 13 can be arbitrarily connected in series, or parallel (although not shown), to one another. This makes it possible to efficiently adjust the entire output voltage and output current. Thus, there are realized the fuel cell casing 32′ and the fuel cell 31′ with which electricity electrochemically produced in the membrane electrode assemblys 13 can be externally extracted satisfactorily.

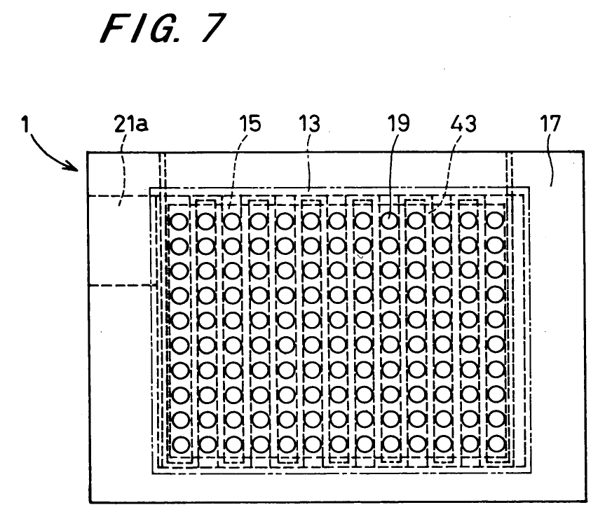

FIG. 6 is a sectional view showing a fuel cell casing and a fuel cell employing the same according to still another embodiment of the invention. FIG. 7 is a top view showing the fuel cell casing and the fuel cell employing the same according to the embodiment of the invention. In this embodiment, the same components as those of the aforementioned embodiment will be denoted by the same reference numerals, and it will be omitted to describe in detail. In these figures, reference numeral 41 denotes a fuel cell; reference numeral 42 denotes a fuel cell casing; reference numeral 13 denotes a membrane electrode assembly; reference numeral 14 denotes a first electrode; reference numeral 15 denotes a second electrode; reference numeral 16 denotes a base body; reference numeral 17 denotes a lid body; reference numeral 18 denotes a first fluid channel; reference numeral 19 denotes a second fluid channel; reference numeral 20a denotes a first wiring conductor; reference numeral 21a denotes a second wiring conductor; and reference numeral 43 denotes a heating element. In FIG. 7, the lid body 17 is drawn in perspective to aid in the understanding of the inner structure.

The constitution of a fuel cell 41 shown in FIG. 6 is similar to that of the fuel cell 31. Note that, the fuel cell 41 is provided with a heating element 43 in the base body 16 and the lid body 17. In addition, a fuel cell casing 42 comprises the base body 16 and the lid body 17.

The heating element 43 is formed on the periphery of at least one of the opening of the first fluid channel 18 disposed on the bottom surface of the concavity of the base body 16 and the opening of the second fluid channel 19 disposed on the lower surface of the lid body 17, for heating the lower or upper principal surface of the membrane electrode assembly 13. The heating element 43, which is formed on the periphery of the opening of the first fluid channel 18 disposed on the bottom surface of the concavity of the base body 16 and/or the opening of the second fluid channel 19 disposed on the lower surface of the lid body 17, may take on any given pattern so long as it is capable of heating the membrane electrode assembly 13 evenly. The preferred examples thereof include: a linear strip pattern as shown in FIG. 7; an arc-shaped strip pattern; a concentrically-shaped pattern; and a spiral pattern. Moreover, the heating element 43 may be divided into a plurality of patterns to improve evenness in heating.

The heating element 43 is preferably made of gold, silver, palladium, platinum-group metal, or alloy of the aforementioned, or made of metal having a high melting point such as tungsten, titanium, titanium nitride, or nickel. Moreover, it is preferable that the heating element 43 is provided with a feeding portion (not shown) made of gold, silver, palladium, platinum, or the like metal. Thereby, conduction of electricity is secured by bringing a conduction terminal into press-contact with the feeding portion.

In a case where the temperature of the membrane electrode assembly 13 is changed or varied, the quantity of current to be supplied to the feeding portion of the heating element 43 is controlled. By so doing, occurrence of undesirable temperature variations can be prevented in the membrane electrode assembly 13, and also the temperature distribution of the membrane electrode assembly 13 can be made uniform.

With the construction thus far described, it is possible to provide the compact and sturdy fuel cell casing 42 capable of housing the membrane electrode assembly 13 as shown in FIG. 6 and the fuel cell 41 that allows highly-efficient control according to the invention.

It should be noted that the invention need not be limited to the above-described embodiments and examples, and therefore various changes and modifications are possible without departing from the spirit or scope of the invention. For example, although not shown in the figure, a heat-insulating member made of for example porous ceramics, or hollow components maintained under vacuum or air, may be additionally provided, as a heat-insulating layer, in between the heating element 43 for heating the lower or upper principal surface of the membrane electrode assembly 13 and the outer surfaces of the base body 16 and the lid body 17. In this case, the time required to raise the temperature to a certain operation temperature level can be shortened, and thus the temperature of the membrane electrode assembly 13 can be controlled more efficiently. Besides, the temperature of the surface of the fuel cell casing 42 can be prevented from unduly increasing. As a result, the fuel cell 41 is excellent in compactness, convenience, and safety, and is accordingly suited for a portable electronic device.

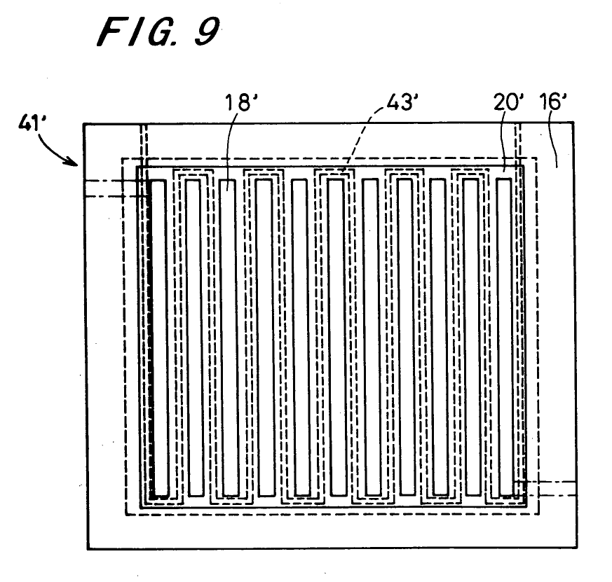

Moreover, Like FIGS. 6 and 7, FIGS. 8 and 9 are a sectional view and a top view, respectively, each showing a fuel cell casing and a fuel cell employing the same according to still another embodiment of the invention. As shown in the figures, the first and second fluid channels 18′ and 19′ may alternatively be constructed by forming an inlet on the side surface of the base body 16′ or the lid body 17′. In this case, the fuel cell 41′ is slenderized as a whole, and the down-sized fuel cell can be effectively adopted in a portable electronic device. Further, by increasing the velocity of flow of air flowing through the fluid channels 18′ and 19′, it is possible to ensure that water vapor is removed by the air concurrently with evaporation of the build-up water in the air electrode by the action of the heating element 43′. As a result, the fuel cell casing 42′ and the fuel cell 41′ succeed in offering further advantage.

In connection with the configurations of the first and second wiring conductors 20′ and 21′, the other ends thereof may be led out toward one common side surfaces of the base body 16′ and the lid body 17′, respectively, instead of being led out toward the outer surfaces thereof. In this case, the wiring lines and the ducts can be put together only on one side of the fuel cell 41′. This helps facilitate miniaturization and protection of the externally-connected portions. Thus, the fuel cell 41′ can be designed with high reliability, and operated with stability for a longer period of time.

Further, a plurality of membrane electrode assemblys 13 are housed within the concavity of the base body 16′, and these membrane electrode assemblys may be electrically connected to one another by the first and second wiring conductors 20′ and 21′. In this case, high-voltage or high-current output can be obtained, taken altogether.

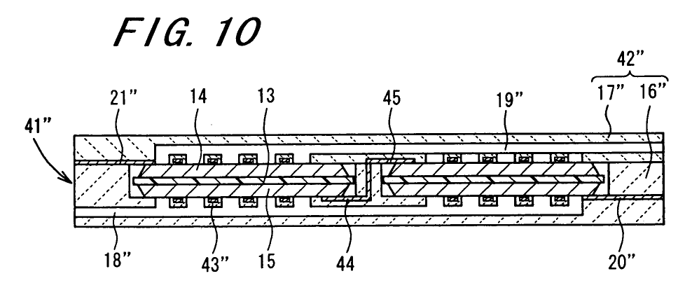

FIG. 10 is a sectional view analogous to FIG. 6 showing a fuel cell casing and a fuel cell employing the same according to still another embodiment of the invention. As seen from FIG. 10, in this embodiment, the membrane electrode assembly 13 is housed in each concavity of the base body 16″ having a plurality of concavities. Moreover, a third wiring conductor 44 is disposed in the base body 16″ so as to extend across the region between the adjacent concavities, and a fourth wiring conductor 45 is disposed in the lid body 17″. The third and fourth wiring conductors are electrically connected to each other. Thereby, in a plurality of membrane electrode assemblys 13, their respective first electrodes 14, as well as their first and second electrodes 14 and 15, are electrically connected with one another. To obtain the overall output through the endmost membrane electrode assemblys 13 connected in series with each other by the third and fourth wiring conductors 44 and 45, the first and second wiring conductors 20″ and 21″ may be each electrically connected thereto. In this case, since the first to fourth wiring conductors 20″, 21″, 44, and 45 allow free three-dimensional wiring, a plurality of membrane electrode assemblys 13 can be arbitrarily connected in series, or parallel (although not shown), to one another. This makes it possible to efficiently adjust the entire output voltage and output current. Thus, there are realized the fuel cell casing 42″ and the fuel cell 41″ with which electricity electrochemically produced in the membrane electrode assemblys 13 can be externally extracted satisfactorily.

FIG. 11 is a sectional view showing a fuel cell casing and a fuel cell employing the same according to still another embodiment of the invention. In this embodiment, the same components as those of the aforementioned embodiment will be denoted by the same reference numerals, and it will be omitted to describe in detail. In FIG. 11, reference numeral 51 denotes a fuel cell; reference numeral 52 denotes a fuel cell casing; reference numeral 13 denotes a membrane electrode assembly; reference numeral 14 denotes a first electrode; reference numeral 15 denotes a second electrode; reference numeral 16 denotes a base body; reference numeral 17 denotes a lid body; reference numeral 18 denotes a first fluid channel; reference numeral 19 denotes a second fluid channel; reference numeral 20 denotes a first wiring conductor; reference numeral 21 denotes a second wiring conductor; and reference numeral 53 denotes a hygroscopic member.

The constitution of a fuel cell 51 shown in FIG. 11 is similar to that of the fuel cell 11 shown in FIG. 1. Note that, at least one of the base body 16 and the lid body 17 is provided with a hygroscopic member 53. In addition, a fuel cell casing 52 comprises the base body 16 and the lid body 17.

At least one of the first and second fluid channels 18 and 19 has its inner surface fully or partly coated with the hygroscopic member 53. Therefore, water or water vapor produced through an electrochemical reaction in the membrane electrode assembly 13, can be easily absorbed and removed by the hygroscopic member 53, resulting in an advantage in effectively preventing a blockage from occurring in the first and second fluid channels 18 and 19 acting as fluid paths for fuel and air. This helps prevent effectively the electrode surfaces of the first and second electrodes 14 and 15 from being covered by water (H₂O), and thus allow effective supply of air acting as oxidant gas, obtained from fuel and atmosphere, through the first and second fluid channels 18 and 19. As a result, chemical reactions can be facilitated in the membrane electrode assembly 13, making highly-efficient electricity production possible.

As absorbent material used in the hygroscopic member which is applied to the inner surfaces of the first and second fluid channels 18 and 19, a highly water (H₂O)-absorbent material is preferably used. The examples thereof include: silica gel; alumina; clay; activated carbon; paper; and wood powder. Powder of inorganic substance such as silica gel, alumina, or clay is particularly desirable in terms of attaining a desired moisture-absorption property. This is because the water (H₂O)-absorbing area can be readily controlled by adjusting the size of the powder particle by pulverization or the like process.

In the case of applying such a hygroscopic member 53 to the inner surface of the first or second fluid channels 18 or 19, all of the first and second fluid channels 18 and 19 should preferably be subjected to application of the hygroscopic member 53. This makes it possible to maintain uniformity in the flow of the air, as oxidant gas obtained from atmosphere through the first and second fluid channels 18 and 19. Moreover, the thickness of the hygroscopic member 53 should preferably be adjusted to be 10% or below with respect to the opening area of the first, second fluid channel 18, 19. This is because the influence of loss pressure needs to be minimized at the time of supplying air as oxidant gas.

To facilitate evaporation of water from the hygroscopic member 53 by the action of air flow, it is preferable that the first and second fluid channels 18 and 19 have their inner walls fully covered with the hygroscopic member. By so doing, in a case where the fuel cell casing 52 and the fuel cell 51 of the invention is applied to a compact cell system such as a portable DMFC (Direct Methanol Fuel Cell), for example, the cell system can be operated for dozens of hours only with 10 ml of methanol. Regarding the amount of water production, only 1 ml of water (H₂O) is produced per consumption of 1 g methanol. That is, the water (H₂O) absorbed by the hygroscopic member 53 is so small in quantity that it evaporates sufficiently by wind generated by a fan. Thus, the water production does not have any serious effect on continuous operation at all.

With the construction thus far described, it is possible to provide the compact and sturdy fuel cell casing 52 capable of housing the membrane electrode assembly 13 as shown in FIG. 11 and the fuel cell 51 that allows highly-efficient control according to the invention.

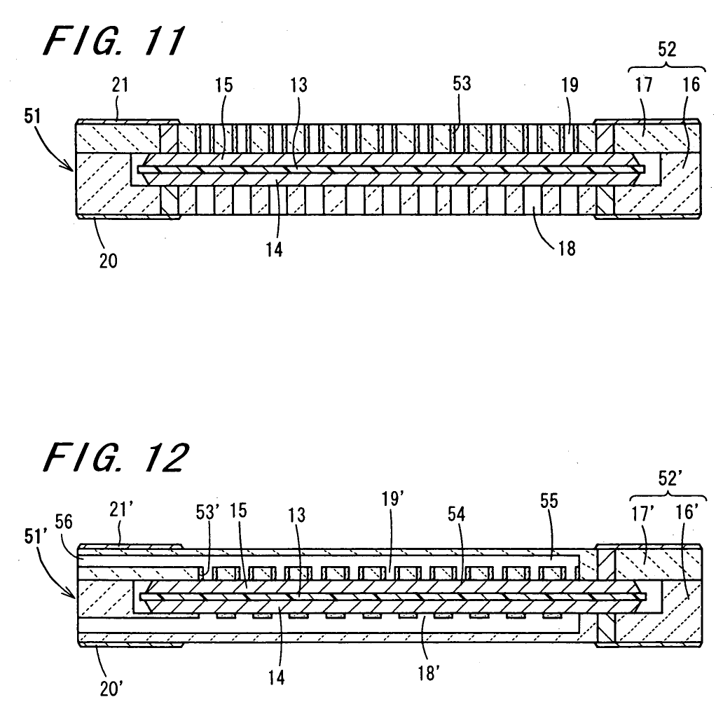

FIG. 12 is a sectional view showing a fuel cell casing and a fuel cell employing the same according to still another embodiment of the invention. As seen from FIG. 12, in this embodiment, the membrane electrode assembly 13 is housed in each concavity of the base body 16′ having some concavities. At least one of the first and second fluid channels 18′ and 19′ is provided with an opening portion 54; a coupling portion 55; a fluid introducing portion 56; and a discharge portion (not shown). The opening portion 54 is composed of a plurality of equally-spaced groove-like openings that are identical in length and width. The opening portion is arranged on the bottom surface of the concavity face to face with the lower and upper principal surfaces of the membrane electrode assembly 13. The coupling portion 55 serves to couple together one ends, as well as the other ends, of a plurality of openings. The fluid introducing portion 56 is so formed as to extend from one and the other side of the coupling portion 55 to the outer surface. The first and second electrodes 14 and 15 are electrically connected to the first wiring conductor 20′ and the second wiring conductor 21′, respectively. In this case, a fluid can be readily supplied to the opening portion 54 taking on the form of a plurality of grooves, by the fluid introducing portion 56 and the coupling portion 55. A plurality of groove-like openings constituting the opening portion 54 are identical in length and width, and are equally spaced. Thus, even if a fluid flows at high speed, since the distance between the introducing portion 56 and the discharge portion is short, the resistance as observed in the fluid path is decreased. As a result, the uniform suppliability of the fluid to be supplied to the membrane electrode assembly 13 can be enhanced, and the water (H₂O) absorbed by the hygroscopic member 53′ can be continuously dried and removed by the air supplied as oxidant gas from atmosphere. Moreover, since the first and second wiring conductors 20′ and 21′ allow free three-dimensional wiring, a plurality of membrane electrode assemblys 13 can be arbitrarily connected in series or parallel to one another. This makes it possible to efficiently adjust the output voltage and output current as a whole. Thus, there are realized the fuel cell casing 52′ and the fuel cell 51′ with which electricity electrochemically produced in the membrane electrode assemblys 13 can be externally extracted satisfactorily.

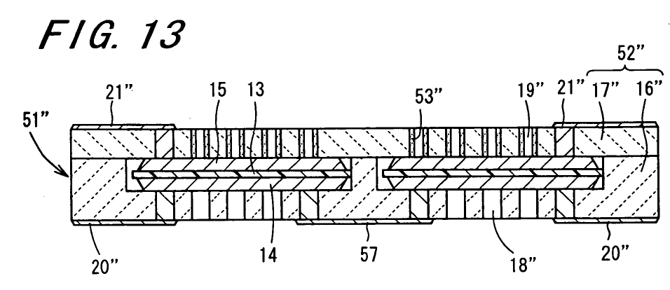

FIG. 13 is a sectional view showing a fuel cell casing and a fuel cell employing the same according to still another embodiment of the invention. As seen from FIG. 13, in this embodiment, the membrane electrode assembly 13 is housed in each concavity of the base body 16″ having a plurality of concavities. Moreover, a third wiring conductor 16 is so disposed as to extend across the region between the adjacent concavities. Thus, in a plurality of membrane electrode assemblys 13, their respective first electrodes 14, as well as their first and second electrodes 14 and 15, are electrically connected with one another. To obtain the overall output through the endmost membrane electrode assemblys 3, the first and second wiring conductors 20″ and 21″ are each electrically connected thereto. In this case, since the first to third wiring conductors 20″, 21″, and 57 allow free three-dimensional wiring, a plurality of membrane electrode assemblys 13 can be arbitrarily connected in series or parallel to one another. This makes it possible to efficiently adjust the entire output voltage and output current. Thus, there are realized the fuel cell casing 52″ and the fuel cell 51″ with which electricity electrochemically produced in the membrane electrode assemblys 13 can be externally extracted satisfactorily.

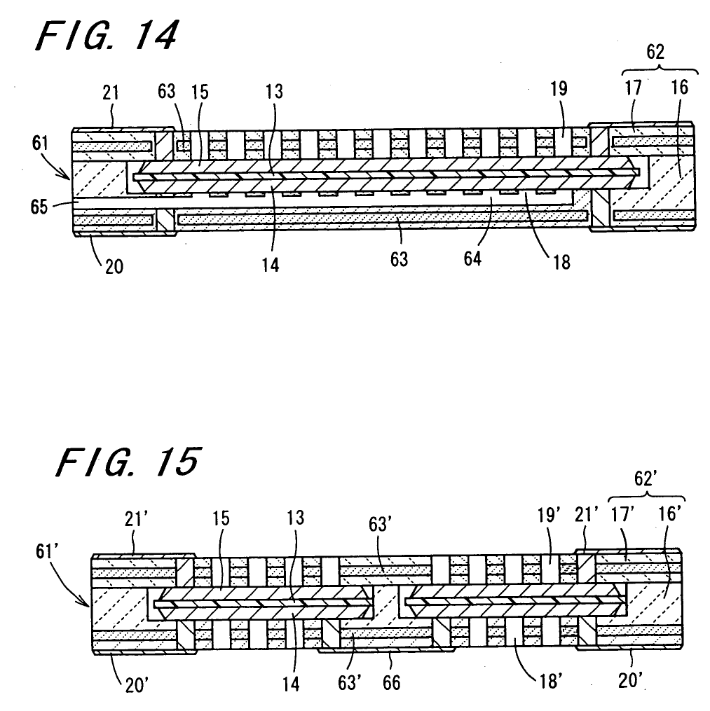

FIG. 14 is a sectional view showing a fuel cell casing and a fuel cell employing the same according to one embodiment of the invention. In this embodiment, the same components as those of the aforementioned embodiment will be denoted by the same reference numerals, and it will be omitted to describe in detail. In FIG. 14, reference numeral 61 denotes a fuel cell; reference numeral 62 denotes a fuel cell casing; reference numeral 13 denotes a membrane electrode assembly; reference numeral 14 denotes a first electrode; reference numeral 15 denotes a second electrode; reference numeral 16 denotes a base body; reference numeral 17 denotes a lid body; reference numeral 18 denotes a first fluid channel; reference numeral 19 denotes a second fluid channel; reference numeral 20 denotes a first wiring conductor; reference numeral 21 denotes a second wiring conductor; reference numeral 63 denotes a heat-insulating layer; reference numeral 64 denotes a coupling portion; and reference numeral 65 denotes a introducing portion.

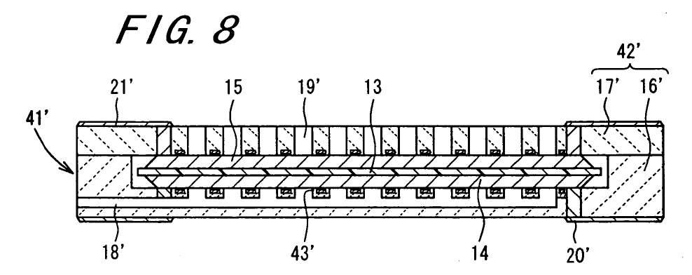

The constitution of a fuel cell 61 shown in FIG. 14 is similar to that of the fuel cell 41′ shown in FIG. 8. Note that, at least one of the base body 16 and the lid body 17 is provided with a heat-insulating layer 63. In addition, a fuel cell casing 62 comprises the base body 16 and the lid body 17.

In the fuel cell 61 and the fuel cell casing 62 embodying the invention, the heat-insulating layer 63 is formed in at least one of a part of the base body 16 which part is in the vicinity of the concavity, that is a part located on a lower side from the concavity in base body 16, and a part of the lid body 17 which part is in the vicinity of the concavity, that is, a part located on an upper side from the concavity in the lid body 17. In this embodiment, the heat-insulating layer 63 is provided in both of these regions. One heat-insulating layer 63 of the base body 16 is formed below the first fluid channel 18, in the lower part of the concavity, so as to extend over substantially the entire surface inside the base body 16. In other words, the one heat-insulating layer 63 of the base body 16 is formed between the bottom surface of the concavity in the base body 16 and the outer surface of the base body 16. Another heat-insulating layer 63 of the lid body 17 is so formed as to extend over substantially the entire inner surface of the lid body 17, through which the second fluid channel 19 passes. In other words, the other heat-insulating layer 63 of the lid body 17 is formed between the lower surface as the one surface facing the concavity in the lid body 17 and the outer surface of the lid body 17. Such a configuration of the heat-insulating layer 63 affords the following advantages. Since the heat-insulating layer 63 is arranged face to face with the principal surface of the membrane electrode assembly 13, heat produced through a chemical reaction is shut off by the heat-insulating layer 63. Thus, the outer surface of the fuel cell casing 62 can be prevented from getting hot with ease, and also the membrane electrode assembly 13 can be maintained at an optimum temperature. As a result, the chemical reaction efficiency can be enhanced. In this way, since the electricity-production efficiency of the fuel cell 61 can be increased, with respect to arbitrary outputs, the membrane electrode assembly 13 can be down-sized, and the fuel cell 61 itself can accordingly be made both smaller in size and lower in profile, leading to excellent portability. In the alternative, the heat-insulating layer 63 may also be disposed on the side surface of the concavity of the base body 16 and on the side surface of the lid body 17.

In the case of forming the heat-insulating layer 63 from porous ceramics, porous green sheets are prepared first. The porous green sheets are stacked on top of each other to obtain a portion constituting a certain layer of the green-sheet stacked body, made of sintered aluminum oxide powder, that is formed into the base or lid body 16 or 17, followed by firing. For example, the porous green sheet is formed as follows. Firstly, there is prepared an aggregate made of electrically-fused alumina and electrically-fused mullite having a grain size of 10 to 150 μm. The aggregate including the electrically-fused alumina, sintered alumina, and electrically-fused mullite is properly adjusted to have a composition of Al₂O₃: 85 to 95 mass %; SiO₂: 5 to 15 mass %; and ineluctable impurities when formed into an alumina-mullite porous green sheet. The alumina-mullite porous green sheet is obtained by using the aggregate in the amount of 50 to 85% by mass and a binder in the amount of 15 to 50% by mass. Then, an organic binder, organic solvent, plasticizer, etc. is added to the aggregate of predetermined amount to form porous ceramic powder, and rare-earth oxide powder and sintering aids are mixedly added thereto to form a slurry. The slurry is then formed into a porous green sheet by the doctor blade method or calendar roll method. The alumina-mullite porous green sheet is subjected to a mold-aided punching process, micro drill-aided punching process, laser light application-aided punching process, or the like stamping process to obtain a desired configuration. After that, the porous green sheets are stacked on top of each other to form a portion constituting a certain layer of the green-sheet stacked body made of sintered aluminum oxide powder, followed by firing. Thereby, the heat-insulating layer 63 is constituted.

In the case of forming the heat-insulating layer 63 from sintered porous ceramics, for example, a paste containing glass is applied to a certain part of sintered alumina-mullite porous ceramics to obtain a glass bonding layer. Then, the glass bonding layer is bonded to a certain layer of sintered aluminum oxide. Subsequently, the stacked body thus obtained is heated in a reducing atmosphere at a temperature of approximately 300 to 500° C. In the alternative, an adhesive made of epoxy resin having high heat resistance or polyimide resin is applied to a certain part of sintered alumina-mullite porous ceramics, and the adhesive-applied part is bonded to a certain layer of sintered aluminum oxide. Thereby, the heat-insulating layer 12 is constituted.

In the case of forming the heat-insulating layer 63 from hollow components, a green sheet made of sintered aluminum oxide powder is subjected in advance to a mold-aided punching process, micro drill-aided punching process, laser light application-aided punching process, or the like stamping process, at its predetermined position, to obtain a desired configuration. After that, the green sheets are stacked on top of each other to form a portion constituting a certain layer of the green-sheet stacked body made of sintered aluminum oxide powder, followed by firing. The hollow component may be shaped either as a circular hole or as a rectangular hole. In terms of the size and number thereof, the larger the size and the number, the better the heat-insulating layer 63 works. However, the hollow component needs to be designed in consideration of the mechanical strength of the fuel cell casing 62.

The heat-insulating layer 63 is arranged in the region between the fluid channel 18, 19 and the outer surfaces of the base body 16 and the lid body 17. The thickness of the heat-insulating layer 63 should preferably be set at 0.1 mm or above. If the thickness is less than 0.1 mm, the heat-insulating layer 63 may fail to exert satisfactory thermal-conduction control effect, and thus it becomes difficult to prevent the outer surface of the fuel cell 61 from getting hot. By contrast, if the thickness is greater than 5 mm, it becomes difficult to make the fuel cell 61 both smaller in thickness and lower in profile, and thus the fuel cell 61 becomes unsuited for a compact portable device. Moreover, regarding the temperature distribution as observed in the membrane electrode assembly 13 during electricity production, the principal surface and its periphery of the membrane electrode assembly 13 tend to have higher temperatures. Thus, in the case of forming the heat-insulating layer 63 from hollow components, the heat-insulating layer 63 should preferably be arranged face to face with the principal surface of the membrane electrode assembly 13. By increasing the size and number (open area ratio) of the hollow component facing the principal surface and its periphery in particular, or by increasing the thickness of the hollow component, the heat-shutoff property of the heat-insulating layer 63 and the temperature distribution of the membrane electrode assembly 13 can be adjusted properly.

Moreover, the heat-insulating layer 63 is formed in at least one of the lower part of the concavity of the base body 16 and the upper part of the concavity of the lid body 17, so as to surround the lower or upper principal surface of the membrane electrode assembly 13. The heat-insulating layer 63 may take on any given pattern so long as it is capable of evenly shutting off heat produced through an electrochemical reaction in the membrane electrode assembly 13, as shown in FIG. 14. For example, the heat-insulating layer 63 may be formed in the vicinity of the opening of the first fluid channel 18 disposed on the concavity bottom surface of the base body 16 and in the bottom plate in the vicinity of the coupling portion 64, or formed in the vicinity of the opening of the second fluid channel 19 disposed in the lid body 17.

With the construction thus far described, it is possible to provide the compact and sturdy fuel cell casing 62 capable of housing the membrane electrode assembly 13 as shown in FIG. 14 and the fuel cell 61 that allows highly-efficient control according to the invention.

It should be noted that the invention need not be limited to the above-described embodiments and examples, and therefore various changes and modifications are possible without departing from the spirit or scope of the invention. For example, although not shown in the figure, a heating element may additionally be formed in between the membrane electrode assembly 13 and the heat-insulating layer 63. The heating element is preferably made of gold, silver, palladium, platinum-group metal, or alloy of the aforementioned, or made of metal having a high melting point such as tungsten, titanium, titanium nitride, or nickel. Moreover, it is preferable that the heating element is provided with a feeding portion (not shown) made of gold, silver, palladium, platinum, or the like metal. Thereby, conduction of electricity is secured by bringing a conduction terminal into press-contact with the feeding portion. In a case where the temperature of the membrane electrode assembly 13 is changed or varied, the quantity of current to be supplied to the feeding portion of the heating element is controlled. By so doing, occurrence of undesirable temperature variations can be prevented in the membrane electrode assembly 13, and also the temperature distribution of the membrane electrode assembly 13 can be made uniform. Further, the time required to raise the temperature to a certain operation temperature level can be shortened, and thus the temperature of the membrane electrode assembly 13 can be controlled more efficiently. As a result, the fuel cell 61 is excellent in compactness, convenience, and safety, and is accordingly suited for a portable electronic device.

FIG. 15 is a sectional view showing a fuel cell casing and a fuel cell employing the same according to still another embodiment of the invention. As seen from FIG. 15, in this embodiment, the membrane electrode assembly 13 is housed in each concavity of the base body 16′ having a plurality of concavities. Moreover, a third wiring conductor 66 is so disposed as to extend across the region between the adjacent concavities. Thus, in a plurality of membrane electrode assemblys 13, their respective first electrodes 14, as well as their first and second electrodes 14 and 15, are electrically connected with one another. To obtain the overall output through the endmost membrane electrode assemblys 13, the first and second wiring conductors 20′ and 21′ are each electrically connected thereto. In this case, since the first to third wiring conductors 20′, 21′, and 66 allow free three-dimensional wiring, a plurality of membrane electrode assemblys 13 can be arbitrarily connected in series or parallel to one another. This makes it possible to efficiently adjust the entire output voltage and output current. Thus, there are realized the fuel cell casing 62′ and the fuel cell 61′ with which electricity electrochemically produced in the membrane electrode assemblys 3 can be externally extracted satisfactorily.

Further, in the above embodiments the first and second wiring conductors 20, 20a, 20′, 20″ and 21, 21a, 21′, 21″ have their surfaces coated with any of gold, platinum, and palladium. The coating may be realized by vapor deposition, preferably, however, a plating method is adopted.

In the case of adopting an electrolytic plating method for example, the coating is carried out as follows. The base body 16 and the lid body 17 are immersed in an electrolytic gold-plating solution composed of potassium gold cyanide, potassium cyanide, tripotassium citrate, monobasic potassium phosphate, ammonium sulfate, and thallium sulfate. Then, by exploiting a predetermined electric power for plating, a gold-plating film is applied to the surfaces of the first and second wiring conductors 20, 20a, 20′, 20″ and 21, 21a, 21′, 21″ made of tungsten, molybdenum, or an alloy of these components with use of a plating jig or the like.

If the gold-plating film has a thickness of less than 0.1 μm, the first and second wiring conductors 20, 20a, 20′, 20″ and 21, 21a, 21′, 21″ made of tungsten, molybdenum, or an alloy of these components cannot be protected from corrosion. Thus, the thickness should preferably be set at 0.1 μm or above. From a cost-effectiveness standpoint, the thickness should preferably be kept in a range from 0.1 to 3 μm.

In addition to the gold plating described just above, as a plating material having a corrosion-resistant property, a plating film composed of at least one of gold, platinum, palladium, and an allow having the aforementioned as a major constituent, may also be used to coat the first and second wiring conductors 20, 20a, 20′, 20″ and 21, 21a, 21′, 21″.

The fuel cell of the invention is incorporated as a power source in a variety of electronic apparatus. The concrete examples thereof include: portable electronic devices such as a portable telephone, PDA (Personal Digital Assistants), a digital camera, a video camera, and a toy like a portable game machine; household electric appliances such as a laptop PC (personal computer), a portable printer, a facsimile machine, a television set, a communication device, an audio/video system, and an electric fan; and electronic devices such as a power tool. In an electronic device incorporating the fuel cell 1 of the invention, since at least one of the first and second wiring conductors is formed around the opening of the first fluid channel disposed on the bottom surface of the concavity, or around the opening of the second fluid channel disposed on the lower surface of the lid body, so as to abut against the first or second electrode, and also has its surface coated with any of gold, platinum, and palladium, the contact area between the first electrode of the membrane electrode assembly and the first wiring conductor, as well as the contact area between the second electrode and the second wiring conductor, can be increased, and direct connection can be established therebetween. Thereby, an increase in electrical resistance and occurrence of improper contact can be effectively prevented, and the first and second wiring conductors can be protected from corrosion, thus achieving an electronic device having high electricity-production efficiency that can be operated with stability for a longer period of time.

Another advantage is that, since the fuel cell and the fuel cell casing of the invention are excellent in compactness and convenience, and are capable of achieving long-duration power supply by dint of highly-efficient electrical connection, the electronic device main body can be made compact, thin-walled, and lightweight. Moreover, for example, even if a portable phone main body receives an impact due to a fall, it is able to offer higher impact resistance and higher water resistance than ever before.

Further, in a case where the structure of the power source portion 123 is a structure that the fuel cell and the fuel cell casing can be freely attached and detached, it is possible, by preparing a spare fuel cell and fuel cell casing, to easily replace to a spare fuel cell and fuel cell casing or take out a fuel cell to replenish and replace fuel in case of battery shutoff or the like, so that it is possible to continuously speak on the phone, and the phone becomes more excellent in convenience than conventional one that uses a storage battery as a power source. There is a merit that it is possible to use even in case of emergency such as blackout.

The invention is not limited to the above embodiments and can be changed in various manners in the scope of the invention, and, for example, a DMFC that uses methanol as fuel is used as a fuel cell in the above embodiments. Further, a fuel cell that uses various kinds of liquids including dimethyl ether as fuel can be also used.

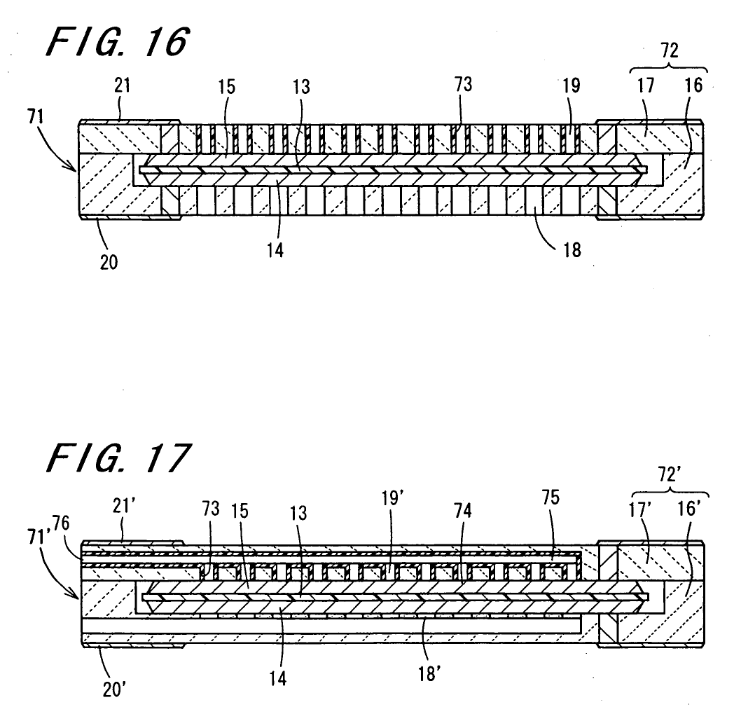

FIG. 16 is a sectional view showing a fuel cell casing and a fuel cell employing the same according to still amother embodiment of the invention. In this embodiment, the same components as those of the aforementioned embodiment will be denoted by the same reference numerals, and it will be omitted to describe in detail. In FIG. 16, reference numeral 71 denotes a fuel cell; reference numeral 72 denotes a fuel cell casing; reference numeral 13 denotes a membrane electrode assembly; reference numeral 14 denotes a first electrode; reference numeral 15 denotes a second electrode; reference numeral 16 denotes a base body; reference numeral 17 denotes a lid body; reference numeral 18 denotes a first fluid channel; reference numeral 19 denotes a second fluid channel; reference numeral 20 denotes a first wiring conductor; reference numeral 21 denotes a second wiring conductor; and reference numeral 73 denotes a hydrophobic coating.

The constitution of a fuel cell 71 shown in FIG. 16 is similar to that of the fuel cell 11 shown in FIG. 1. Note that, at least one of the base body 16 and the lid body 17 is provided with a hydrophobic coating 73. In addition, a fuel cell casing 72 comprises the base body 16 and the lid body 17.

At least one of the first and second fluid channels 18 and 19 has its inner surface fully or partly coated with the hydrophobic coating 73. Therefore, water droplets caused by condensation of water vapor, as well as water produced through an electrochemical reaction in the membrane electrode assembly 13, can be easily discharged and removed by the hydrophobic coating 73, resulting in an advantage in effectively preventing a blockage from occurring in the first and second fluid channels 18 and 19 acting as fluid paths for fuel and air. This helps prevent effectively the electrode surfaces of the first and second electrodes 14 and 15 from being covered by water (H₂O), and thus allow effective supply of air acting as oxidant gas, obtained from fuel and atmosphere, through the first and second fluid channels 18 and 19. As a result, chemical reactions can be facilitated in the membrane electrode assembly 13, making highly-efficient electricity production possible.

The hydrophobic coating 73, which is coated on the inner surface of at least one of the first and second fluid channels 8 and 9, is made of a material repellent to water (H₂O). The preferred examples thereof include: a material metallized with tungsten, copper, silver, or gold; a material plated with gold; and a material coated with fluorocarbon polymer, silane coupling agent, or Teflon (Registered trademark). Of these examples, a gold-plated material is particularly desirable in terms of attainment of desired water repellency, because it lends itself to adjustment of a contact angle with respect to water (H₂O) conducted by changing the surface roughness and fineness conditions.

In the case of applying such a hydrophobic coating 73 to the inner surface of the first or second fluid channels 18 or 19, all of the first and second fluid channels 18 and 19 should preferably be subjected to application of the hydrophobic coating 73. This makes it possible to maintain uniformity in the flow of the air, as oxidant gas obtained from atmosphere through the first and second fluid channels 18 and 19. Moreover, the thickness of the hydrophobic coating 73 should preferably be adjusted to be 10% or below with respect to the opening area of the first, second fluid channel 18, 19. This is because the influence of loss pressure needs to be minimized at the time of supplying air as oxidant gas.

Moreover, to facilitate discharge of water droplets from the hydrophobic coating 73 by the flow of fuel or air, the first and second fluid channels 18 and 19 have their inner surfaces fully coated with the hydrophobic coating 73. By so doing, the fuel cell casing 72 and the fuel cell 71 embodying the invention may be adopted as a compact-type cell system such as a portable DMFC (Direct Methanol Fuel Cell).

With the construction thus far described, it is possible to provide the compact and sturdy fuel cell casing 72 capable of housing the membrane electrode assembly 13 as shown in FIG. 16 and the fuel cell 71 that allows highly-efficient control according to the invention.

The fuel cell 71 of the invention is incorporated as a power source in a variety of electronic apparatus. The concrete examples thereof include: portable electronic devices such as a portable telephone, PDA (Personal Digital Assistants), a digital camera, a video camera, and a toy like a portable game machine; household electric appliances such as a laptop PC (personal computer), a portable printer, a facsimile machine, a television set, a communication device, an audio/video system, and an electric fan; and electronic devices such as a power tool. In an electronic device incorporating the fuel cell 71 of the invention, since at least one of the first and second fluid channels has its inner surface fully or partly coated with the hydrophobic coating, the fluid path surrounded by the hydrophobic coating exhibits satisfactory water repellency. Thereby, condensation of water occurring inside the first and second fluid channels, as well as water (H₂O) produced through an electrochemical reaction in the membrane electrode assembly, can be easily discharged and removed from the duct under the pressure of fuel and air supplied, resulting in an advantage in effectively preventing clogging of water droplets in the first and second fluid channels. This helps prevent the electrode surfaces of the first and second electrodes from being covered by water (H₂O), and thus allow effective supply of air acting as oxidant gas, obtained from fuel and atmosphere, through the first and second fluid channels. Therefore, chemical reactions can be facilitated in the membrane electrode assembly, and resultantly the electronic device is operated with stability for a longer period of time.

FIG. 17 is a sectional view showing a fuel cell casing and a fuel cell employing the same according to still another embodiment of the invention. As seen from FIG. 17, in this embodiment, the membrane electrode assembly 13 is housed in each concavity of the base body 16′ having some concavities. At least one of the first and second fluid channels 18′ and 19′ is provided with an opening portion 74; a coupling portion 75; a fluid introducing portion 76; and a discharge portion (not shown). The opening portion 74 is composed of a plurality of equally-spaced groove-like openings that are identical in length and width. The opening portion is arranged on the bottom surface of the concavity face to face with the lower and upper principal surfaces of the membrane electrode assembly 3. The coupling portion 75 serves to couple together one ends, as well as the other ends, of a plurality of openings. The fluid introducing portion 15 is so formed as to extend from one and the other side of the coupling portion 75 to the outer surface. The first and second electrodes 14 and 15 are electrically connected to the first wiring conductor 20′ and the second wiring conductor 21′, respectively. In this case, a fluid can be readily supplied to the opening portion 74 taking on the form of a plurality of grooves, by the fluid introducing portion 76 and the coupling portion 75. A plurality of groove-like openings constituting the opening portion 74 are identical in length and width, and are equally spaced. Thus, even if a fluid flows at high speed, since the distance between the introducing portion 76 and the discharge portion is short, the resistance as observed in the fluid path is decreased. As a result, the uniform suppliability of the fluid to be supplied to the membrane electrode assembly 13 can be enhanced, and the water (H₂O) produced through condensation on the hydrophobic coating 73 can be discharged by the air supplied as oxidant gas from fuel and atmosphere. Moreover, since the first and second wiring conductors 20′ and 21′ allow free three-dimensional wiring, a plurality of membrane electrode assemblys 13 can be arbitrarily connected in series or parallel to one another. This makes it possible to efficiently adjust the output voltage and output current as a whole. Thus, there are realized the fuel cell casing 72′ and the fuel cell 71′ with which electricity electrochemically produced in the membrane electrode assemblys 13 can be externally extracted satisfactorily.

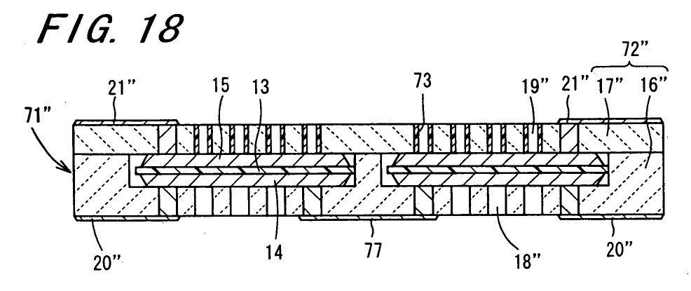

FIG. 18 is a sectional view showing a fuel cell casing and a fuel cell employing the same according to still another embodiment of the invention. As seen from FIG. 18, in this embodiment, the membrane electrode assembly 13 is housed in each concavity of the base body 16″ having a plurality of concavities. Moreover, a third wiring conductor 77 is so disposed as to extend across the region between the adjacent concavities. Thus, in a plurality of membrane electrode assemblys 13, their respective first electrodes 14, as well as their first and second electrodes 14 and 15, are electrically connected with one another. To obtain the overall output through the endmost membrane electrode assemblys 13, the first and second wiring conductors 20″ and 21″ are each electrically connected thereto. In this case, since the first to third wiring conductors 20″, 21″, and 77 allow free three-dimensional wiring, a plurality of membrane electrode assemblys 13 can be arbitrarily connected in series or parallel to one another. This makes it possible to efficiently adjust the entire output voltage and output current. Thus, there are realized the fuel cell casing 72″ and the fuel cell 71″ with which electricity electrochemically produced in the membrane electrode assemblys 13 can be externally extracted satisfactorily.

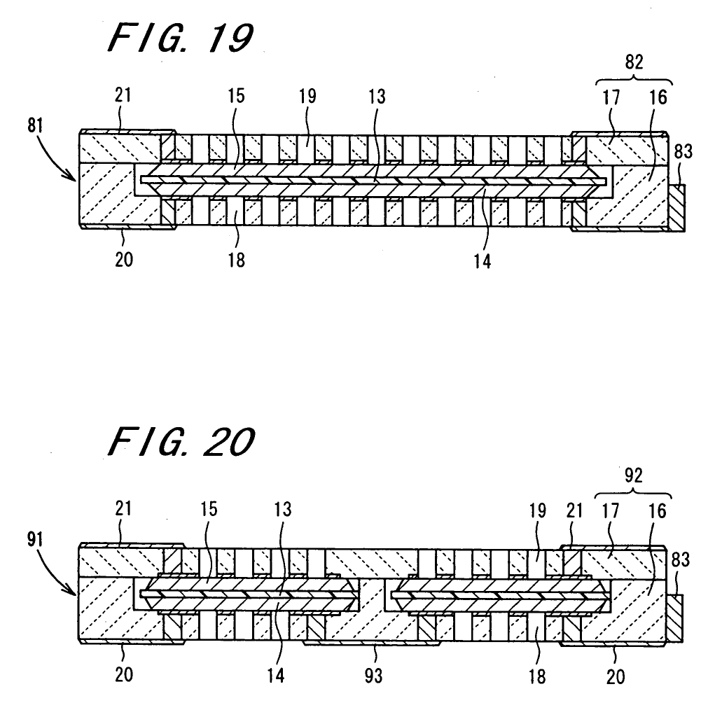

FIG. 19 is a sectional view showing an embodiment of fuel cell installed in an electronic apparatus, according to one embodiment of the invention. In this embodiment, the same components as those of the aforementioned embodiment will be denoted by the same reference numerals, and it will be omitted to describe in detail.

In FIG. 19, reference numeral 81 denotes a fuel cell, reference numeral 82 denotes a fuel cell casing, reference numeral 13 denotes a membrane electrode assembly, reference numeral 14 denotes a first electrode, reference numeral 15 denotes a second electrode, reference numerals 16 denotes a base body, reference numerals 17 denotes a lid body, reference numeral 18 denotes a first fluid channel, reference numeral 19 denotes a second fluid channel, reference numeral 20 denotes a first wiring conductor, reference numeral 21 denotes a second wiring conductor, reference numeral 83 denotes an external connection terminal. The electronic apparatus is a mobile phone, a PDA (personal digital assistant), a digital camera or the like. Concrete examples thereof will be described later.

The constitution of a fuel cell 81 shown in FIG. 19 is similar to that of the fuel cell 11 shown in FIG. 1. Note that, at least one of the base body 16 and the lid body 17 is provided with an external connection terminal 83. In addition, a fuel cell casing 82 comprises the base body 16 and the lid body 17.

The external connection terminals 83 are bonded to at least either the base body 6 or the lid body 7 by soldering, brazing or the like. It is desirable that the external connection terminals 83 have a shape that enables fine electrical connection with a motherboard or the like for forming an electronic circuit as a main part of electronic apparatus. Such a shape is, for example, a rod, a hook, a cone or the like that allows easy electrical and mechanical connection to an electronic circuit as a main part of electronic apparatus by making the terminals in contact with each other or inserting the terminal. It is preferable to dispose a fitting portion (a hole or the like) corresponding to the external connection terminal to a region where the external connection terminal 12 is connected of an electronic circuit as a main part of electronic apparatus. Besides, by placing the external connection terminal 83 on the side surface of the base body or the lid body, it is possible to low-profile electronic apparatus.

By coating the exposed surfaces of the first wiring conductors 20, the second wiring conductors 21, and the external connection conductors 83 with metal such as nickel, copper, gold, platinum and palladium that are good in conductivity and good in corrosion-resistance and wettability with a blazing material, it is possible to realize good electrical connection between the first conductor 20, the second conductor 21, the external connection terminal 83 and a motherboard or the like for forming an electronic circuit as a main part of electronic apparatus.

Next, FIGS. 20 to 23 are sectional views respectively showing fuel cells that are installed in the electronic apparatus according to still other embodiments of the invention.

In these views, reference numerals 91, 101, 111, 121 denote a fuel cell, reference numerals 92, 102, 112, 122 denote a fuel cell casing, reference numeral 13 denotes a membrane electrode assembly, reference numeral 14 denotes a first electrode, reference numeral 15 denotes a second electrode, reference numerals 16 denotes a base body, reference numerals 17 denotes a lid body, reference numeral 18 denotes a first fluid channel, reference numeral 19 denotes a second fluid channel, reference numeral 20 denotes a first wiring conductor, reference numeral 21 denotes a second wiring conductor, reference numeral 83 denotes an external connection terminal, reference numeral 93 denotes a third wiring conductor, reference numeral 103 denotes a fourth wiring conductor, reference numeral 104 denotes a fifth wiring conductor, reference numeral 113 denotes a sixth wiring conductor, reference numeral 123 denotes a seventh wiring conductor, reference numeral 124 denotes an eighth wiring conductor.

In FIGS. 2 to 5, the reference numerals 13 to 21 and 83 denote the same components as in FIG. 19.

The third wiring conductor 93 of FIG. 20, one end of which is disposed to a region facing the first electrode 14 of the membrane electrode assembly 13 on the bottom surface of one of the plural concavities of the base body 16 and the other end of which is disposed to a region facing the first electrode 14 of another membrane electrode assembly 13 on the bottom surface of another one of the concavities, is formed in one body with the base body 16. Moreover, it is desirable to form the third wiring conductor 93 to be 10 μm or more higher than the bottom surface of the concavity of the base body 16 so that both the ends thereof can be easily made in contact with the first electrode 14. The desired height of the third wiring conductor 93 can be achieved by adjusting the printing condition such that the conductor paste is print-coated in a larger thickness during the print-coating process as described above. Further, the first wiring conductor 10 should preferably be arranged in plural face to face with the first electrode 14. This helps reduce electric loss in the third wiring conductor 93. That part of the third wiring conductor 93 which penetrates through the base body 16 should preferably be Φ50 μm or above in diameter.

Of the fourth wiring conductor 103 of FIG. 21 and, one end is disposed to a region facing the first electrode 14 of the membrane electrode assembly 13 on the bottom surface of one of the plural concavities of the base body 16, and the other end is led out to a region where the lid body 17 is mounted of the upper surface of the base body 16. Moreover, the fifth wiring conductor 104 is formed in a manner that one end is disposed to a region facing the second electrode 15 of the membrane electrode assembly 13 of another one of the concavities on the lower surface of the lid body 17, and the other end is led out to a region mounted to the base body 16 of the lower surface of the lid body 17 so as to face the other end of the fourth wiring conductor 103.

It is preferable that, like the third wiring conductor 93, the fourth wiring conductor 103 is formed integrally with the base body 16 and is made 10 μm or above higher than the concavity bottom surface of the base body 16. This allows one end thereof to make contact with the first electrode 14 with ease. The desired height of the fourth wiring conductor 103 can be achieved by adjusting the printing condition such that the conductor paste is print-coated in a larger thickness during the print-coating process as described above. Further, the fourth wiring conductor 103 should preferably be arranged in plural face to face with the first electrode 14. This helps reduce electric loss in the fourth wiring conductor 103. That part of the fourth wiring conductor 103 which penetrates through the base body 16 should preferably be Φ50 μm or above in diameter.

Further, it is preferable that, like the second wiring conductor 21, the fifth wiring conductor 104 is formed integrally with the lid body 7 and is made 10 μm or above higher than the lower surface of the lid body 17. This allows one end thereof to make contact with the second electrode 15 with ease. The desired height of the fifth wiring conductor 104 can be achieved by adjusting the printing condition such that the conductor paste is print-coated in a larger thickness during the print-coating process as described above. Further, the fifth wiring conductor 104 should preferably be arranged in plural face to face with the second electrode 15. This helps reduce electric loss in the fifth wiring conductor 104. That part of the fifth wiring conductor 104 which penetrates through the lid body 17 should preferably be Φ50 μm or above in diameter.

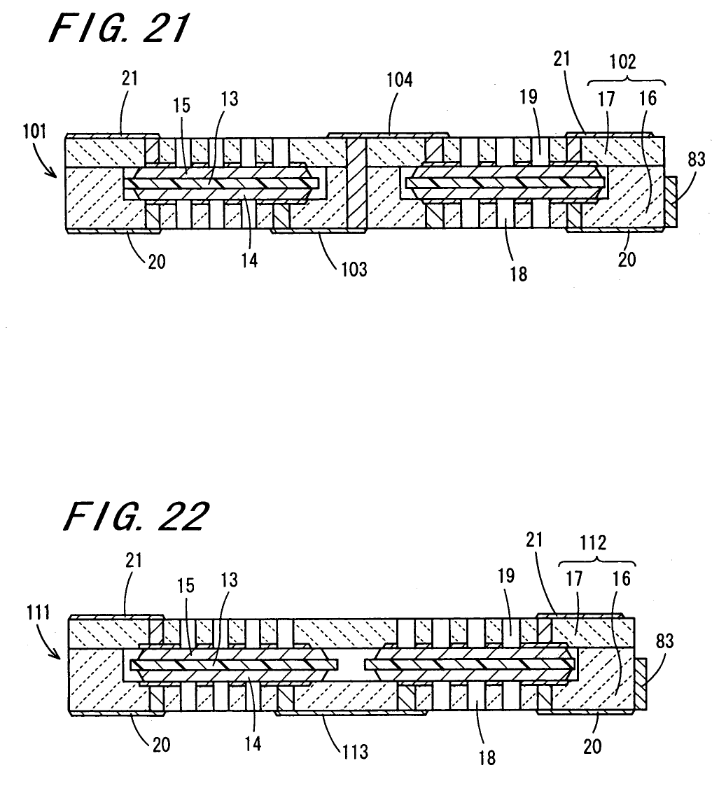

The sixth wiring conductor 113 of FIG. 22, one end which is disposed to a region facing the first electrode 14 of one of the membrane electrode assemblys 13 on the bottom surface of the concavity of the base body 16 and the other end which is disposed to a region facing the first electrode 14 of another one of the membrane electrode assemblys 13 on the bottom surface of the same concavity, is formed in one body with the base body 16.

It is desirable to form the sixth wiring conductor 113 to be 10 μm or more higher than the bottom surface of the concavity of the base body 16 so that both the ends thereof are easily made in contact with the first electrode 14. The desired height of sixth wiring conductor 113 can be achieved by adjusting the printing condition such that the conductor paste is print-coated in a larger thickness during the print-coating process as described above. Further, the third wiring conductor 93 should preferably be arranged in plural face to face with the first electrode 14. This helps reduce electric loss in the sixth wiring conductor 113. That part of the sixth wiring conductor 113 which penetrates through the base body 16 should preferably be Φ50 μm or above in diameter.

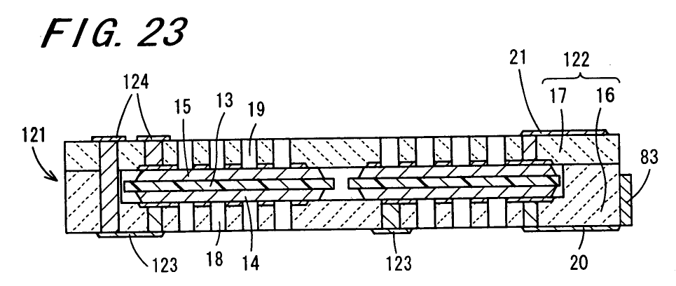

Of the seventh wiring conductor 123 of FIG. 23, one end is disposed to a region facing the first electrode 14 of one of the plural membrane electrode assemblys 13 on the bottom surface of the first concavity or the concavity of the base body 16, and the other end is led out to a region where the lid body 17 is mounted of the upper surface of the base body 16. Moreover, the eighth wiring conductor 124 is formed in a manner that one end is disposed to a region facing the second electrode 15 of another one of the plural membrane electrode assemblys 13 of the lower surface of the lid body 17 and the other end is led out to a region mounted to the upper surface of the base body 16 of the lower surface of the lid body 17 so as to face the other end of the seventh wiring conductor 123.

This seventh wiring conductor 123 is formed in one body with the base body 16 in the same manner as the third wiring conductor 93, and it is desirable to form to be 10 μm or more higher than the bottom surface of the concavity of the base body 16 so that one end thereof is easily made in contact with the first electrode 14. The desired height of the seventh wiring conductor 123 can be achieved by adjusting the printing condition such that the conductor paste is print-coated in a larger thickness during the print-coating process as described above. Further, the seventh wiring conductor 123 should preferably be arranged in plural face to face with the first electrode 14. This helps reduce electric loss in the seventh wiring conductor 123. That part of the seventh wiring conductor 123 which penetrates through the base body 16 should preferably be Φ50 μm or above in diameter.

Further, the eighth wiring conductor 124 is formed in one body with the lid body 17 in the same manner as the second wiring conductor 21, and it is desirable to form to be 10 μm or more higher than the lower surface of the lid body 17 so that one end thereof is easily made in contact with the second electrode 15. The desired height of eighth wiring conductor 124 can be achieved by adjusting the printing condition such that the conductor paste is print-coated in a larger thickness during the print-coating process as described above. Further, eighth wiring conductor 124 should preferably be arranged in plural face to face with the second electrode 15. This helps reduce electric loss in the eighth wiring conductor 124. That part of eighth wiring conductor 124 which penetrates through the lid body 17 should preferably be Φ50 μm or above in diameter.

As shown in FIG. 20 and FIG. 21, according to the fuel cell casings 92, 102 installed in the electronic apparatus and the fuel cells 91, 101, by storing the membrane electrode assembly 13 in each concavity of the base body 16 that has a plurality of concavities, disposing the third wiring conductors 93, or the fourth wiring conductors 103 and the fifth wiring conductors 104 between the end portions of the adjacent concavities, electrically connecting the first electrodes 14 of the plural membrane electrode assemblys 13, or the first electrode 14 and the second electrode 15, and electrically connecting the first wiring conductors 20 and the second wiring conductors 21 so as to take out the whole output to the membrane electrode assemblys 13 placed in positions to become both ends, three-dimensional free wiring is allowed by the first to third wiring conductors 20, 21, 93 or by the first, second, fourth and fifth wiring conductors 20, 21, 103, 104, so that it is possible to arbitrarily connect the plural membrane electrode assemblys 13 in series or in parallel. As a result, since it becomes possible to efficiently regulate the entire output voltage and output current, a fuel cell that is capable of taking out electricity electrochemically generated in the plural membrane electrode assemblys 13 to the outside in a good manner is realized.

As shown in FIG. 22 and FIG. 23, according to the fuel cell casings 112, 122 installed in the electronic apparatus of the invention and the fuel cells 111, 121, by containing the plural membrane electrode assemblys 13 in the concavity of the base body 16, disposing the sixth wiring conductors 113, or the seventh wiring conductors 123 and the eighth wiring conductors 124, electrically connecting the first electrodes 14 of the plural membrane electrode assemblys 13, or the first electrode 14 and the second electrode 15, and electrically connecting the first wiring conductors 20 and the second wiring conductors 21 so as to take out the whole output to the membrane electrode assemblys 13 placed in positions to become both ends, three-dimensional free wiring is allowed by the first, second and sixth wiring conductors 20, 21, 113 or by the first, second, seventh and eighth wiring conductors 20, 21, 123, 124, so that it is possible to arbitrarily connect the plural membrane electrode assemblys 13 in series or in parallel. As a result, since it becomes possible to efficiently regulate the entire output voltage and output current, a fuel cell that is capable of taking out electricity electrochemically generated in the plural membrane electrode assemblys 13 to the outside in a good manner is realized.

In the scope of the invention, various changes may be done. For example, in order to low-profile the whole fuel cell, inlets from the side face of the base body or the lid body may be disposed to the first fluid channels or the second fluid channels. This is effective for miniaturization at the time of using for mobile electronic apparatus in specific. Besides, regarding the first and second wiring conductors, the other ends led out to the outer surfaces of the base body and the lid body may be disposed so as to be led out to the side faces on the same side, respectively, to gather the external connection terminals 83. This makes it possible to gather wiring, ducts and the like on one side of the fuel cell, miniaturization and protection of joints to the outside are facilitated, highly reliable designing is enabled, and a fuel cell that is capable of stably operating for a long term is realized.

Next, electronic apparatus that has the above fuel cell as a power source will be described. Since the electronic apparatus of the invention has the fuel cell as mentioned above as a power source, it has various effects as described below and is small, short in height, capable of stable operation over the long run, and excellent in safety and convenience.

In the case of providing the fuel cell 81 installed as a power source with external connection terminals (a positive terminal and a negative terminal) on at least either the base body 16 or the lid body 17, the electronic apparatus of the invention can be electrically connected to a circuit board of the electronic apparatus with ease, and can be freely attached and detached. Therefore, without using a facility or the like that is provided with a special safety facility, it is possible to easily replace the fuel cell with a new one, and it is possible to make the electronic apparatus highly convenient.

Furthermore, since, in a case where the base body 16 of the fuel cell casing 82 is made of multilayer ceramics, it is possible to form metal layers by a metallization method or the like on the surface of a ceramic layer locating inside in various shapes and electrical characteristics, it is possible to form an electronic circuit device that functions as a resistor, a capacitance, an inductance or the like. Therefore, for example, by forming a large-capacity capacitor in parallel with the fuel cell, in a case where an electric current outputted from the fuel cell 81 is lacking, a shortfall of the electric current is compensated and supply of an electric current in accordance with a target output electric current can be secured. Moreover, since a boosting circuit can be formed, it is possible to maintain a voltage necessary for the electronic apparatus.

In the case of forming a resistor, a capacitance or an inductance inside the base body 16, it is preferable that the base body 16 is made of sintered glass ceramics.

For example, sintered glass ceramics is made of a glass component and filler. These components are the same as the aforementioned embodiment, and it will be omitted to describe in details.

Further, it is preferable that the mixture ratio of the glass and the filler is 40:60 to 99:1 in mass ratio.

As an organic binder blended in a glass ceramic green sheet, one that has been used in a ceramic green sheet so far can be used, and it is, for example, a homopolymer or a copolymer of acrylic-base (a homopolymer or a copolymer of acrylic acid, methacrylic acid or ester thereof, concretely, an acrylic acid ester copolymer, a methacrylic acid ester copolymer, acrylic acid ester—methacrylic acid ester copolymer or the like), polyvinyl butyral-base, polyvinyl alcohol-base, acrylic-styrene-base, polypropylene carbonate-base, cellulose-base or the like.

A glass ceramic green sheet is obtained by adding a specified amount of plasticizer, a solvent (an organic solvent, water or the like) into the glass powder, the filler powder and the organic binder as necessary to obtain slurry, and molding this by doctor blade, rolling, calendar rolling, die pressing or the like to thickness of approximately 50 to 500 μm.

A conductor pattern is formed on the surface of a glass ceramic green sheet, for example, by printing paste of conductor material powder by a screen printing method, a gravure printing method or the like, or by transferring metal foil of a specified pattern shape. A conductor material is of, for example, one kind or two or more kinds selected from Cu, Au, Ag, Pd, Pt or the like, and in the case of containing two or more kinds, it may be any shape of mixture, alloy, coating or the like.

Further, in a case where a large-capacity capacitance is formed, for example, a layer made of inorganic substance powder that has high dielectric constant such as barium titanate (referred to as a barium titanate layer hereafter) is formed inside a base body 16 made of glass ceramics. In this case, it is manufactured by firstly forming slurry that contains ceramic powder and glass powder to obtain a plurality of green sheets, subsequently printing metal paste to become a lower electrode layer on the green sheet, subsequently printing dielectric paste made of barium titanate or the like on the lower electrode layer by screen printing to form a dielectric layer, further printing metal pate on the dielectric layer to form an upper electrode layer, stacking these green sheets, and firing this stacked body.

Further, in a case where a resistor is formed inside the base body 16, it can be formed by print-applying resistor paste whose principal ingredients are RuO₂, IrO₂, RhO₂, SnO₂, LaB₆ and the like to the green sheet in a specified pattern by a method such as screen printing, gravure printing or the like by the same method as the first wiring conductor 20 and the second wiring conductor 21.

Further, it is good that an internal circuit is formed in the base body 16 of the fuel cell 81. Consequently, it is possible to mount an electronic part electrically connected to the internal circuit on the surface of the base body 16. Therefore, it is possible to increase functionality of electronic apparatus by the electronic part mounted on the surface of the base body 16.

Further, it is good that an electronic part electrically connected to the internal circuit is disposed to the surface of the base body 16 of the fuel cell 81. Consequently, by using a sensor, a control IC or the like as the electronic part and detecting the density of fuel inside the fluid channels 18, 19 by a density sensor, optimum circulation, fuel dilution, and suppress of decrease of fuel use efficiency are enabled. In addition, by using electronic parts, a boosting circuit can be formed, it becomes possible to control a voltage necessary for electronic apparatus. Further, by using a temperature sensor or the like, it becomes possible to manage and control the temperature of the membrane electrode assembly.

It is possible to mount an electronic part electrically connected to the internal circuit on the surface of the base body 16 or the lid body 17. Therefore, it is possible to increase functionality of the electronic apparatus by the electronic part mounted on the surface of the base body 16.

Consequently, for example, be using a sensor, a control IC or the like as the electronic part and detecting the density of fuel in the fluid channels by a density sensor, optimum circulation, dilution of fuel, and prevention of decrease of fuel use efficiency are enabled.

Further, it is good that, in the fuel cell 81, piezoelectric pumps, that is, micropumps using a piezoelectric material such as lead zirconate titanate (PZT; composition formula: Pb (Zr, Ti) O₃) are disposed in at least either the first fluid channels 18 or the second fluid channels 19. Consequently, the small piezoelectric pumps prevent backflow of fuel, with the result that it is possible to prevent unused fuel from being polluted by a reactant or the like, and it is possible to avoid that residual air affects an operation of electronic apparatus because the residual air is discharged. Besides, fuel is constantly supplied, with the result that electric power is stably generated, and actuation time is shortened because fuel is smoothly supplied.

The piezoelectric pump is constituted by an influx portion, a variable volume portion, and an efflux portion. Then, the variable volume portion can be manufactured by, for example, disposing a piezoelectric material outside the first and second fluid channels 18, 19, and by the use of expansion and contraction of the piezoelectric material responsive to an applied voltage, it is possible to vibrate upper regions of the first and second fluid channels 18, 19. Consequently, it can vary the volumes of the first and second fluid channels 18, 19, and can function as a pump.

Further, the influx portion and the efflux portion are formed by the first and second fluid channels 18, 19 connected to the variable volume portion, and they are for letting fuel flow into and out of the variable volume portion. It is preferable that the sectional area of the efflux portion is larger than the sectional area of the influx portion. Consequently, pressure of fuel of the efflux portion becomes small, and in the case of causing the variable volume portion to function as a pump, fuel flows toward the efflux portion where pressure is small, and it is possible to send fuel in a specific direction in a good manner. Backflow prevention valves that prevent backflow of fuel may be disposed to the influx portion and the efflux portion.

Such a piezoelectric pump is made of an organic or inorganic piezoelectric material, and can be manufactured by bonding this piezoelectric material after firing a ceramic green sheet to become the base body 16 or the lid body 17 or, in the case of using a ceramic piezoelectric material such as PZT, mounting the ceramic piezoelectric material in a specified position of a ceramic green sheet and thereafter firing at the same time.

Further, the fuel cell 81 is excellent in reliability and safety because, other than the first and second wiring conductors 20, 21 whose one ends are disposed inside the housing, nothing comes in electric contact with the membrane electrode assembly 13 itself uselessly.

On the basis of the above, according to the electronic apparatus of the invention, it is possible to provide electronic apparatus that is excellent in compactness, convenience and safety and capable of stable operation over the long run by equal supply of fluids and highly efficient electrical connection.

Then, in concrete, the electronic apparatus of the invention is mobile electronic apparatus such as a mobile phone, a PDA (personal digital assistant), a digital camera or video camera or a toy such as a game machine, and electronic apparatus that includes a laptop PC (personal computer) such as a printer, a facsimile, a television, a communication apparatus, an audio video apparatus, various kinds of household electric appliances such as an electric fan, or a machine tool of portable type.

In recent years, electronic apparatus that additionally has a function of displaying a moving image has been used. Since such moving image display requires considerably large power consumption, electronic apparatus that uses a conventional storage battery becomes incapable of operating in a short time period, whereas the electronic apparatus of the invention is provided with a fuel cell that can supply a power source for a considerably long time period, and therefore, it is capable of operating for a long time period even in the case of displaying a moving image.

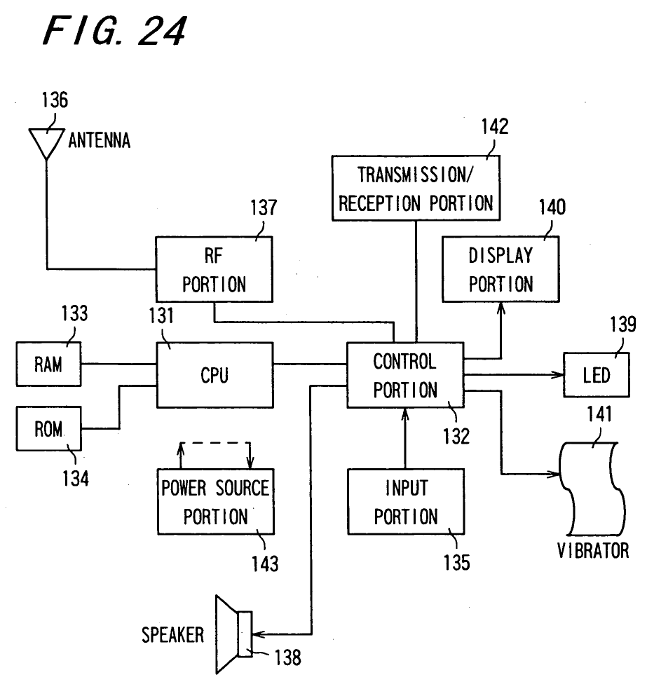

For example, in a case where the electronic apparatus of the invention is a mobile phone, as shown in a block diagram of FIG. 24, it comprises a central processing unit (CPU) 131, a control portion 132, a random access memory (RAM) 133, a read only memory (ROM) 134, an input portion 135 that inputs data operated by the user to the CPU 131, an antenna 136, a radio portion 137 (RF portion) that demodulates a signal received by the antenna 136 and supplies to the control portion 132 as well as modulates a signal supplied from the control portion 132 and transmits from the antenna 136, a speaker 138 that rumbles based on a rumbling signal from the control portion 132, a light emitting diode (LED) 139 that turns on, turns off or flashes by control from the control portion 132, a display portion 140 that displays information by a signal from the control portion 132, a vibrator 141 that vibrates by a driving signal from the control portion 132, a transmission/reception portion 142 that converts a voice of the user to a voice signal and transmits to the control portion 132 as well as converts a voice signal from the control portion 132 to a voice and outputs, and a power source portion 143 that supplies power sources to the respective portions, and the fuel cell and the fuel cell casing of the invention are built in the power source portion 143.

In this case, the fuel cell and the fuel cell casing of the invention are excellent in compactness, convenience and safety, and are capable of equal supply of fuel and power source supply for a long time period by highly efficient electrical connection, whereby miniaturization, low-profiling and weight reduction of a mobile phone are enabled.

Further, considering that a recent mobile phone is miniaturized and low-profiled enough, it is possible to additionally install an electronic part that has a function of a camera, a video or the like other than a function of a telephone into a space made by miniaturizing and low-profiling a fuel cell in the above manner, and it is possible to promote multifunction.

Further, instead of newly installing an electronic part, it is also possible to dispose a shock absorber, a preventive member or the like so as to protect a major electronic circuit. In this case, it is also possible to make a structure that can possibly strengthen than ever shock-resistance when a mobile phone main body is shocked by a fall or the like, a waterproof characteristic at the time of use in the rain or the like.

Further, as a result of miniaturizing an electric circuit portion inside a mobile phone main body, restrictions on the outer shape of a mobile phone main body decrease, and it becomes possible to form a mobile phone in an outer shape that is excellent in design, for example, a shape that enables elderly people and children to hold with ease.

Further, in a case where the structure of the power source portion 143 is a structure that the fuel cell and the fuel cell casing can be freely attached and detached as described above, it is possible, by preparing a spare fuel cell and fuel cell casing, to easily replace to a spare fuel cell and fuel cell casing or take out a fuel cell to replenish and replace fuel in case of battery shutoff or the like, so that it is possible to continuously speak on the phone, and the phone becomes more excellent in convenience than conventional one that uses a storage battery as a power source.

Further, since a replaced (used) fuel cell can be instantly reused after replenished with fuel, it is easier to use than a charging type, and it is possible to effectively use resources. Moreover, there is a merit that it is possible to use even in case of emergency such as blackout for a long time period due to natural disasters and even outdoors.

Further, a laptop PC (personal computer) is made by a basic constitution of comprising a personal computer main body, a first box that contains a keyboard for inputting specified data to the personal computer main body, and a second box that contains a display for displaying data inputted by the keyboard or data processed by the personal computer main body, attaching the second box to the first box so as to be openable and closable, and forming a power source portion that supplies power sources to the respective portions in the first box, and the fuel cell and the fuel cell casing of the invention are installed in the power source portion. In this case, as in the aforementioned mobile phone, the fuel cell and the fuel cell casing installed in the electronic apparatus of the invention are excellent in compactness, convenience and safety and are capable of equal supply of fuel and power source supply for a long time period by highly efficient electrical connection, so that miniaturization, low-profiling and weight reduction of a laptop PC (personal computer) main body and making it multifunction are enabled, and it is possible to realize a highly convenient laptop PC (personal computer) that is capable of stable supply of a large electric current for a long time period and that has a display easy to look and reduces burdens of weight and volume at the time of carrying, in response to a large and high-resolution display.

Further, in a case where the structure of the power portion is a structure that the fuel cell and the fuel cell casing of the invention are freely attached and detached, by preparing a spare fuel cell and fuel cell casing of the invention, there is a merit that under the condition of using with only a secondary battery outdoors or in a mobile unit such as an airplane, it becomes possible to supply electric power for a longer time period than ever dramatically. Moreover, in the case of using in a public space, it is outstandingly excellent in convenience and can be used without restrictions because it is excellent in safety.

The invention is not limited to the above embodiments and can be changed in various manners in the scope of the invention. For example, a DMFC that uses methanol as fuel is used as a fuel cell in the above embodiments. However, a fuel cell that uses various kinds of liquids including dimethyl ether as fuel can be also used. In the PEFC, a fuel cell that uses reformed hydrogen obtained from methanol by using a compact reforming device as fuel can be also used.

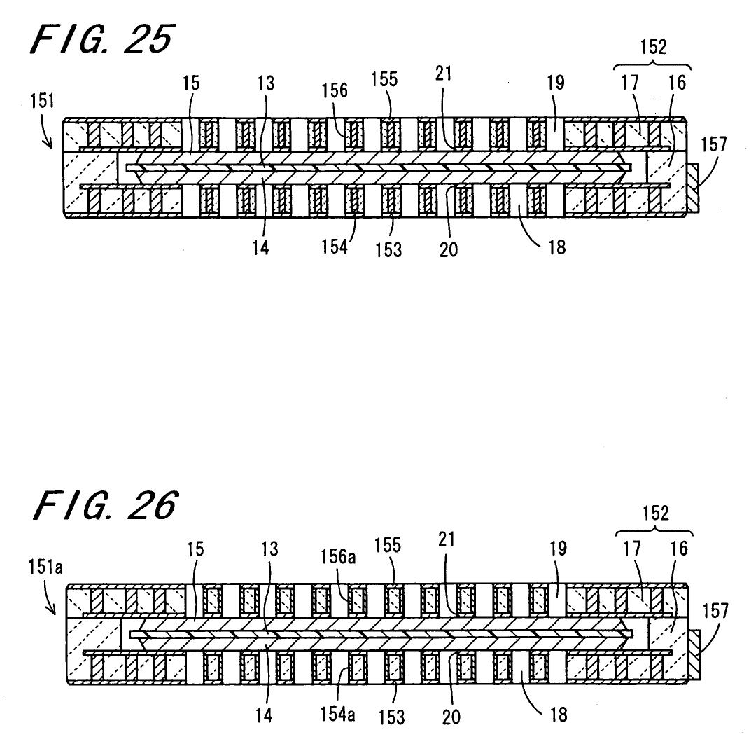

FIG. 25 is a sectional view showing a fuel cell according to still another embodiment of the invention. In this embodiment, the same components as those of the aforementioned embodiment will be denoted by the same reference numerals, and it will be omitted to describe in detail. In FIG. 25, reference numeral 151 denotes a fuel cell, reference numeral 152 denotes a fuel cell casing, reference numeral 13 denotes a membrane electrode assembly, reference numeral 14 denotes a first electrode, reference numeral 15 denotes a second electrode, reference numeral 16 denotes a base body, reference numeral 17 denotes a lid body, reference numeral 18 denotes a first fluid channel, reference numeral 19 denotes a second fluid channel, reference numeral 20 denotes a first wiring conductor, reference numeral 153 denotes a third wiring conductor, reference numeral 154 denotes a first connection conductor, reference numeral 21 denotes a second wiring conductor, reference numeral 155 denotes a fourth wiring conductor, reference numeral 156 denotes a second connection conductor, and reference numeral 157 denotes an external connection terminal.

It is preferable that the base body 16 and the lid body 17 are made of sintered aluminum oxide of a close-packed substance whose relative density is 95% or more, for example. In this case, for example, in the case of sintered aluminum oxide, firstly, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser or the like, through holes as the first fluid channels 18 and the second fluid channels 19 and through holes for disposing the first connection conductors 154 and the second connection conductors 156 are formed on the green sheet. The first fluid channels 18 and the second fluid channels 19 may by grooves that are formed by punching with a die, press-molding or the like and that locate on a surface layer and in an internal layer.

In the case of using sintered aluminum oxide as a ceramics material, it is preferable that the first wiring conductors 20, the second wiring conductors 21, the third wiring conductors 153, the fourth wiring conductors 155, the first connection conductors 154 and the second connection conductors 156 are made of tungsten and/or molybdenum so as not to be oxidized. In this case, for example, conductor paste made by adding 3 to 20 mass parts of Al₂O₃ and 0.5 to 5 mass parts of Nb₂O₅ to 100 mass parts of tungsten and/or molybdenum powder as an inorganic component is prepared. By print-applying the conductor paste on the surface of the green sheet by a method of screen printing, gravure printing or the like into a predetermined pattern, or filling in the through holes, it is possible to form the first wiring conductors 20, the second wiring conductors 21, the third wiring conductors 153, the fourth wiring conductors 155, the first connection conductors 154 and the second connection conductors 156.

Further, from the viewpoint of efficiently taking out electricity electrochemically generated in the membrane electrode assembly 13 to the outside, it is preferable that the first wiring conductors 20, the second wiring conductors 21, the third wiring conductors 153, the fourth wiring conductors 155, the first connection conductors 154 and the second connection conductors 156 are made so that specific electric resistance is 0.1 mΩcm or less. Such a material is tungsten, tungsten-base metal, silver, silver-base metal, copper, copper-base metal, gold, gold-base metal or the like.

Further, it is good that the volumes of all the conductors including the first wiring conductors 20, the second wiring conductors 21, the third wiring conductors 153, the fourth wiring conductors 155, the first connection conductors 154 and the second connection conductors 156 are 0.5% or more of the volume of the fuel cell casing 152. Consequently, resistances of the conductors formed in the fuel cell casing 152 become small, and it is possible to efficiently take out electricity electrochemically generated in the membrane electrode assembly 13 to the outside.

Into the conductor paste, for the purpose of increasing close adhesion of the base body 16 and the lid body 17 to ceramics, aluminum oxide powder or powder of the same composite with a ceramics component forming the base body 16 and the lid body 17 can be added, for example, in the ratio of 0.05 to 2 volume %.

Then, by aligning and stack-crimping a specified number of sheet-like forms with the conductor paste printed and filled, and thereafter firing this stacked body, for example, in a nonoxidizing atmosphere, at the maximum firing temperatures of 1200-1500° C., the base body 16 and the lid body 17 of ceramics and the first wiring conductors 20, the second wiring conductors 21, the third wiring conductors 153, the fourth wiring conductors 155, the first connection conductors 154 and the second connection conductors 156 are obtained desirably.

Further, the first wiring conductors 20 are connected to the third wiring conductors 153 formed in parallel with the first wiring conductors 20 at regions of the base body 16 locating on the lower side as the other surface side from the first wiring conductors 20, via the first connection conductors 154 formed between the first fluid channels 18 of the base body 16, and consequently, it is possible to make the resistance of the wiring conductors connected to the first electrode 14 considerably low, and it is possible to make electrical loss extremely small. Desirably, it is preferable that the first connection conductor 154 has a diameter of Φ50 μm or more.

Further, the second wiring conductors 21 are connected to the fourth wiring conductors 155 formed in parallel with the second wiring conductors 21 at regions of the lid body 17 locating on the upper side as the other surface side from the second wiring conductors 21, via the second connection conductors 156 formed between the second fluid channels 19 of the lid body 17, and consequently, it is possible to make the resistance of the wiring conductors connected to the second electrode 15 considerably low, and it is possible to make electrical loss extremely small. Desirably, it is preferable that the second connection conductor 156 has a diameter of Φ50 μm or more.

By coating the exposed surfaces of the first wiring conductors 20, the second wiring conductors 21, the third wiring conductors 153, the fourth wiring conductors 155 and the external connection terminal 157 with metal such as nickel, copper, gold, platinum and palladium that are good in conductivity and good in corrosion-resistance and wettability with a blazing material, it is possible to realize good electrical connection between the conductors and a motherboard or the like for forming an electronic circuit as a main part of electronic apparatus.

Next, a fuel cell according to still another embodiment of the invention will be described based on FIG. 26. Since the constitution of the fuel cell 151a is the same as that of the fuel cell except the first connection conductors 154a and the second connection conductors 156a, a detailed description thereof will be omitted.

The first wiring conductors 20 are connected to the third wiring conductors 153 formed in parallel with the first wiring conductors 20 at regions of the base body 16 locating on the lower side than the first wiring conductors 20, via the first connection conductors 154a formed on the inner peripheral surfaces of the first fluid channels 18 of the base body 16, whereby it is possible to make the resistance of the wiring conductors connected to the first electrode 14 considerably low, and it is possible to make electrical loss extremely small. Desirably, it is preferable that the diameters of the first connection conductors 154a are Φ50 μm or more.

Further, the second wiring conductors 21 are connected to the fourth wiring conductors 155 formed in parallel with the second wiring conductors 21 at regions of the lid body 17 locating on the upper side than the second wiring conductors 21, via the second connection conductors 156a formed on the inner peripheral surfaces of the second fluid channels 19 of the lid body 17, whereby it is possible to make the resistance of the wiring conductors connected to the second electrode 15 considerably low, and it is possible to make electrical loss extremely small. Desirably, it is preferable that the diameters of the second connection conductors 156a are Φ50 μm or more.

For the purpose of effectively preventing corrosion due to fuel that flows in the first and second fluid channels 18, 19, it is good to coat the surfaces of the first and second connection conductors 154a, 156a with metal that has excellent corrosion-resistance and high electrical conductivity such as gold or platinum by plating, vapor-deposition or the like.

electronic apparatus that has the above fuel cell as a power source is the same constitution as described above, and it will be omitted to describe in details.

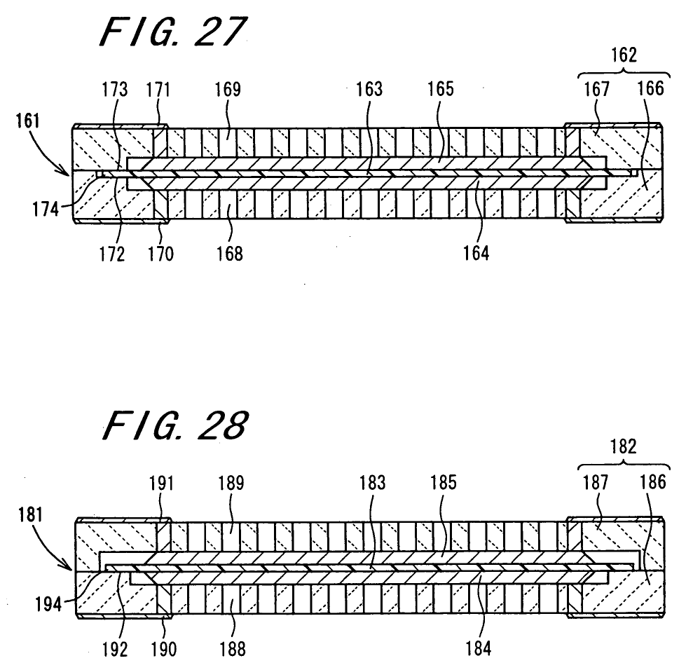

FIGS. 27 and 28 are sectional views each showing a fuel cell casing and a fuel cell employing the same according to still another embodiment of the invention. In these figures, reference numerals 161 and 181 denote a fuel cell; 162 and 182 denote a fuel cell casing; 163 and 183 denote a membrane electrode assembly; 164 and 184 denote a first electrode; 165 and 185 denote a second electrode; 166 and 186 denote a base body; 167 and 187 denote a lid body; 168 and 188 denote a first fluid channel; 169 and 189 denote a second fluid channel; 170 and 190 denote a first wiring conductor; 171 and 191 denote a second wiring conductor; 172 and 192 denote a placement portion; 173 denotes an abutment portion; and 174 and 194 denote an overhanging portion.

On the membrane electrode assembly 163, 183, for example, on both the principal surfaces of an ion conduction membrane (exchange membrane) as a platy solid electrolyte, a fuel electrode (not shown in the drawing) to become an anode electrode and an air electrode (not shown in the drawing) to become a cathode electrode are formed into one body so as to face the first electrode 164, 184 formed on the lower principal surface and the second electrode 165, 185 formed on the upper principal surface, respectively. Then, it is possible to flow an electric current generated in the membrane electrode assembly 163, 183 to the first electrode 164, 184 and the second electrode 165, 185 and take it to the outside.

Such an ion conduction membrane (exchange membrane) of the membrane electrode assembly 163, 183 is constituted by a proton conductive ion exchange membrane such as a perfluorocarbon sulfonic acid resin, for example, Nafion (a product name, produced by DuPont). Moreover, the fuel electrode and the air electrode are porous-state gas diffusing electrodes, and have both functions of a porous catalyst layer and a gas diffusing layer. The fuel electrode and the air electrode are constituted by a porous material that holds conductive fine particles carrying a catalyst such as platinum, palladium or alloy thereof, for example, carbon fine particles by a hydrophobic resin binder such as polytetrafluoroethylene.

The first electrode 164, 184 and the second electrode 165, 185 on the lower principal surface and the upper principal surface of the membrane electrode assembly 163, 183 are formed by a method of hot pressing a carbon electrode on which fine particles of a catalyst such as platinum or platinum-ruthenium are attached on the membrane electrode assembly 163, 183, a method of applying or transferring a mixture of a carbon electrode material on which fine particles of a catalyst such as platinum or platinum-ruthenium are attached and a solution in which an electrolyte material is dispersed onto an electrolyte, or the like.

At this time, formed at the outer edge of the electrolyte are not the first and second electrodes 164, 184 and 165, 185 but the overhanging portion 174, 194.

The fuel cell casing 162 of the invention shown in FIG. 27 comprises the base body 166 that has a first concavity and the lid body 167 having a second concavity, and has a function of storing the membrane electrode assembly 163 inside the first and second concavities and hermetically sealing. The fuel cell casing 182 of the invention shown in FIG. 28 comprises the base body 186 that has a concavity and the lid body 187, and has a function of storing the membrane electrode assembly 183 inside the concavity and hermetically sealing. The fuel cell casing 162, 182 is made of a ceramics material such as sintered aluminum oxide (Al₂O₃), sintered mullite (3Al₂O₃.2SiO₂), sintered silicon carbide (SiC), sintered aluminum nitride (AlN), sintered silicon nitride (Si₃N₄) or sintered glass ceramics.

For example, sintered glass ceramics is made of a glass component and filler. These components are the same as the aforementioned embodiment, and it will be omitted to describe in details.

Since the fuel cell casing 162, 182 comprises the base body 166 having the first concavity or the base body 186 having the concavity, and the lid body 167 having the second concavity or the lid body 187, and the concavity is hermetically sealed by mounting the lid body 167, 187 around the first concavity or the concavity of the base body 166, 186 so as to cover the first concavity or the concavity, the lid body 167, 187 is mounted to the base body 166, 186 by bonding with a metal bonding material such as solder or silver brazing filler, by bonding with a resin material such as epoxy, or by a method of bonding a sealant or the like made of ferroalloy or the like on the upper surface around the first concavity or the concavity and welding by seam weld, electron beam, laser or the like.

The base body 166, 186 and the lid body 167, 187 are made to be thin, respectively, and in order to enable low-profiling of the fuel cell 161, 181 of the invention, it is preferable that flexural strength as mechanical strength is 200 MPa or more.

It is preferable that the base body 166, 186 and the lid body 167, 187 are made of sintered aluminum oxide of a close-packed substance whose relative density is 95% or more, for example. In this case, for example, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser or the like, through holes as the first fluid channels 168, 188 and the second fluid channels 169, 189 and through holes for disposing the first wiring conductors 170, 190 and the second wiring conductors 171, 191 are formed on the green sheet.

The first and second wiring conductors 170, 190 and 171, 191 should preferably be composed of tungsten, molybdenum or alloy thereof to prevent oxidation. In this case, for example, conductor paste made by adding 3 to 20 mass parts of Al₂O₃ and 0.5 to 5 mass parts of Nb₂O₅ to 100 mass parts of tungsten or molybdenum powder as an inorganic component is prepared. The conductor paste is filled in the through hole pierced in the green sheet to form a via hole acting as a through conductor.

Into the conductor paste, for the purpose of increasing close adhesion of the base body 166, 186 and the lid body 167, 187 to ceramics, aluminum oxide powder or powder of the same composite with a ceramics component forming the base body 166, 186 and the lid body 167, 187 can be added, for example, in the ratio of 0.05 to 2 volume %.

The first and second wiring conductors 170, 190 and 171, 191 are formed in the outer and inner layers of the base body 166, 186 and the lid body 167, 187 before, after, or concurrently with the formation of the via conductor achieved by filling the conductor paste into the through hole. The formation of the wiring conductors is achieved by print-coating a similar conductor paste in a predetermined pattern on the green sheet in accordance with the screen printing method, gravure printing method, or the like method.

Thereafter, a predetermined number of sheet-like molded bodies carrying the printed, filled conductor paste are subjected to positional alignment, and are then stacked on top of each other under pressure. The stacked body is then fired, in a non-oxidative atmosphere, at a high temperature of approximately 1200 to 1500° C. Thereby, the desired ceramic base body 166, 186, the lid body 167, 187, and the first and second wiring conductors 170, 190 and 171, 191 are obtained.

Further, it is preferable that the base body 166, 186 and the lid body 167, 187 made of ceramics have thickness of 0.2 mm or more. In a case where the thickness is less than 0.2 mm, because the strengths are apt to come short, the base body 166, 186 and the lid body 167, 187 tend to be easily cracked by stress caused when the base body 166, 186 and the lid body 167, 187 are mounted. On the other hand, in a case where the thickness is more than 5 mm, because slenderizing and low-profiling are difficult, it is inappropriate to use as a fuel cell installed in small mobile equipment, and because a thermal capacity is large, it is likely to become hard to instantly set to appropriate temperature corresponding to an electrochemical reaction condition of the membrane electrode assembly 163, 183.

In the fuel cell casing 162 of the invention shown in FIG. 27, the first concavity of the base body 166 takes on a double structure, whereas the second concavity of the lid body 167 takes on a single structure. In the alternative, the first concavity of the base body 166 may take on a single structure and the second concavity of the lid body 167 may take on a double structure.

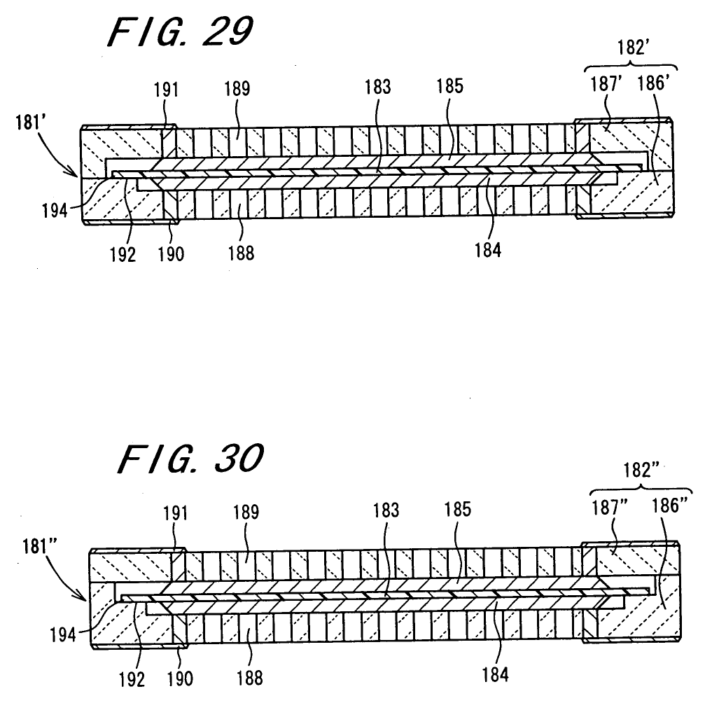

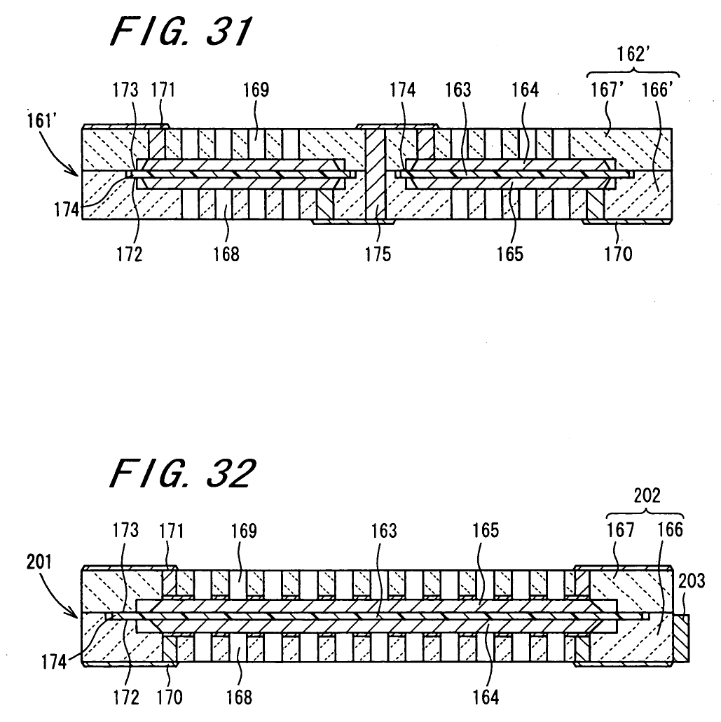

In the fuel cell casing 182 of the invention shown in FIG. 28, the concavity of the base body 186 takes on a so-called double structure, whereas the concavity of the lid body 187 takes on a single structure. However, the configurations maybe altered as follows to facilitate the production of the base and lid bodies 186′, 186″ and 187′, 187″. For example, in another embodiment of the invention sectionally shown in FIG. 29 analogous to FIG. 28, both the concavity of the base body 186′ and the concavity of the lid body 187′ take on a single structure. Moreover, in still another embodiment of the invention sectionally shown in FIG. 30 analogous to FIG. 28, the concavity of the base body 186″ takes on a single structure, and meanwhile the lid body 187″ is formed in a concavity-absent flat structure. Note that, in FIGS. 29 and 30, the components that play the same or corresponding roles as in FIG. 28 will be identified with the same reference symbols. Specifically, reference numerals 181′ and 181″ denote a fuel cell; 182′ and 182″ denote a fuel cell casing; 183 denotes a membrane electrode assembly; 184 denotes a first electrode; 185 denotes a second electrode; 186′ and 186″ denote a base body; 187′ and 187″ denote a lid body; 188 denotes a first fluid channel; 189 denotes a second fluid channel; 190 denotes a first wiring conductor; 191 denotes a second wiring conductor; 192 denotes a placement portion; and 194 denotes an overhanging portion.

The first wiring conductor 170, 190 and the second wiring conductor 171, 191 are each electrically connected to the first electrode 164, 184 and the second electrode 165, 185, respectively, of the membrane electrode assembly 163, 183 so as to function as current-carrying paths for extracting currents generated in the membrane electrode assembly 163, 183 out of the fuel cell casing 162, 182. Note that, although the subsequent explanation holds true for another example of the fuel cell casing and the fuel cell employing the same of the invention shown in FIGS. 29 and 30, quotation of the reference symbols is omitted.

The first wiring conductor 170, 190 has its one end disposed in that part of the bottom surface of the first concavity or the concavity of the base body 166, 186 which faces the first electrode 164, 184 of the membrane electrode assembly 163, 183, and its other end led out toward the outer surface of the base body 166, 186. As described above, it is preferable that the first wiring conductor 170, 190 is formed integrally with the base body 166, 186 and is made 10 μm or above higher than the bottom surface of the first concavity or the concavity of the base body 166, 186. This allows the first wiring conductor 170, 190 to make contact with the first electrode 164, 184 with ease. The desired height of the first wiring conductor 170, 190 can be achieved by adjusting the printing condition such that the conductor paste is print-coated in a larger thickness during the print-coating process as described above. Further, the first wiring conductor 170, 190 should preferably be arranged in plural face to face with the first electrode 164, 184. This helps reduce electric loss in the first wiring conductor 170, 190. That part of the first wiring conductor 170, 190 which penetrates through the base body 166, 186 should preferably be Φ50 μm or above in diameter.

The second wiring conductor 171, 191 has its one end disposed in that part of the lower surface of the lid body 167, 187 which faces the second electrode 165, 185 of the membrane electrode assembly 163, 183, and its other end led out toward the outer surface of the lid body 167, 187. It is preferable that, like the first wiring conductor 170, 190, the second wiring conductor 171, 191 is formed integrally with the lid body 167, 187 and is made 10 μm or above higher than the lower surface of the lid body 167, 187 or the bottom surface of the concavity provided in the lid body 167, 187. This allows the second wiring conductor 171, 191 to make contact with the second electrode 165, 185 with ease. The desired height of the second wiring conductor 171, 191 can be achieved by adjusting the printing condition such that the conductor paste is print-coated in a larger thickness during the print-coating process as described above. Further, the second wiring conductor 171, 191 should preferably be arranged in plural face to face with the second electrode 165, 185. This helps reduce electric loss in the second wiring conductor 171, 191. That part of the second wiring conductor 171, 191 which penetrates through the lid body 167, 187 should preferably be Φ50 μm or above in diameter.

It is preferable that the first and second wiring conductors 170, 190 and 171, 191 each have its exposed surface coated with a highly-conductive metal material such as nickel or gold which is highly corrosion-resistant and exhibits excellent wettability with respect to a brazing filler material, using the plating method. This makes it possible to establish satisfactory electrical connection between the first and second wiring conductors 170, 190 and 171, 191, as well as between the first, second wiring conductor 170, 190; 171, 191 and an external electric circuit.

The first and second wiring conductors 170, 190 and 171, 191 can be electrically connected to the first and second electrodes 164, 184 and 165, 185, respectively, by accommodating so as to grippingly insert the membrane electrode assembly 163, 183 between the base body 166, 186 and the lid body 167, 187. By so doing, the first and second wiring conductors 170, 190 and 171, 191 are brought into pressure-contact with the first and second electrodes 164, 184 and 165, 185, respectively.

Arranged on the bottom surface of the first concavity or the concavity of the base body 166, 186 facing the first electrode 164, 184 and on the lower surface of the lid body 167, 187 facing the second electrode 165, 185 are the first fluid channel 168, 188 and the second fluid channel 169, 189, respectively. The first fluid channel 168, 188 is so formed as to extend toward the outer surface of the base body 166, 186, whereas the second fluid channel 169, 189 is so formed as to extend toward the outer surface of the lid body 167, 187. The first and second fluid channels 168, 188 and 168, 189 are constituted by the through holes pierced in the base body 166, 186 and the lid body 167, 187, or grooves. The first and second fluid channels 168, 188 and 169, 189 each serve as a passage for a fluid to be supplied to the membrane electrode assembly 163, 183, such as fuel gas for example hydrogen-rich reforming gas or oxidant gas for example air, and besides serves as a passage for a fluid to be discharged from the membrane electrode assembly 163, 183 after reactions, such as water produced through reactions.

Regarding a through hole or a groove which is pierced in the base body 166, 186 and the lid body 167, 187 as the first and second fluid channels 168, 188 and 169, 189, the diameter and number of the through hole, or the width, depth, and arrangement of the groove are determined according to the specifications of the fuel cell 161, 181 in such a way that a fluid such as fuel gas or oxidant gas can be evenly supplied to the membrane electrode assembly 163, 183.

In the fuel cell casing 162, 182 and the fuel cell 161, 181 embodying the invention, the first and second fluid channels 168, 188 and 169, 189 should preferably have a hole diameter of Φ0.1 mm or above and be equally spaced. This allows a fluid to flow into the membrane electrode assembly 163, 183 under uniform pressure.

In this way, the first fluid channel 168, 188 is disposed face to face with the lower principal surface of the membrane electrode assembly 163, 183 having the first electrode 164, 184, whereas the second fluid channel 169, 189 is disposed face to face with the upper principal surface of the membrane electrode assembly 163, 183 having the second electrode 165, 185. With this arrangement, a fluid can be exchanged between the lower and upper principal surfaces of the membrane electrode assembly 163, 183 and their corresponding first and second fluid channels 168, 188 and 169, 189, and thus the fluid can be supplied and discharged through the respective fluid path. Moreover, in the case of supplying gas as a fluid, it is possible to prevent a decrease in the partial pressure of the gas supplied to the first and second electrodes 164, 184 and 165, 185 of the membrane electrode assembly 163, 183, and thus obtain a predetermined stable output voltage. Further, since the partial pressure of the supplied gas is stabilized, the inner pressure within the fuel cell 161, 181 is made uniform. As a result, thermal stress occurring in the membrane electrode assembly 163, 183 can be suppressed, leading to enhancement of the reliability of the fuel cell 161, 181.

In the fuel cell casing 162 of the invention shown in FIG. 27, the membrane electrode assembly 163 is housed, with its overhanging portion 174 grippingly interposed between the placement portion 172 formed in the outer periphery of the first concavity of the upper surface of the base body 166 and the abutment portion 173 formed in the outer periphery of the second concavity of the lower surface of the lid body 167. Thus, the first and second fluid channels 168 and 169 are isolated from each other by the membrane electrode assembly 163. This helps prevent mixing of two different fluid materials (for example, oxygen gas and hydrogen gas or methanol), and thus it never occurs that the fuel cell fails to function properly and that flammable fluid materials are ignited and exploded through mixture at a high temperature. As a result, the safety of the fuel cell can be assured. Moreover, since the overhanging portion 174 of the membrane electrode assembly 163 is grippingly interposed between the placement portion 172 of the base body 166 and the abutment portion 173 of the lid body 167, the membrane electrode assembly 163 can be securely housed within the fuel cell casing 162 with ease.

To ensure that the membrane electrode assembly 163 is fixed to the fuel cell casing 162 and that hermeticity is attained between the first fluid channel 168 and the second fluid channel 169, the interval between the placement portion 172 and the abutment portion 173 should preferably be made equal to or smaller than the thickness of the overhanging portion 174 of the membrane electrode assembly 163. Moreover, the opening dimension of the first concavity should preferably be made substantially equal to the outer dimension of the membrane electrode assembly 163. This helps facilitate positional adjustment of the membrane electrode assembly 163 with respect to the base body 166 during assembly. Further, to enhance the hermeticity between the first fluid channel 168 and the second fluid channel 169, a sealing material should preferably be arranged between the overhanging portion 174 and at least one of the placement portion 172 and the abutment portion 173. In this case, an adhesive sealing material is particularly desirable in terms of more reliable securement of the membrane electrode assembly 163.

In the fuel cell casing 182 of the invention shown in FIG. 28, the membrane electrode assembly 183 is placed on the placement portion 192 formed in the outer periphery of the concavity of the upper surface of the base body 186. Thus, the first and second fluid channels 188 and 189 are isolated from each other by the membrane electrode assembly 183. This helps prevent mixing of two different fluid materials (for example, oxygen gas and hydrogen gas or methanol), and thus it never occurs that the fuel cell fails to function properly and that flammable fluid materials are ignited and exploded through mixture at a high temperature. As a result, the safety of the fuel cell can be assured. Moreover, since there is no need to conform the depth of the concavity to the thickness of the thin overhanging portion 194 of the membrane electrode assembly 183, the base body 186 can be produced with ease.

At the time of placing the membrane electrode assembly 163, 183 onto the placement portion 172, 192, it is good to place via an adhesive that has a sealing characteristic between them, because fixture of the membrane electrode assembly 163, 183 and hermeticity between the first fluid channels 168, 188 and the second fluid channels 169, 189 are secured. Such an adhesive is a rubber or resin material of fluororesin-base, silicon-base, ethylene propylene-base, polyurethane-base, polysulfide-base, butyl rubber-base, acrylic-base, epoxy-base or the like.

With the construction thus far described, it is possible to provide the compact, sturdy fuel cell casings 162, 182 capable of housing the membrane electrode assembly 163, 183, and also the fuel cell 161, 181 that allows highly-efficient control according to the invention, as shown in FIGS. 27 and 28.

It should be noted that the invention need not be limited to the above-described embodiments and examples, and therefore various changes and modifications are possible without departing from the spirit or scope of the invention. For example, the first and second fluid channels may alternatively be constructed by forming an inlet on the side surface of the base body or the lid body. In this case, the fuel cell is slenderized as a whole, and the down-sized fuel cell can be effectively adopted in a portable electronic device. Moreover, the other ends of the first and second wiring conductors may be led out toward one common side surfaces of the base body and the lid body, respectively, instead of being led out toward the outer surfaces thereof. In this case, the wiring lines and the ducts can be put together only on one side of the fuel cell. This helps facilitate miniaturization and protection of the externally-connected portions. Thus, the fuel cell can be designed with high reliability, and operated with stability for a longer period of time.

Further, a plurality of membrane electrode assemblys are housed within the concavity of the base body, and these membrane electrode assemblys may be electrically connected to one another by the first and second wiring conductors. In this case, high-voltage or high-current output can be obtained, taken altogether.

FIG. 31 is a sectional view showing a fuel cell casing and a fuel cell employing the same according to still another embodiment of the invention. As seen from FIG. 31, in this embodiment, the membrane electrode assembly 163 is housed in each first concavity of the base body 166′ having a plurality of first concavities. Moreover, a third wiring conductor 175 is so disposed as to extend across the region between the adjacent first concavities. Thus, in a plurality of membrane electrode assemblys 163, their respective first electrodes 164, as well as their first and second electrodes 164 and 165, are electrically connected with one another. To obtain the overall output through the membrane electrode assemblys 163 located at the opposite ends of the construction, the first and second wiring conductors 170 and 171 are each electrically connected thereto. In this case, since the first to third wiring conductors 170, 171, and 175 allow free three-dimensional wiring, a plurality of membrane electrode assemblys 163 can be arbitrarily connected in series or parallel to one another. This makes it possible to efficiently adjust the entire output voltage and output current. Thus, there is realized the fuel cell 161′ with which electricity electrochemically produced in the membrane electrode assemblys 163 can be externally extracted satisfactorily. The construction shown in FIG. 31 may be applied to the fuel cell casing and the fuel cell employing the same of the invention shown in FIGS. 28, 29, and 30. Note that, in FIG. 31, the components that play the same or corresponding roles as in FIG. 27 will be identified with the same reference symbols. Specifically, reference numeral 161′ denotes a fuel cell; reference numeral 162′ denotes a fuel cell casing; reference numeral 163 denotes a membrane electrode assembly; reference numeral 164 denotes a first electrode; reference numeral 165 denotes a second electrode; reference numeral 166′ denotes a base body; reference numeral 167′ denotes a lid body; reference numeral 168 denotes a first fluid channel; reference numeral 169 denotes a second fluid channel; reference numeral 170 denotes a first wiring conductor; reference numeral 171 denotes a second wiring conductor; reference numeral 172 denotes a placement portion; reference numeral 174 denotes an overhanging portion; and reference numeral 175 denotes a third wiring conductor.

In the embodiment of the invention shown in FIG. 27, like the embodiment of the invention shown in FIG. 6, a heating element for heating the lower or upper principal surface of the membrane electrode assembly 163 may be formed on the periphery of at least one of the opening of the first fluid channel 168 disposed on the bottom surface of the first concavity and the opening of the second fluid channel 169 disposed on the bottom surface of the second concavity. In addition, like the embodiment of the invention shown in FIG. 11, a hygroscopic member may be coated on at least one of the inner surface of the first fluid channel 168 and the inner surface of the second fluid channel 169. Further, a heat-insulating layer may be formed in at least one of the part located on the lower side of the first concavity in the base body 166 and the part located on the upper side of the second concavity in the lid body 167. That is, a heat-insulating layer may be formed in at least one of the part of the base body 166 which part is in the vicinity of the first concavity and the part of the lid body 167 which part is in the vicinity of the second concavity. In other words, a heat-insulating layer may be formed in at least one of the part located between the bottom surface of the first concavity in the base body 166 and the outer surface of the base body 166, and the part located between the bottom surface of the second concavity in the lid body 167 and the outer surface of the lid body 167.

In the embodiment of the invention shown in FIG. 28, like the embodiment of the invention shown in FIG. 6, a heating element for heating the lower or upper principal surface of the membrane electrode assembly may be formed on the periphery of at least one of the opening of the first fluid channel 188 disposed on the bottom surface of the concavity and the opening of the second fluid channel 1898 disposed on the lower surface of the lid body 187. In addition, like the embodiment of the invention shown in FIG. 11, a hygroscopic member may be coated on at least one of the inner surface of the first fluid channel 188 and the inner surface of the second fluid channel 189. Further, a heat-insulating layer may be formed in at least one of the part located on the lower side of the concavity in the base body 186 and the part located on the upper side of the concavity in the lid body 187. That is, a heat-insulating layer may be formed in at least one of the part of the base body 186 which part is in the vicinity of the concavity and the part of the lid body 187 which part is in the vicinity of the concavity. In other words, a heat-insulating layer may be formed in at least one of the part located between the bottom surface of the concavity in the base body 186 and the outer surface of the base body 186, and the part located between the one surface facing the concavity in the lid body 187 and the outer surface of the lid body 187.

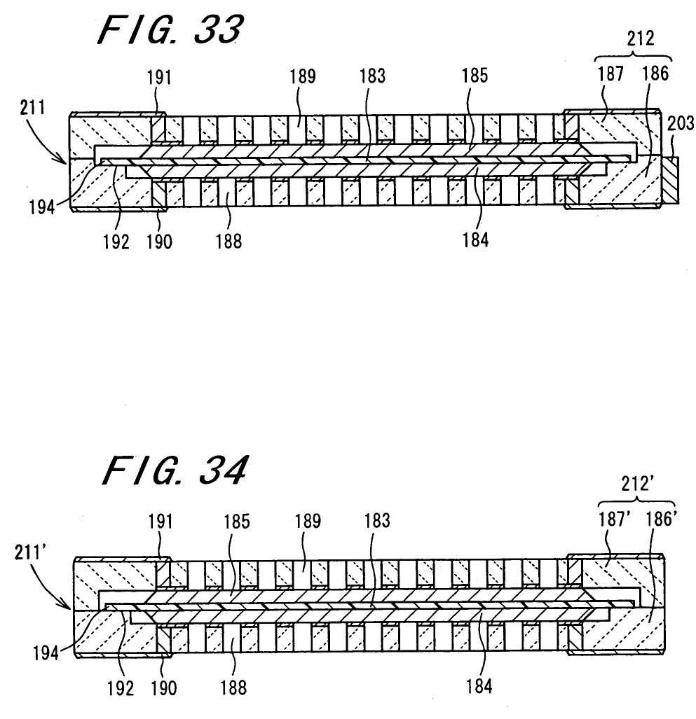

FIGS. 32 and 33 are sectional views each showing a fuel cell installed in the electronic apparatus according to still another embodiment of the invention. In this embodiment, the same components as those of the aforementioned embodiment will be denoted by the same reference numerals, and it will be omitted to describe in detail.

In these views, reference numerals 201, 211 denote a fuel cell, reference numerals 202, 212 denote a fuel cell casing, reference numerals 163, 183 denote a membrane electrode assembly, reference numerals 164, 184 denote a first electrode, reference numerals 165, 185 denote a second electrode, reference numerals 166, 186 denote a base body, reference numerals 167, 187 denote a lid body, reference numerals 168, 188 denote a first fluid channel, reference numerals 169, 189 denote a second fluid channel, reference numerals 170, 190 denote a first wiring conductor, reference numerals 171, 191 denote a second wiring conductor, reference numeral 203 denotes an external connection terminal, reference numerals 172, 182 denote a placement portion, reference numeral 173 denotes an abutting portion, and reference numerals 174, 184 denote an overhanging portion. These electronic apparatuses are a mobile phone, a PDA (personal digital assistant), a digital camera or the like. Concrete examples thereof will be described later. The fuel cell casing 202 shown in FIG. 32 comprises the base body 166 and the lid body 167. In addition, the fuel cell casing 212 shown in FIG. 33 comprises he base body 186 and the lid body 187.

Further, the external connection terminals 203 are bonded to at least either the base body 166, 186 or the lid body 167, 187 by soldering, brazing or the like. It is desirable that the external connection terminals 203 have a shape that enables fine electrical connection with a motherboard or the like for forming an electronic circuit as a main part of electronic apparatus. Such a shape is, for example, a rod, a hook, a cone or the like that allows easy electrical and mechanical connection to an electronic circuit as a main part of electronic apparatus by making the terminals in contact with each other or inserting the terminal. It is preferable to dispose a fitting portion (a hole or the like) corresponding to the external connection terminal to a region where the external connection terminal 203 is connected of an electronic circuit as a main part of electronic apparatus. Besides, by placing the external connection terminal 203 on the side surface of the base body 166, 186 or the lid body 167, 187, it is possible to low-profile electronic apparatus.

In the fuel cell casing 202 installed in the electronic apparatus according to the embodiment of the invention shown in FIG. 32, the first concavity of the base body 166 takes on a double structure, whereas the second concavity of the lid body 167 takes on a single structure. In the alternative, the first concavity of the base body 166 may take on a single structure and the second concavity of the lid body 167 may take on a double structure.

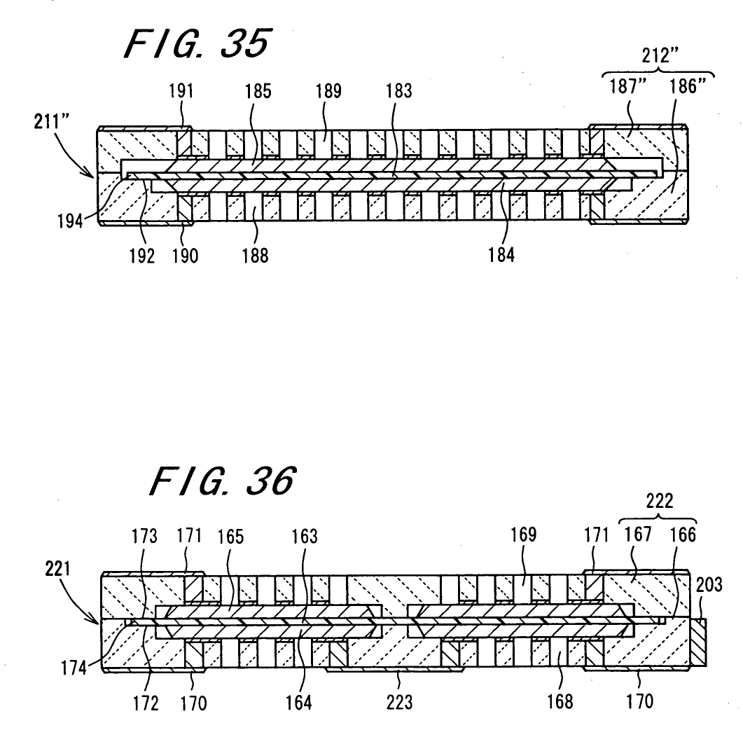

In the fuel cell 201 installed in the electronic apparatus according to the embodiment of the invention shown in FIG. 33, the concavity of the base body 186 takes on a so-called double structure, whereas the concavity of the lid body 187 takes on a single structure. However, the configurations may be altered as follows to facilitate the production of the base and lid bodies 186′, 186″ and 187′, 187″. For example, in another embodiment of the invention sectionally shown in FIG. 34 analogous to FIG. 33, both the concavity of the base body 186′ and the concavity of the lid body 187′ take on a single structure. Moreover, in still another embodiment of the invention sectionally shown in FIG. 35 analogous to FIG. 33, the concavity of the base body 186″ takes on a single structure, and meanwhile the lid body 187″ is formed in a concavity-absent flat structure.

Note that, in FIG. 34 and FIG. 35, the same parts as in FIG. 33 are denoted by the same reference numerals, and reference numerals 211′, 211″ denote a fuel cell, reference numerals 212′, 212″ denote a fuel cell casing, reference numeral 183 denotes a membrane electrode assembly, reference numeral 184 denotes a first electrode, reference numeral 185 denotes a second electrode, reference numerals 186′, 186″ denote a base body, reference numerals 187′, 187″ denote a lid body, reference numeral 188 denotes a first fluid channel, reference numeral 189 denotes a second fluid channel, reference numeral 190 denotes a first wiring conductor, reference numeral 191 denotes a second wiring conductor, reference numeral 192 denotes a placement portion, and reference numeral 194 denotes an overhanging portion.

By coating the exposed surfaces of the first wiring conductors 170, 190, the second wiring conductors 171, 191, and the external connection terminals 203 with metal such as nickel, copper, gold, platinum and palladium that are good in conductivity and good in corrosion-resistance and wettability with a blazing material, it is possible to realize good electrical connection between the first conductor 170, 190, the second conductor 171, 191, the external connection terminal 203 and a motherboard or the like for forming an electronic circuit as a main part of electronic apparatus.

In the fuel cell installed in the electronic apparatus of the invention shown in FIG. 32, the membrane electrode assembly 163 is housed, with its overhanging portion 174 grippingly interposed between the placement portion 172 formed in the outer periphery of the first concavity of the upper surface of the base body 166 and the abutment portion 173 formed in the outer periphery of the second concavity of the lower surface of the lid body 167. Thus, the first and second fluid channels 168 and 169 are isolated from each other by the membrane electrode assembly 163. This helps prevent mixing of two different fluid materials (for example, oxygen gas and hydrogen gas or methanol), and thus it never occurs that the fuel cell fails to function properly and that flammable fluid materials are ignited and exploded through mixture at a high temperature. As a result, the safety of the fuel cell can be assured. Moreover, since the overhanging portion 174 of the membrane electrode assembly 163 is grippingly interposed between the placement portion 172 of the base body 166 and the abutment portion 173 of the lid body 167, the membrane electrode assembly 163 can be securely housed within the fuel cell casing 202 with ease.

To ensure that the membrane electrode assembly 163 is fixed to the fuel cell casing 202 and that hermeticity is attained between the first fluid channel 168 and the second fluid channel 169, the interval between the placement portion 172 and the abutment portion 173 should preferably be made equal to or smaller than the thickness of the overhanging portion 174 of the membrane electrode assembly 163. Moreover, the opening dimension of the first concavity should preferably be made substantially equal to the outer dimension of the membrane electrode assembly 163. This helps facilitate positional adjustment of the membrane electrode assembly 163 with respect to the base body 166 during assembly. Further, to enhance the hermeticity between the first fluid channel 168 and the second fluid channel 169, a sealing material should preferably be arranged between the overhanging portion 174 and at least one of the placement portion 172 and the abutment portion 173. In this case, an adhesive sealing material is particularly desirable in terms of more reliable securement of the membrane electrode assembly 163.

In the fuel cell casing 212 of the invention shown in FIG. 33, the membrane electrode assembly 183 is placed on the placement portion 192 formed in the outer periphery of the concavity of the upper surface of the base body 186. Thus, the first and second fluid channels 188 and 189 are isolated from each other by the membrane electrode assembly 183. This helps prevent mixing of two different fluid materials (for example, oxygen gas and hydrogen gas or methanol), and thus it never occurs that the fuel cell fails to function properly and that flammable fluid materials are ignited and exploded through mixture at a high temperature. As a result, the safety of the fuel cell can be assured. Moreover, since there is no need to conform the depth of the concavity to the thickness of the thin overhanging portion 194 of the membrane electrode assembly 183, the base body 186 can be produced with ease.

At the time of placing the membrane electrode assembly 163, 183 onto the placement portion 172, 192, it is good to place via an adhesive that has a sealing characteristic between them, because fixture of the membrane electrode assembly 163, 183 and hermeticity between the first fluid channels 168, 188 and the second fluid channels 169, 189 are secured. Such an adhesive is a rubber or resin material of fluororesin-base, silicon-base, ethylene propylene-base, polyurethane-base, polysulfide-base, butyl rubber-base, acrylic-base, epoxy-base or the like.

With the above constitution, as shown in FIGS. 32 and 33, the fuel cell casing 202, 212 that is capable of storing the membrane electrode assembly 163, 183 and is small and sturdy can be obtained, and the fuel cell 201, 211 that can be controlled highly efficiently and is installed in the electronic apparatus of the invention can be obtained.

Next, FIGS. 36 to 43 are sectional views each showing fuel cell installed in the electronic apparatus according to still another embodiment of the invention.

In these views, reference numerals 221, 231, 241, 251, 261, 271, 281, 291 denote a fuel cell, reference numerals 222, 232, 242, 252, 262, 272, 282, 292 denote a fuel cell casing, reference numerals 163, 183 denote a membrane electrode assembly, reference numerals 164, 184 denote a first electrode, reference numerals 165, 185 denote a second electrode, reference numerals 166, 186 denote a base body, reference numerals 167, 187 denote a lid body, reference numerals 168, 188 denote a first fluid channel, reference numerals 169, 189 denote a second fluid channel, reference numerals 170, 190 denote a first wiring conductor, reference numerals 171, 191 denote a second wiring conductor, reference numeral 203 denotes an external connection terminal, reference numerals 223, 263 denote a third wiring conductor, reference numerals 233, 273 denote a fourth wiring conductor, reference numerals 234, 274 denote a fifth wiring conductor, reference numerals 243, 283 denote a sixth wiring conductor, reference numerals 253, 293 denote a seventh wiring conductor, reference numerals 254, 294 denote an eighth wiring conductor, reference numerals 172, 192 denote a placement portion, reference numeral 173 denotes an abutting portion, and reference numerals 174, 194 denote an overhanging portion.

In FIGS. 36 to 43, the same reference numerals as in FIGS. 32 and 33 denote the same parts as in FIGS. 32 and 33.

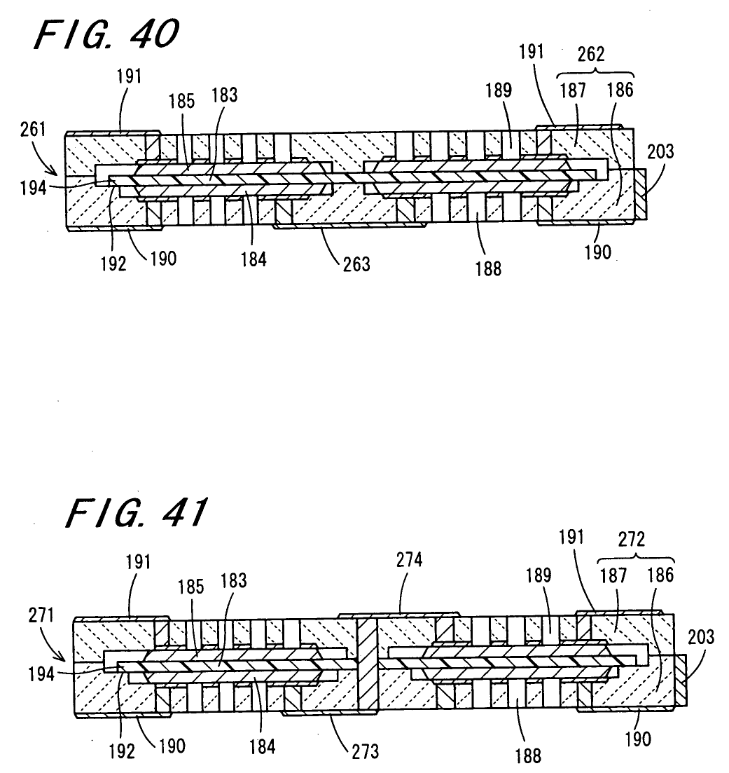

The third wiring conductor 223, 263 of FIGS. 36 and 40, one end of which is disposed to a region facing the first electrode 164, 184 of the membrane electrode assembly 163, 183 on the bottom surface of one of the plural first concavities or concavities of the base body 166, 186 and the other end of which is disposed to a region facing the first electrode 164, 184 of another membrane electrode assembly 163, 183 on the bottom surface of another one of the first concavities or the concavities, is formed in one body with the base body 166, 186. Moreover, it is desirable to form the third wiring conductor 223, 263 to be 10 μm or more higher than the bottom surface of the first concavity or the concavity of the base body 166, 186 so that both the ends thereof can be easily made in contact with the first electrode 164, 184. The desired height of the third wiring conductor 223, 263 can be achieved by adjusting the printing condition such that the conductor paste is print-coated in a larger thickness during the print-coating process as described above. Further, the third wiring conductor 223, 263 should preferably be arranged in plural face to face with the first electrode 164, 184. This helps reduce electric loss in the third wiring conductor 223, 263. That part of the third wiring conductor 223, 263 which penetrates through the base body 166, 186 should preferably be Φ50 μm or above in diameter.

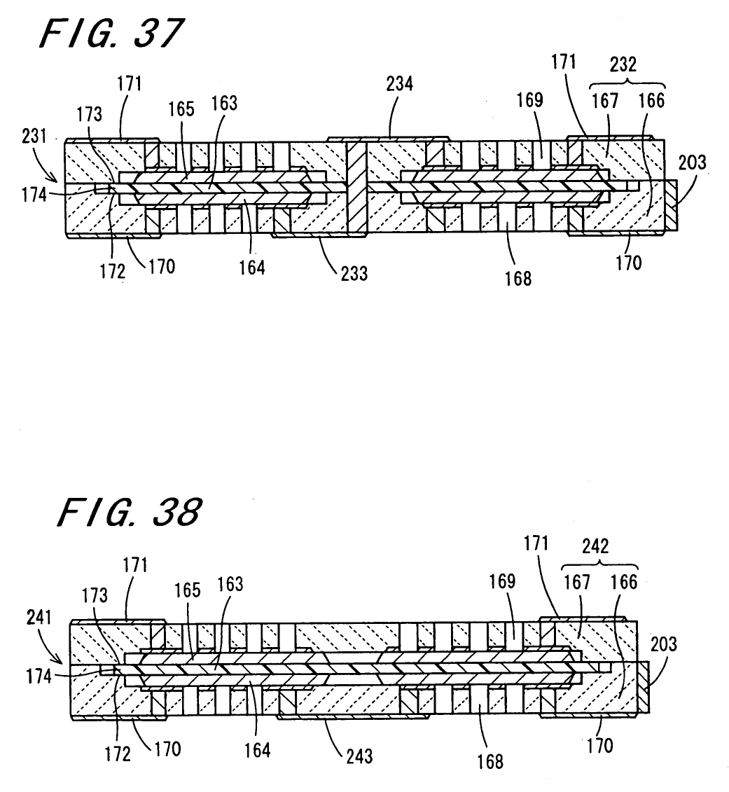

Of the fourth wiring conductor 233, 273 of FIGS. 37 and 41, one end is disposed to a region facing the first electrode 164, 184 of the membrane electrode assembly 163, 183 on the bottom surface of one of the plural first concavities or concavities of the base body 166, 186, and the other end is led out to a region where the lid body 167, 187 is mounted of the upper surface of the base body 166, 186. Moreover, the fifth wiring conductor 234, 274 is formed in a manner that one end is disposed to a region facing the second electrode 165, 185 of the membrane electrode assembly 163, 183 of another one of the first concavities or the concavities on the lower surface of the lid body 167, 187, and the other end is led out to a region mounted to the base body 166, 186 of the lower surface of the lid body 167, 187 so as to face the other end of the fourth wiring conductor 233, 273.

This fourth wiring conductor 233, 273 is formed in one body with the base body 166, 186 in the same manner as the third wiring conductor 223, 263, and it is desirable to form to be 10 μm or more higher than the bottom surface of the first concavity or the concavity of the base body 166, 186 so that one end thereof is easily made in contact with the first electrode 164, 184. The desired height of the fourth wiring conductor 233, 273 can be achieved by adjusting the printing condition such that the conductor paste is print-coated in a larger thickness during the print-coating process as described above. Further, the fourth wiring conductor 233, 273 should preferably be arranged in plural face to face with the first electrode 164, 184. This helps reduce electric loss in the fourth wiring conductor 233, 273. That part of the fourth wiring conductor 233, 273 which penetrates through the base body 166, 186 should preferably be Φ50 μm or above in diameter.

Further, the fifth wiring conductor 234, 274 is formed in one body with the lid body 167, 187 in the same manner as the second wiring conductor 171, 191, and it is desirable to form to be 10 μm or more higher than the lower surface of the lid body 167, 187 so that one end thereof is easily made in contact with the second electrode 165, 185. The desired height of the fifth wiring conductor 234, 274 can be achieved by adjusting the printing condition such that the conductor paste is print-coated in a larger thickness during the print-coating process as described above. Further, the fifth wiring conductor 234, 274 should preferably be arranged in plural face to face with the second electrode 165, 185. This helps reduce electric loss in the fifth wiring conductor 234, 274. That part of the fifth wiring conductor 234, 274 which penetrates through the lid body 167, 187 should preferably be Φ50 μm or above in diameter.

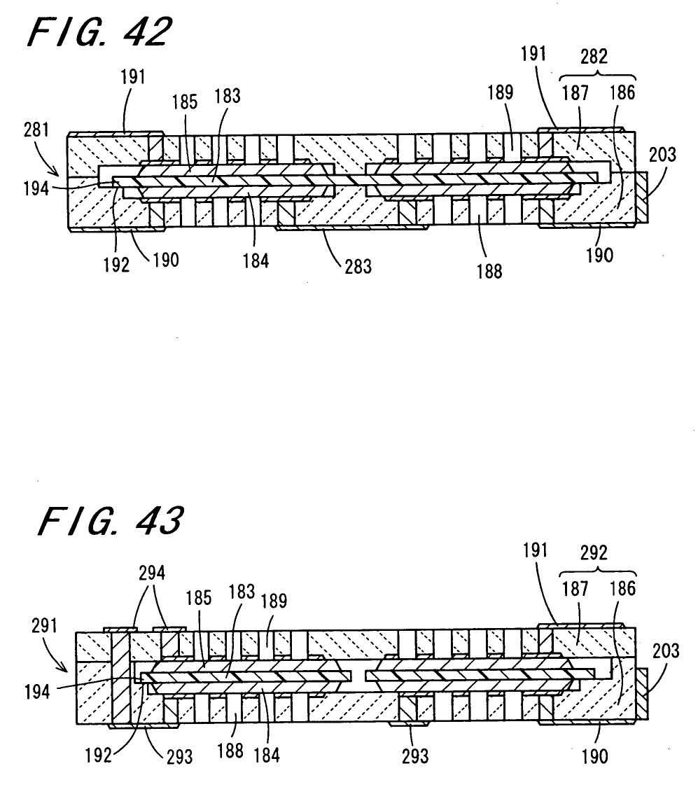

The sixth wiring conductor 243, 283 of FIGS. 38 and 42, one end which is disposed to a region facing the first electrode 164, 184 of one of the membrane electrode assemblys 163, 183 on the bottom surface of the first concavity or the concavity of the base body 166, 186 and the other end which is disposed to a region facing the first electrode 164, 184 of another one of the membrane electrode assemblys 163, 183 on the bottom surface of the same first concavity or concavity, is formed in one body with the base body 166, 186.

It is desirable to form the sixth wiring conductor 243, 283 to be 10 μm or more higher than the bottom surface of the first concavity or concavity of the base body 166, 186 so that both the ends thereof are easily made in contact with the first electrode 164, 184. The desired height of the sixth wiring conductor 243, 283 can be achieved by adjusting the printing condition such that the conductor paste is print-coated in a larger thickness during the print-coating process as described above. Further, the sixth wiring conductor 243, 283 should preferably be arranged in plural face to face with the first electrode 164, 184. This helps reduce electric loss in the sixth wiring conductor 243, 283. That part of the sixth wiring conductor 243, 283 which penetrates through the base body 166, 186 should preferably be Φ50 μm or above in diameter.

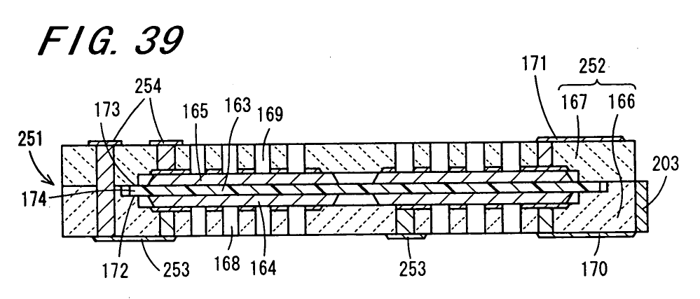

Of the seventh wiring conductor 253, 293 of FIGS. 39 and 43, one end is disposed to a region facing the first electrode 164, 184 of one of the plural membrane electrode assemblys 163, 183 on the bottom surface of the first concavity or the concavity of the base body 166, 186, and the other end is led out to a region where the lid body 167, 187 is mounted of the upper surface of the base body 166, 186. Moreover, the eighth wiring conductor 254, 294 is formed in a manner that one end is disposed to a region facing the second electrode 165, 185 of another one of the plural membrane electrode assemblys 163, 183 of the lower surface of the lid body 167, 187 and the other end is led out to a region mounted to the upper surface of the base body 166, 186 of the lower surface of the lid body 167, 187 so as to face the other end of the seventh wiring conductor 253, 293.

This seventh wiring conductor 253, 293 is formed in one body with the base body 166, 186 in the same manner as the third wiring conductor 223, 263, and it is desirable to form to be 10 μm or more higher than the bottom surface of the concavity of the base body 166, 186 so that one end thereof is easily made in contact with the first electrode 164, 184. The desired height of the seventh wiring conductor 253, 293 can be achieved by adjusting the printing condition such that the conductor paste is print-coated in a larger thickness during the print-coating process as described above. Further, the seventh wiring conductor 253, 293 should preferably be arranged in plural face to face with the first electrode 164, 184. This helps reduce electric loss in the seventh wiring conductor 253, 293. That part of the seventh wiring conductor 253, 293 which penetrates through the base body 166, 186 should preferably be Φ50 μm or above in diameter.

Further, the eighth wiring conductor 254, 294 is formed in one body with the lid body 167, 187 in the same manner as the second wiring conductor 171, 191, and it is desirable to form to be 10 μm or more higher than the lower surface of the lid body 167, 187 so that one end thereof is easily made in contact with the second electrode 165, 185. The desired height of the eighth wiring conductor 254, 294 can be achieved by adjusting the printing condition such that the conductor paste is print-coated in a larger thickness during the print-coating process as described above. Further, the eighth wiring conductor 254, 294 should preferably be arranged in plural face to face with the first electrode 164, 184. This helps reduce electric loss in the eighth wiring conductor 254, 294. That part of the eighth wiring conductor 254, 294 which penetrates through the base body 166, 186 should preferably be Φ50 μm or above in diameter.

As shown in FIGS. 36, 37, 40 and 41, according to the fuel cell casing 222, 232, 262, 272 installed in the electronic apparatus and the fuel cell 221, 231, 261, 271, by storing the membrane electrode assembly 163, 183 in each first concavity or concavity of the base body 166, 186 that has a plurality of first concavities or concavities, disposing the third wiring conductors 223, 263, or the fourth wiring conductors 233, 273 and the fifth wiring conductors 234, 274 between the end portions of the adjacent first concavities or concavities, electrically connecting the first electrodes 164, 184 of the plural membrane electrode assemblys 163, 183, or the first electrode 164, 184 and the second electrode 165, 185, and electrically connecting the first wiring conductors 170, 190 and the second wiring conductors 171, 191 so as to take out the whole output to the membrane electrode assemblys 163, 183 placed in positions to become both ends, three-dimensional free wiring is allowed by the first to third wiring conductors 170, 190; 171, 191; 223, 263 or by the first, second, fourth and fifth wiring conductors 170, 190; 171, 191; 233, 273; 234, 274, so that it is possible to arbitrarily connect the plural membrane electrode assemblys 163, 183 in series or in parallel. As a result, since it becomes possible to efficiently regulate the entire output voltage and output current, a fuel cell that is capable of taking out electricity electrochemically generated in the plural membrane electrode assemblys 163, 183 to the outside in a good manner is realized.

As shown in FIGS. 38, 39, 42 and 43, according to the fuel cell casing 242, 252, 282, 292 installed in the electronic apparatus of the invention and the fuel cell 241, 251, 281, 291, by containing the plural membrane electrode assemblys 163, 183 in the first concavity or concavity of the base body 166, 186, disposing the sixth wiring conductors 243, 283, or the seventh wiring conductors 253, 293 and the eighth wiring conductors 254, 294, electrically connecting the first electrodes 164, 184 of the plural membrane electrode assemblys 163, 183, or the first electrode 164, 184 and the second electrode 165, 185, and electrically connecting the first wiring conductors 170, 190 and the second wiring conductors 171, 191 so as to take out the whole output to the membrane electrode assemblys 163, 183 placed in positions to become both ends, three-dimensional free wiring is allowed by the first, second and sixth wiring conductors 170, 190; 171, 191; 243, 283 or by the first, second, seventh and eighth wiring conductors 170, 190; 171, 191; 253, 293; 254, 294, so that it is possible to arbitrarily connect the plural membrane electrode assemblys 3 in series or in parallel. As a result, since it becomes possible to efficiently regulate the entire output voltage and output current, a fuel cell that is capable of taking out electricity electrochemically generated in the plural membrane electrode assemblys 163, 183 to the outside in a good manner is realized.

In the scope of the invention, various changes may be done. For example, in order to low-profile the whole fuel cell, inlets from the side face of the base body 166, 186 or the lid body 167, 187 may be disposed to the first fluid channels 168, 188 or the second fluid channels 169, 189. This is effective for miniaturization at the time of using for mobile electronic apparatus in specific. Besides, regarding the first and second wiring conductors 170, 190; 171, 191, the other ends led out to the outer surfaces of the base body 166, 186 and the lid body 167, 187 may be disposed so as to be led out to the side faces on the same side, respectively, to gather the external connection terminals 203. This makes it possible to gather wiring, ducts and the like on one side of the fuel cell, miniaturization and protection of joints to the outside are facilitated, highly reliable designing is enabled, and a fuel cell that is capable of stably operating for a long term is realized.

Next, electronic apparatus that has the above fuel cell as a power source will be described.

Since the electronic apparatus of the invention has the fuel cell as mentioned above as a power source, it has various effects as described below and is small, short in height, capable of stable operation over the long run, and excellent in safety and convenience.

According to the electronic apparatus of the invention, since a part of the external connection terminals 203 (a positive terminal and a negative terminal) of the fuel cell as a power source can be electrically connected to a circuit board of the electronic apparatus with ease and freely attached and detached, for example, the fuel cell can be replaced with a new fuel cell considerably easily and is highly convenient.

Further, since a fuel cell and a fuel cell casing constituted by the base body 166, 186 made of multilayer ceramic are used as a power source and therefore electric wiring of the fuel cell can be freely done, it is easy to connect a plurality of fuel cells in series, and it is possible to realize electronic apparatus that is small, short in height and light-weight.

Furthermore, since the base body 166, 186 is made of multilayer ceramics, a resistor, a capacitance and an inductance can be formed inside the base body.

By thus forming a large-capacity capacitance inside the base body 166, 186, for example, in parallel with a fuel cell, in a case where an electric current outputted from the fuel cell is lacking, a shortfall of the electric current is compensated and supply of an electric current responsive to an aimed output electric current can be secured. Moreover, since, in the same manner, by using a resistor, a capacitance and an inductance, a boosting circuit can be formed, it becomes possible to secure a voltage necessary for electronic apparatus.

In the case of forming a resistor, a capacitance or an inductance inside the base body 166, 186, it is preferable that the base body 166, 186 is made of sintered glass ceramics.

For example, sintered glass ceramics is made of a glass component and filler. These components are the same as the aforementioned embodiment, and it will be omitted to describe in details.

Further, it is preferable that the mixture ratio of the glass and the filler is 40:60 to 99:1 in mass ratio.

As an organic binder blended in a glass ceramic green sheet, one that has been used in a ceramic green sheet so far can be used, and it is, for example, a homopolymer or a copolymer of acrylic-base (a homopolymer or a copolymer of acrylic acid, methacrylic acid or ester thereof, concretely, an acrylic acid ester copolymer, a methacrylic acid ester copolymer, acrylic acid ester—methacrylic acid ester copolymer or the like), polyvinyl butyral-base, polyvinyl alcohol-base, acrylic-styrene-base, polypropylene carbonate-base, cellulose-base or the like.

A glass ceramic green sheet is obtained by adding a specified amount of plasticizer, a solvent (an organic solvent, water or the like) into the glass powder, the filler powder and the organic binder as necessary to obtain slurry, and molding this by doctor blade, rolling, calendar rolling, die pressing or the like to thickness of approximately 50 to 500 μm.

A conductor pattern is formed on the surface of a glass ceramic green sheet, for example, by printing paste of conductor material powder by a screen printing method, a gravure printing method or the like, or by transferring metal foil of a specified pattern shape. A conductor material is of, for example, one kind or two or more kinds selected from Au, Ag, Pd, Pt or the like, and in the case of containing two or more kinds, it may be any shape of mixture, alloy, coating or the like.

Further, in a case where a large-capacity capacitance is formed, for example, a layer made of inorganic substance powder that has high dielectric constant such as barium titanate (referred to as a barium titanate layer hereafter) is formed inside a base body made of glass ceramics. In this case, it is manufactured by firstly forming slurry that contains ceramic powder and glass powder to obtain a plurality of green sheets, subsequently printing metal paste to become a lower electrode layer on the green sheet, subsequently printing dielectric paste made of barium titanate or the like on the lower electrode layer by screen printing to form a dielectric layer, further printing metal pate on the dielectric layer to form an upper electrode layer, stacking these green sheets, and firing this stacked body.

Further, in a case where a resistor is formed inside the base body, it can be formed by print-applying resistor paste whose principal ingredients are RuO₂, IrO₂, RhO₂, SnO₂, LaB₆ and the like to the green sheet in a specified pattern by a method such as screen printing, gravure printing or the like by the same method as the first wiring conductor 170, 190 and the second wiring conductor 171, 191.

Further, it is good that an internal circuit is formed in the base body 166, 186 of the fuel cell 201, 211. Consequently, it is possible to mount an electronic part electrically connected to the internal circuit on the surface of the base body 166, 186. Therefore, it is possible to increase functionality of electronic apparatus by the electronic part mounted on the surface of the base body 166, 186.

Further, it is good that an electronic part electrically connected to the internal circuit is disposed to the surface of the base body 166, 186 of the fuel cell 201, 211. Consequently, by using a sensor, a control IC or the like as the electronic part and detecting the density of fuel inside the fluid channels 168, 188; 169, 189 by a density sensor, optimum circulation, fuel dilution, and suppress of decrease of fuel use efficiency are enabled.

Further, it is good that, in the fuel cell 201, 211, piezoelectric pumps, that is, micropumps using a piezoelectric material such as lead zirconate titanate (PZT; composition formula: Pb (Zr, Ti) O3) are disposed in at least either the first fluid channels 168, 188 or the second fluid channels 169, 189. Consequently, the small piezoelectric pumps prevent backflow of fuel, with the result that it is possible to prevent unused fuel from being polluted by a reactant or the like, and it is possible to avoid that residual air affects an operation of electronic apparatus because the residual air is discharged. Besides, fuel is constantly supplied, with the result that electric power is stably generated, and actuation time is shortened because fuel is smoothly supplied.

The piezoelectric pump is constituted by an influx portion, a variable volume portion, and an efflux portion. Then, the variable volume portion can be manufactured by, for example, disposing a piezoelectric material outside the first and second fluid channels 168, 188; 169, 189, and by the use of expansion and contraction of the piezoelectric material responsive to an applied voltage, it is possible to vibrate upper regions of the first and second fluid channels 168, 188; 169, 189. Consequently, it can vary the volumes of the first and second fluid channels 168, 188; 169, 189, and can function as a pump.

Further, the influx portion and the efflux portion are formed by the first and second fluid channels 168, 188; 169, 189 connected to the variable volume portion, and they are for letting fuel flow into and out of the variable volume portion. It is preferable that the sectional area of the efflux portion is larger than the sectional area of the influx portion. Consequently, pressure of fuel of the efflux portion becomes small, and in the case of causing the variable volume portion to function as a pump, fuel flows toward the efflux portion where pressure is small, and it is possible to send fuel in a specific direction in a good manner. Backflow prevention valves that prevent backflow of fuel may be disposed to the influx portion and the efflux portion.

Such a piezoelectric pump is made of an organic or inorganic piezoelectric material, and can be manufactured by bonding this piezoelectric material after firing a ceramic green sheet to become the base body 166, 186 or the lid body 167, 187 or, in the case of using a ceramic piezoelectric material such as PZT, mounting the ceramic piezoelectric material in a specified position of a ceramic green sheet and thereafter firing at the same time.

Further, the fuel cell 201, 211 is excellent in reliability and safety because, other than the first and second wiring conductors 170, 190; 171, 191 whose one ends are disposed inside the casing, nothing comes in electric contact with the membrane electrode assembly 163, 183 itself uselessly.

On the basis of the above, according to the electronic apparatus of the invention, it is possible to provide electronic apparatus that is excellent in compactness, convenience and safety and capable of stable operation over the long run by equal supply of fluids and highly efficient electrical connection.

Then, in concrete, the electronic apparatus of the invention is mobile electronic apparatus such as a mobile phone, a PDA (personal digital assistant), a digital camera or video camera or a toy such as a game machine, and electronic apparatus that includes a laptop PC (personal computer) such as a printer, a facsimile, a television, a communication apparatus, an audio video apparatus, various kinds of household electric appliances such as an electric fan, or a machine tool of portable type.

In recent years, electronic apparatus that additionally has a function of displaying a moving image by the use of a liquid crystal display device or the like has been used. Since such moving image display requires considerably large power consumption, electronic apparatus that uses a conventional storage battery becomes incapable of operating in a short time period, whereas the electronic apparatus of the invention is provided with a fuel cell that can supply a power source for a considerably long time period, and therefore, it is capable of operating for a long time period even in the case of displaying a moving image.

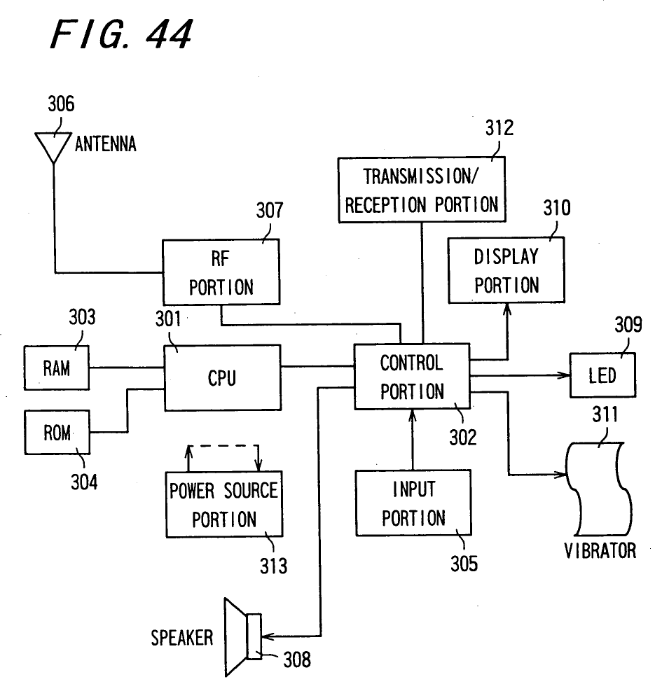

For example, in a case where the electronic apparatus of the invention is a mobile phone, as shown in a block diagram of FIG. 44, it comprises a central processing unit (CPU) 301, a control portion 302, a random access memory (RAM) 303, a read only memory (ROM) 304, an input portion 305 that inputs data operated by the user to the CPU 301, an antenna 306, a radio portion 307 that demodulates a signal received by the antenna 306 and supplies to the control portion 302 as well as modulates a signal supplied from the control portion 302 and transmits from the antenna 306, a speaker 308 that rumbles based on a rumbling signal from the control portion 302, a light emitting diode (LED) 309 that turns on, turns off or flashes by control from the control portion 302, a display portion 310 that displays information by a signal from the control portion 302, a vibrator 311 that vibrates by a driving signal from the control portion 302, a transmission/reception portion 312 that converts a voice of the user to a voice signal and transmits to the control portion 302 as well as converts a voice signal from the control portion 302 to a voice and outputs, and a power source portion 313 that supplies power sources to the respective portions, and the fuel cell and the fuel cell casing of the invention are built in the power source portion 313.

In this case, the fuel cell and the fuel cell casing are excellent in compactness, convenience and safety, and are capable of equal supply of fuel and power source supply for a long time period by highly efficient electrical connection, whereby miniaturization, low-profiling and weight reduction of a mobile phone are enabled.

Further, considering that a recent mobile phone is miniaturized and low-profiled enough, it is possible to additionally install an electronic part that has a function of a camera, a video or the like other than a function of a telephone into a space made by miniaturizing and low-profiling a fuel cell in the above manner, and it is possible to promote multifunction.

Further, instead of newly installing an electronic part, it is also possible to dispose a shock absorber, a preventive member or the like so as to protect a major electronic circuit. In this case, it is also possible to make a structure that can possibly strengthen than ever shock-resistance when a mobile phone main body is shocked by a fall or the like, a waterproof characteristic at the time of use in the rain or the like.

Further, as a result of miniaturizing an electric circuit portion inside a mobile phone main body, restrictions on the outer shape of a mobile phone main body decrease, and it becomes possible to form a mobile phone in an outer shape that is excellent in design, for example, a shape that enables elderly people and children to hold with ease.

Further, in a case where the structure of the power source portion 313 is a structure that the fuel cell and the fuel cell casing can be freely attached and detached as described above, it is possible, by preparing a spare fuel cell and fuel cell casing, to easily replace to a spare fuel cell and fuel cell casing or take out a fuel cell to replenish and replace fuel in case of battery shutoff or the like, so that it is possible to continuously speak on the phone, and the phone becomes more excellent in convenience than conventional one that uses a storage battery as a power source.

Further, since a replaced (used) fuel cell can be instantly reused after replenished with fuel, it is easier to use than a charging type, and it is possible to effectively use resources. Moreover, there is a merit that it is possible to use even in case of emergency such as blackout for a long time period due to natural disasters and even outdoors.

Further, a laptop PC (personal computer) is made by a basic constitution of comprising a personal computer main body, a first box that contains a keyboard for inputting specified data to the personal computer main body, and a second box that contains a display for displaying data inputted by the keyboard or data processed by the personal computer main body, attaching the second box to the first box so as to be openable and closable, and forming a power source portion that supplies power sources to the respective portions in the first box, and the fuel cell and the fuel cell casing are installed in the power source portion. In this case, as in the aforementioned mobile phone, the fuel cell and the fuel cell casing installed in the electronic apparatus of the invention are excellent in compactness, convenience and safety and are capable of equal supply of fuel and power source supply for a long time period by highly efficient electrical connection, so that miniaturization, low-profiling and weight reduction of a laptop PC (personal computer) main body and making it multifunction are enabled, and it is possible to realize a highly convenient laptop PC (personal computer) that is capable of stable supply of a large electric current for a long time period and that has a display easy to look and reduces burdens of weight and volume at the time of carrying, in response to a large and high-resolution display.

Further, in a case where the structure of the power portion is a structure that the fuel cell and the fuel cell casing are freely attached and detached, by preparing a spare fuel cell and fuel cell casing of the invention, there is a merit that under the condition of using with only a secondary battery outdoors or in a mobile unit such as an airplane, it becomes possible to supply electric power for a longer time period than ever dramatically. Moreover, in the case of using in a public space, it is outstandingly excellent in convenience and can be used without restrictions because it is excellent in safety.

The invention is not limited to the above embodiments and can be changed in various manners in the scope of the invention,

furthermore, although a DMFC that uses methanol as fuel is used as a fuel cell in the above embodiments, a fuel cell that uses various kinds of liquids including dimethyl ether as fuel can be also used.

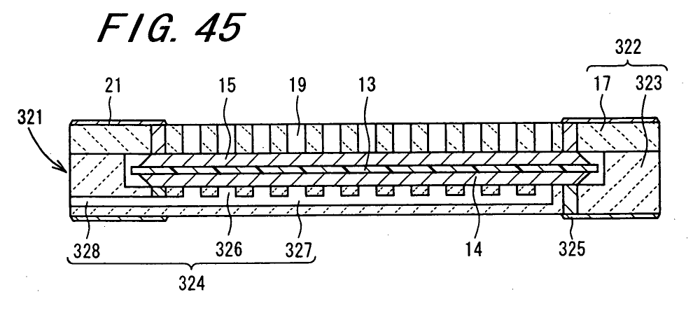

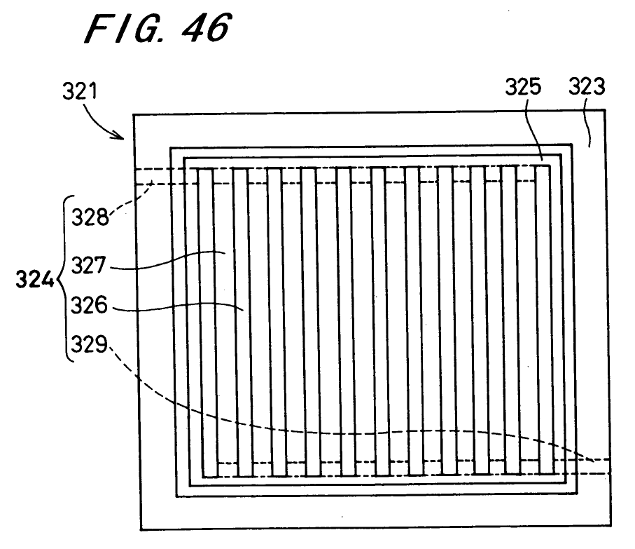

FIG. 45 is a sectional view showing a fuel cell casing and a fuel cell employing the same according to still another embodiment of the invention. FIGS. 46 to 51 are top views each showing the base body of the fuel cell casing and the fuel cells employing the same according to still another embodiment of the invention. In this embodiment, the same components as those of the aforementioned embodiment will be denoted by the same reference numerals, and it will be omitted to describe in detail. In these figures, reference numerals 321, 331, 341, 351, and 361 denote a fuel cell; reference numerals 322, 332, 342, 352, and 362 denote a fuel cell casing; reference numeral 13 denotes a membrane electrode assembly; reference numeral 14 denotes a first electrode; reference numeral 15 denotes a second electrode; reference numerals 323, 333, 343, 353, and 363 denote a base body; reference numeral 17 denotes a lid body; reference numerals 324, 334, 344, 354, and 364 denote a first fluid channel; reference numeral 19 denotes a second fluid channel; reference numerals 325, 335, 345, 355, and 365 denote a first wiring conductor; reference numeral 21 denotes a second wiring conductor; reference numerals 326, 336, 346, 356, and 366 denote an opening portion; reference numerals 327, 337, 347, 357, and 367 denote a coupling portion; reference numerals 328, 338, 348, 358, and 368 denote an introducing portion; and reference numerals 329, 339, 349, 359, and 369 denote a discharge portion. Otherwise, in the invention, the opening portion 326, 336, 346, 356, and 366, the coupling portions 327, 337, 347, 357, and 367, the introducing portions 328, 338, 348, 358, and 368, and the discharge portions 329, 339, 349, 359, and 369, are different from one another in arrangement, width, and depth.

The fuel cell casing 322, 332, 342, 352, 362 of the invention comprises the base body 323, 333, 343, 353, 363 that has a concavity and the lid body 17, has a function of storing the membrane electrode assembly 13 inside the concavity and hermetically sealing, and is made of a ceramics material such as sintered aluminum oxide (Al₂O₃), sintered mullite (3Al₂O₃.2SiO₂), sintered silicon carbide (SiC), sintered aluminum nitride (AlN), sintered silicon nitride (Si₃N₄) or sintered glass ceramics.

For example, sintered glass ceramics is made of a glass component and filler. These components are the same as the aforementioned embodiment, and it will be omitted to describe in details.

Since the fuel cell casing 322, 332, 342, 352, 362 comprises the base body 323, 333, 343, 353, 363 having a concavity and the lid body 17, and the concavity is hermetically sealed by mounting the lid body 17 around the concavity of the base body 323, 333, 343, 353, 363 so as to cover the concavity, the lid body 17 is mounted to the base body 323, 333, 343, 353, 363 by bonding with a metal bonding material such as solder or silver brazing filler, by bonding with a resin material such as epoxy, or by a method of bonding a sealant or the like made of ferroalloy or the like on the upper surface around the concavity and welding by seam weld, electron beam, laser or the like. Here, the lid body 17 may be also provided with a concavity in the manner as the base body 323, 333, 343, 353, 363.

The base body 323, 333, 343, 353, 363 and the lid body 17 are made to be thin, respectively, and in order to enable low-profiling of the fuel cell 321, 331, 341, 351, 361 of the invention, it is preferable that flexural strength as mechanical strength is 200 MPa or more.

It is preferable that the base body 323, 333, 343, 353, 363 and the lid body 17 are made of sintered aluminum oxide of a close-packed substance whose relative density is 95% or more, for example. In this case, for example, firstly, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser or the like, through holes and openings as the first fluid channels 324, 334, 344, 354, 364 and the second fluid channels 19 and through holes for disposing the first connection conductors 325, 335, 345, 355, 365 and the second connection conductors 21 are formed on the green sheet.

The first wiring conductor 325, 335, 345, 355, 365 and the second wiring conductor 21 should preferably be composed of tungsten, molybdenum or an alloy thereof to prevent oxidation. In this case, for example, conductor paste made by adding 3 to 20 mass parts of Al₂O₃ and 0.5 to 5 mass parts of Nb₂O₅ to 100 mass parts of tungsten or molybdenum powder as an inorganic component is prepared. The conductor paste is filled in the through hole pierced in the green sheet to form a via hole acting as a through conductor.

Into the conductor paste, for the purpose of increasing close adhesion of the base body 323, 333, 343, 353, 363 and the lid body 17 to ceramics, aluminum oxide powder or powder of the same composite with a ceramics component forming the base body 323, 333, 343, 353, 363 and the lid body 17 can be added, for example, in the ratio of 0.05 to 2 volume %.

The first wiring conductor 325, 335, 345, 355, 365 and the second wiring conductor 21 are formed in the outer and inner layers of the base body 323, 333, 343, 353, 363 and the lid body 17 before, after, or concurrently with the formation of the via conductor achieved by filling the conductor paste into the through hole. The formation of the wiring conductors is achieved by print-coating a similar conductor paste in a predetermined pattern on the green sheet in accordance with the screen printing method, gravure printing method, or the like method.

Thereafter, a predetermined number of sheet-like molded bodies carrying the printed, filled conductor paste are subjected to positional alignment, and are then stacked on top of each other under pressure. The stacked body is then fired, in a non-oxidative atmosphere, at a high temperature of approximately 1200 to 1500° C. Thereby, the desired ceramic base body 323, 333, 343, 353, 363, the lid body 17, the first wiring conductor 325, 335, 345, 355, 365 and the second wiring conductor 21 are obtained.

Further, it is preferable that the base body 323, 333, 343, 353, 363 and the lid body 17 made of ceramics have thickness of 0.2 mm or more. In a case where the thickness is less than 0.2 mm, because the strengths are apt to come short, the base body 323, 333, 343, 353, 363 and the lid body 17 tend to be easily cracked by stress caused when the base body 323, 333, 343, 353, 363 and the lid body 17 are mounted. On the other hand, in a case where the thickness is more than 5 mm, because slenderizing and low-profiling are difficult, it is inappropriate to use as a fuel cell installed in small mobile equipment, and because a thermal capacity is large, it is likely to become hard to instantly set to appropriate temperature corresponding to an electrochemical reaction condition of the membrane electrode assembly 3.

The first wiring conductors 325, 335, 345, 355, 365 and the second wiring conductors 21 are electrically connected to the first electrode 14 and the second electrode 15 of the membrane electrode assembly 13, respectively, thereby functioning as conductive paths for taking out an electric current generated in the membrane electrode assembly 13 to the outside of the fuel cell casing 322, 332, 342, 352, 362.

The first wiring conductor 325, 335, 345, 355, 365 has its one end disposed around the opening portion 326, 336, 346, 356, 366 of the first fluid channel 324, 334, 344, 354, 364 facing the first electrode 14 of the membrane electrode assembly 13 on the bottom surface of the concavity of the base body 323, 333, 343, 353, 363, or more preferably, disposed over the entire area of the surface with which the first electrode 14 of the membrane electrode assembly 13 makes contact, and its other end led out toward the outer surface (i.e. bottom surface in the example of FIG. 45) of the base body 323, 333, 343, 353, 363. With this arrangement, the first wiring conductor 325, 335, 345, 355, 365 can be in immediate contact with the entire area of the principal surface of the first electrode 14 of the membrane electrode assembly 13, with the exception of the area facing with the opening portion 326, 336, 346, 356, 366 of the first fluid channel 324, 334, 344, 354, 364. This makes it possible to increase the contact area between the first electrode 14 of the membrane electrode assembly 13 and the first wiring conductor 325, 335, 345, 355, 365. As a result, an increase in electrical resistance and occurrence of improper contact can be effectively prevented, thus achieving a fuel cell that succeeds in providing high electricity-production efficiency.

As described above, it is preferable that the first wiring conductor 325, 335, 345, 355, 365 is formed integrally with the base body 323, 333, 343, 353, 363 and is made 10 μm or above higher than the concavity bottom surface of the base body 323, 333, 343, 353, 363. This allows the first wiring conductor 325, 335, 345, 355, 365 to make contact with the first electrode 14 with ease. The desired height of the first wiring conductor 325, 335, 345, 355, 365 can be achieved by adjusting the printing condition such that the conductor paste is print-coated in a larger thickness during the print-coating process as described above. Further, the first wiring conductor 325, 335, 345, 355, 365 should preferably be arranged in plural face to face with the first electrode 14. This helps reduce electric loss in the first wiring conductor 325, 335, 345, 355, 365. That part of the first wiring conductor 325, 335, 345, 355, 365 which penetrates through the base body 323, 333, 343, 353, 363 should preferably be Φ50 μm or above in diameter.

The second wiring conductor 21 has its one end disposed around the opening of the second fluid channel 19 facing the second electrode 15 of the membrane electrode assembly 13 on the lower surface of the lid body 17, or equivalently disposed over the entire area of the surface with which the second electrode 15 of the membrane electrode assembly 13 makes contact, and its other end led out toward the outer surface (i.e. upper surface in the example of FIG. 45) of the lid body 17. With this arrangement, the second wiring conductor 21 can be in immediate contact with the entire area of the principal surface of the second electrode 15 of the membrane electrode assembly 13, with the exception of the area facing with the opening of the second fluid channel 19. This makes it possible to increase the contact area between the second electrode 15 of the membrane electrode assembly 13 and the second wiring conductor 21. As a result, an increase in electrical resistance and occurrence of improper contact can be effectively prevented, thus achieving a fuel cell that succeeds in providing high electricity-production efficiency.

It is preferable that, like the first wiring conductor 325, 335, 345, 355, 365, the second wiring conductor 21 is formed integrally with the lid body 17 and is made 10 μm or above higher than the bottom surface of the concavity of the lid body 17. This allows the second wiring conductor 21 to make contact with the second electrode 15 with ease. The desired height of the second wiring conductor 21 can be achieved by adjusting the printing condition such that the conductor paste is print-coated in a larger thickness during the print-coating process as described above. Further, the second wiring conductor 21 may be arranged in plural face to face with the second electrode 15. This helps reduce electric loss in the second wiring conductor 21. That part of the second wiring conductor 21 which penetrates through the lid body 17 should preferably be Φ50 μm or above in diameter.

It is preferable that the first wiring conductor 325, 335, 345, 355, 365 and the second wiring conductor 21 each have its exposed surface coated with a highly-conductive metal material such as nickel which is highly corrosion-resistant and exhibits excellent wettability with respect to a brazing filler material, using the plating method. This makes it possible to establish satisfactory electrical connection between the first wiring conductor 325, 335, 345, 355, 365 and the second wiring conductor 21, as well as between the first wiring conductor 325, 335, 345, 355, 365, the second wiring conductor 21 and an external electric circuit.

The first and second wiring conductors 325, 335, 345, 355, 365, 21 can be electrically connected to the first and second electrodes 14 and 15, respectively, by grippingly inserting the membrane electrode assembly 13 between the base body 323, 333, 343, 353, 363 and the lid body 17. By so doing, the first and second wiring conductors 325, 335, 345, 355, 365, 21 are brought into pressure-contact with the first and second electrodes 14 and 15, respectively.

Arranged on the concavity bottom surface of the base body 323, 333, 343, 353, 363 facing the first electrode 14 and on the lower surface of the lid body 17 facing the second electrode 15 are the first fluid channel 324, 334, 344, 354, 364 and the second fluid channel 19, respectively. The first fluid channel 324, 334, 344, 354, 364 is so formed as to extend toward the outer surface of the base body 323, 333, 343, 353, 363, whereas the second fluid channel 19 is so formed as to extend toward the outer surface of the lid body 17. The first and second fluid channels 324, 334, 344, 354, 364, 19 are constituted by the through holes pierced in the base body 323, 333, 343, 353, 363 and the lid body 17, or grooves. The first and second fluid channels 324, 334, 344, 354, 364, 19 each serve as a passage for a fluid to be supplied to the membrane electrode assembly 13, such as fuel gas for example hydrogen-rich reforming gas or oxidant gas for example air, and besides serves as a passage for a fluid to be discharged from the membrane electrode assembly 13 after reactions, such as water produced through reactions.

In the fuel cell casing 322 and the fuel cell 321 embodying the invention, at least one of the first and second fluid channels 324, 19 is composed of the opening portion 326, the coupling portion 327, the fluid introducing portion 328, and the fluid discharge portion 329. The opening portion 326 includes a plurality of equally-spaced groove-like openings that are identical in length and width, and is arranged on the bottom surface of the concavity of the base body 323 or the lower surface of the lid body 17 face to face with the lower or upper principal surface of the membrane electrode assembly 13. The coupling portion 327 serves to couple together one ends, as well as the other ends, of a plurality of openings formed within the base body 323 or the lid body 17. The fluid introducing portion 328 is so formed as to extend from one side of the coupling portion 327 to the outer surface of the base body 323 or the lid body 17. The fluid discharge portion 329 is so formed as to extend from the other side of the coupling portion to the outer surface of the base body 323 or the lid body 17. Regarding a through hole or a groove which is pierced in the base body 323 and the lid body 17, the diameter and number of the through hole, or the width, depth, and arrangement of the groove-like opening are determined according to the specifications of the fuel cell 321 in such a way that a fluid such as fuel gas or oxidant gas can be evenly supplied to the membrane electrode assembly 13.

When part of a fluid is diverted from the coupling portion 327 into the opening portion 326, in the groove-like opening of the opening portion 326 located on the side of the introducing portion 328 and the discharge portion 329, the fluid flows thereinto at higher speed, whereas in the opening of the opening portion 326 located away from the introducing portion 328 and the discharge portion 329, the fluid flows thereinto at lower speed. Therefore, the fluid resistance as observed in the opening portion 326 needs to be reduced. To achieve this, it is important to increase the number of the openings in the opening portion 326. To enhance the uniform suppliability of the fluid to be supplied to the membrane electrode assembly 13, for example, the opening should preferably have a width of 1 mm and a depth of 0.2 mm. Further enhancement of the uniform suppliability of the fluid can be achieved by reducing the opening width to 100 μm and by increasing the number of the openings.

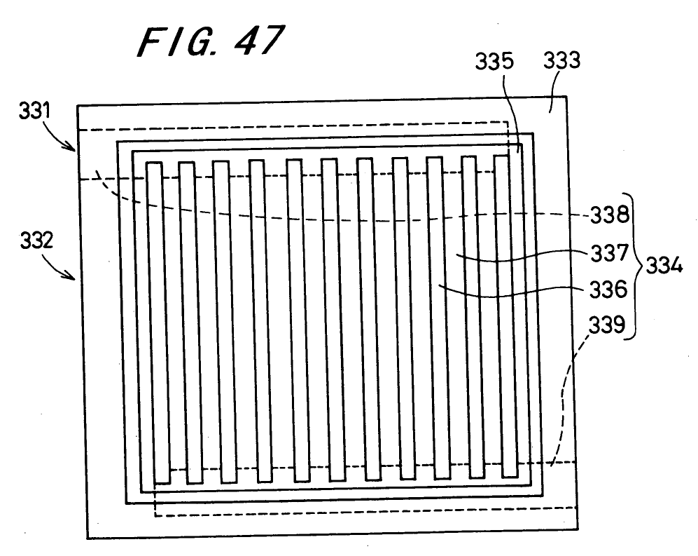

In the fuel cell casing 332 and the fuel cell 331 of the invention shown in FIG. 47, it is important to reduce the fluid resistance as observed in a plurality of groove-like openings constituting the opening portion 336 and in the coupling portion 337 for connecting the openings together. To enhance the uniform suppliability of the fluid to be supplied to the membrane electrode assembly 13, the coupling portion 337 is made larger in fluid-path cross-sectional area than the opening portion 336. This helps minimize the fluid resistance of the coupling portion 337 across the openings to a negligible level with respect to the fluid resistance of the opening, and consequently it never occurs that only the opening located on the side of the introducing portion 338 and the discharge portion 339 receives a larger amount of fluid. As a result, the fluid is uniformly supplied to the individual groove-like openings of the opening portion 336. To achieve this, for example, the coupling portion 337 should preferably have a width of 4 mm and a depth of 0.5 mm or above to obtain an appropriate fluid-path cross-sectional area with respect to the opening having a width of 1 mm and a depth of 0.2 mm. In this case, since the fluid resistance of the opening is derived from an expression: length/(width×depth), the fluid-resistance ratio between the opening and the coupling portion 337 across the openings is given as: 20/(1×0.2):2/(4×0.5) up to greater than 100:1. Thus, the fluid resistance of the coupling portion 337 across the openings is made smaller relative to that of the opening, and thereby the fluid is uniformly supplied to the individual groove-like openings of the opening portion 336. Note that the width and depth of the coupling portion 337 should be so determined as to obtain a larger fluid-path cross-sectional area in consideration of the need for compactness and lower profile in the fuel cell casing 332.

In the fuel cell casing 342, 352, 362 and the fuel cell 341, 351, 361 of the invention, it is important to change the width and depth of the groove-like opening of the opening portion 346, 356, 366 according to the arrangement of the introducing portion 348, 358, 368 and the discharge portion 349, 359, 369. It is preferable that the groove-like opening located on the side of the introducing portion 348, 358, 368 and the discharge portion 349, 359, 369 has a narrower opening width to increase the fluid resistance, and that the opening located away from the introducing portion 348, 358, 368 and the discharge portion 349, 359, 369 has a wider opening width to decrease the fluid resistance. By properly adjusting the fluid-path cross-sectional areas of the individual openings successively in accordance with the number of the groove-like openings of the opening portion 346, 356, 366, and the fluid-path cross-sectional areas and lengths of the opening portion 346, 356, 366 and the coupling portion 347, 357, 367, it is possible to attain uniform suppliability for the fluid to be supplied to the opening portion 346, 356, 366. Hence, chemical reactions can be stabilized in the membrane electrode assembly 13 without being unequal depending on positions, and the temperature distribution within the fuel cell casing 342, 352, 362 can accordingly be made uniform. As a result, thermal stress occurring in the membrane electrode assembly 13 can be suppressed, leading to enhancement of the reliability of the fuel cell 341, 351, 361.

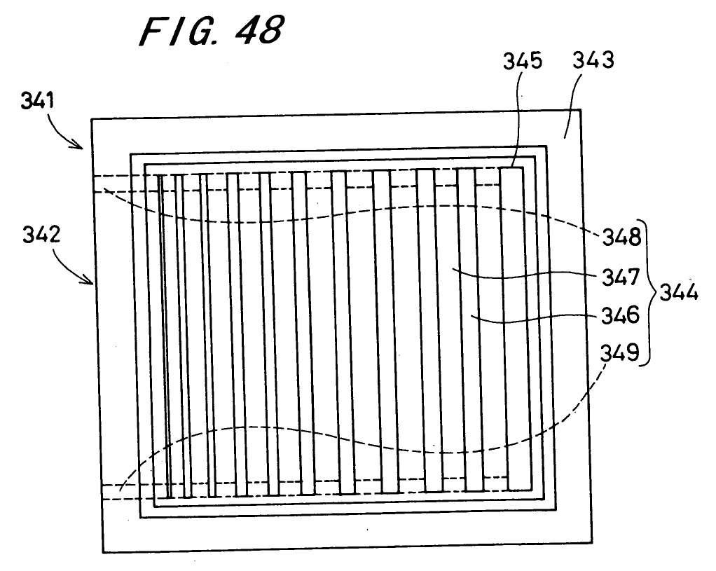

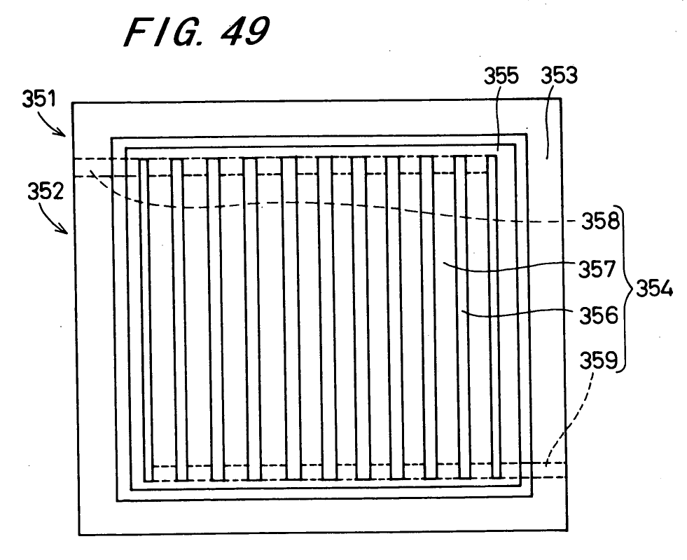

That is, in the fuel cell casing 342 and the fuel cell 341 of the invention shown in FIG. 48, both the introducing portion 348 and the discharge portion 349 are disposed at one end of the array of a plurality of openings of the opening portion 346, and the openings are arranged in order of increasing fluid-path cross-sectional area from the one end at which the introducing portion 348 and the discharge portion 349 are disposed to the other end of the array. With this arrangement, the openings closer to the one end of the array, at which the introducing portion 348 and the discharge portion 349 are disposed, have greater fluid resistance, whereas the openings closer to the other end of the array have smaller fluid resistance. Thus, it never occurs that only the opening located on the side of the introducing portion 348 and the discharge portion 349 receives a larger amount of fluid. As a result, the fluid is uniformly supplied to the individual groove-like openings of the opening portion 346.

In the fuel cell casing 352 and the fuel cell 351 of the invention shown in FIG. 49, the introducing portion 358 is disposed at one end of the array of a plurality of openings of the opening portion 356, whereas the discharge portion 359 is disposed at the other end of the array, and the openings are arranged in order of increasing fluid-path cross-sectional area from each end to the center of the array in the opening portion 356. With this arrangement, in the opening portion 356, the openings closer to each end of the array have greater fluid resistance, whereas the openings closer to the center of the array have smaller fluid resistance. Thus, it never occurs that only the opening located on the side of the introducing portion 358 and the discharge portion 359 receives a larger amount of fluid. As a result, the fluid is uniformly supplied to the individual groove-like openings of the opening portion 356.

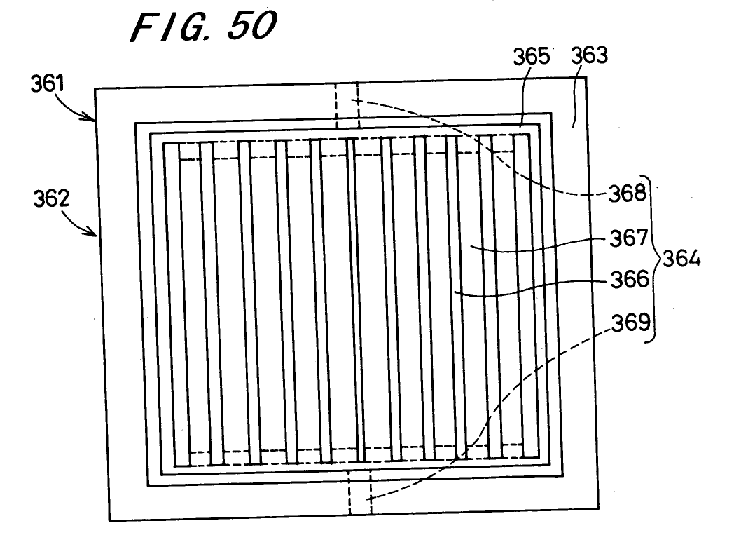

In the fuel cell casing 362 and the fuel cell 361 of the invention shown in FIG. 50, both the introducing portion 368 and the discharge portion 369 are disposed at the center of the array of a plurality of openings of the opening portion 366, and the openings are arranged in order of increasing fluid-path cross-sectional area from the center to each end of the array in the opening portion 366. With this arrangement, in the opening portion 366, the openings closer to the center of the array have greater fluid resistance, whereas the openings closer to each end of the array have smaller fluid resistance. Thus, it never occurs that only the opening located on the side of the introducing portion 368 and the discharge portion 369 receives a larger amount of fluid. As a result, the fluid is uniformly supplied to the individual groove-like openings of the opening portion 366.

According to the fuel cell casing 322, 332, 342, 352, 362 and the fuel cell 321, 331, 341, 351, 361 of the invention, the first fluid channel 324, 334, 344, 354, 364 is disposed face to face with the lower principal surface of the membrane electrode assembly 13 having the first electrode 14, whereas the second fluid channel 19 is disposed face to face with the upper principal surface of the membrane electrode assembly 13 having the second electrode 15. With this arrangement, a fluid can be exchanged between the lower and upper principal surfaces of the membrane electrode assembly 13 and their corresponding first fluid channel 324, 334, 344, 354, 364 and the second fluid channel 19, and thus the fluid can be supplied and discharged through the respective fluid path. Moreover, for example, in the case of supplying gas as a fluid, it is possible to prevent a decrease in the partial pressure of the gas supplied to the first and second electrodes 14 and 15 of the membrane electrode assembly 13, and thus obtain a predetermined stable output voltage. Further, since the partial pressure of the supplied gas is stabilized, the inner pressure within the fuel cell 321, 331, 341, 351, 361 is made uniform. As a result, thermal stress occurring in the membrane electrode assembly 13 can be suppressed, leading to enhancement of the reliability of the fuel cell 321, 331, 341, 351, 361.

With the construction thus far described, it is possible to provide the compact and sturdy fuel cell casing 322, 332, 342, 352, 362 capable of housing the membrane electrode assembly 13 and the fuel cell 321, 331, 341, 351, 361 that allows highly-efficient control according to the invention as shown in FIGS. 45 to 50.

It should be noted that the invention need not be limited to the above-described embodiments and examples, and therefore various changes and modifications are possible without departing from the spirit or scope of the invention. For example, the first and second fluid channels may alternatively be constructed by forming an inlet on the side surface of the base body or the lid body. In this case, the fuel cell is slenderized as a whole, and the down-sized fuel cell can be effectively adopted in a portable electronic device. Moreover, the other ends of the first and second wiring conductors may be led out toward one common side surfaces of the base body and the lid body, respectively, instead of being led out toward the outer surfaces thereof. In this case, the wiring lines and the ducts can be put together only on one side of the fuel cell. This helps facilitate miniaturization and protection of the externally-connected portions. Thus, the fuel cell can be designed with high reliability, and operated with stability for a longer period of time.

In the embodiments thus far described, the first wiring conductor 325, 335, 345, 355, 365 and the second wiring conductor 21 are formed on the entire bottom surface of the concavity around the opening of the first fluid channel 324, 334, 344, 354, 364 and on the entire lower surface of the lid body 17 around the opening of the second fluid channel 19, respectively, so as to abut against the first and second electrodes 14 and 15, respectively. This is because, such an arrangement makes it possible to increase the contact area between the first electrode 14 of the membrane electrode assembly 13 and the first wiring conductor 325, 335, 345, 355, 365, as well as the contact area between the second electrode 15 and the second wiring conductor 21, and also to reduce electrical resistance. Note that, to achieve further increase in the amount of fluid to be supplied to the membrane electrode assembly 13 to increase the amount of electricity production, the openings on a side of the membrane electrode assembly 13 in the first fluid channel 324, 334, 344, 354, 364 and the second fluid channel 19 may be made of a porous member.

Moreover, a plurality of membrane electrode assemblys are housed within the concavity of the base body, and these membrane electrode assemblys may be electrically connected to one another by the first and second wiring conductors. In this case, high-voltage or high-current output can be obtained, taken altogether.

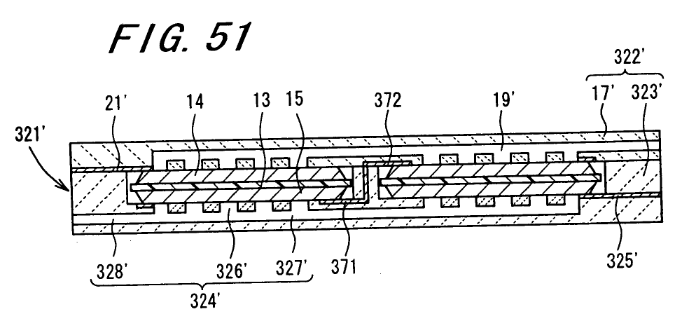

FIG. 51 is a sectional view showing a fuel cell casing and a fuel cell employing the same according to still another embodiment of the invention. As seen from FIG. 51, in this embodiment, the membrane electrode assembly 13 is housed in each concavity of the base body 323′ having a plurality of concavities. Moreover, a third wiring conductor 371 is so disposed as to extend across the region between the adjacent concavities, and a fourth wiring conductor 372 is disposed in the lid body 17′. The third and fourth wiring conductors are electrically connected to each other. Thereby, in a plurality of membrane electrode assemblys 13, their respective first electrodes 14, as well as their first and second electrodes 14 and 15, are electrically connected with one another. To obtain the overall output through the endmost membrane electrode assemblys 13 connected in series with each other by the third and fourth wiring conductors 371 and 372, the first and second wiring conductors 325′ and 21′ are each electrically connected thereto. In this case, since the first to fourth wiring conductors 325′, 21′, 371, and 372 allow free three-dimensional wiring, a plurality of membrane electrode assemblys 13 can be arbitrarily connected in series, or parallel (although not shown), with one another. This makes it possible to efficiently adjust the entire output voltage and output current. Thus, there are realized the fuel cell casing 322′ and the fuel cell 321′ with which electricity electrochemically produced in the membrane electrode assemblys 13 can be externally extracted satisfactorily. The construction shown in FIG. 51 may be applied to the fuel cell casings and the fuel cells employing the same of the invention shown in FIGS. 47 to 50. Note that, in FIG. 51, the components that play the same or corresponding roles as in FIG. 45 will be identified with the same reference symbols. Specifically, reference numeral 321′ denotes a fuel cell; reference numeral 322′ denotes a fuel cell casing; reference numeral 13 denotes a membrane electrode assembly; reference numeral 14 denotes a first electrode; reference numeral 15 denotes a second electrode; reference numeral 323′ denotes a base body; reference numeral 17′ denotes a lid body; reference numeral 324′ denotes a first fluid channel; reference numeral 19′ denotes a second fluid channel; reference numeral 325′ denotes a first wiring conductor; reference numeral 21′ denotes a second wiring conductor; reference numeral 326′ denotes an opening portion; reference numeral 327′ denotes a coupling portion; reference numeral 328′ denotes an introducing portion; reference numeral 329′ denotes a discharge portion; reference numeral 371 denotes a third wiring conductor; and reference numeral 372 denotes a fourth wiring conductor.

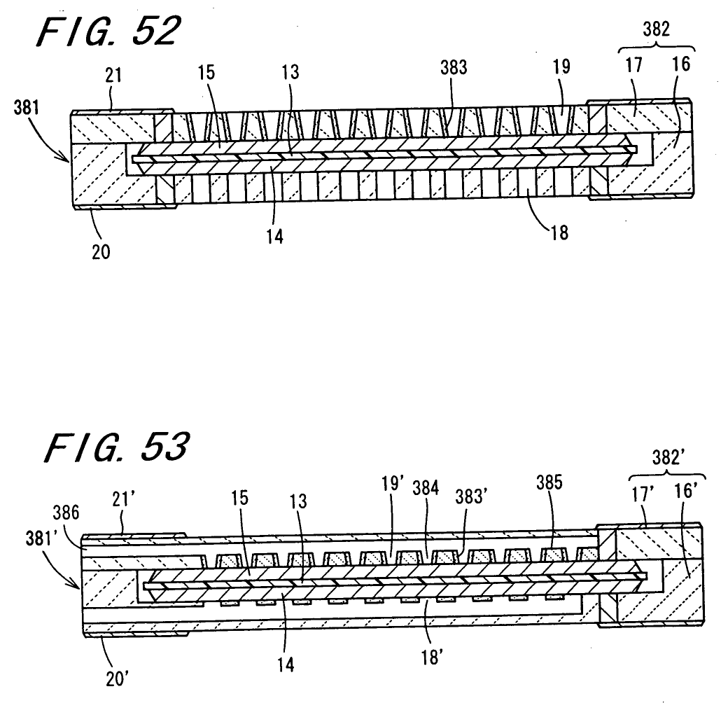

FIG. 52 is a sectional view showing a fuel cell casing and a fuel cell employing the same according to still another embodiment of the invention. In this embodiment, the same components as those of the aforementioned embodiment will be denoted by the same reference numerals, and it will be omitted to describe in detail. In FIG. 52, reference numeral 381 denotes a fuel cell; reference numeral 382 denotes a fuel cell casing; reference numeral 13 denotes a membrane electrode assembly; reference numeral 14 denotes a first electrode; reference numeral 15 denotes a second electrode; reference numeral 16 denotes a base body; reference numeral 17 denotes a lid body; reference numeral 18 denotes a first fluid channel; reference numeral 19 denotes a second fluid channel; reference numeral 20 denotes a first wiring conductor; reference numeral 21 denotes a second wiring conductor; and reference numeral 383 denotes an opening configuration.

It is preferable that the base body 16 and the lid body 17 are made of sintered aluminum oxide of a close-packed substance whose relative density is 95% or more, for example. In this case, for example, firstly, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser or the like, through holes as the first fluid channels 18 and the second fluid channels 19 and through holes for disposing the first connection conductors 20 and the second connection conductors 21 are formed on the green sheet.

At this time, at least one of the first and second fluid channels 18 and 19 is formed in the ceramic green sheet so as to broaden gradually from one principal surface to the other principal surface of the ceramic green sheet at an angle θ from 35 to 70 degrees. Thereby, at least one of the first and second fluid channels 18 and 19 has the opening configuration 383 which is so shaped that its cross-sectional area becomes smaller gradually toward the membrane electrode assembly 13.

Such an opening configuration 383 is realized by a stamping process using a mold. Specifically, a clearance is created so that a through hole of a die is made larger in diameter than a punch (rod-shaped stamping mold) in a stamping die. This makes it possible to form a through hole in which an outlet end is larger than an inlet end during stamping. For example, if the ceramic green sheet has a thickness of approximately 0.5 mm, the clearance between the outer surface of the stamping pin and the inner surface of the through hole of the die is kept in a range from 0.2 to 0.5 mm. Thereby, the angle θ can be kept in a range from 35 to 70 degrees. If the angle θ is less than 35 degrees, the inner wall of the duct cannot be efficiently formed with stability.

In the invention, at least one of the first and second fluid channels 18 and 19 is preferably so shaped that its cross-sectional area becomes smaller gradually toward the membrane electrode assembly 13. This facilitates evaporation of water vapor or water produced through an electrochemical reaction in the membrane electrode assembly 13, resulting in an advantage in preventing a blockage from occurring in the first and second fluid channels 18 and 19 acting as fluid paths for air. Thus, the electrode surfaces of the first and second electrodes 14 and 15 can be prevented from being covered by water (H₂O), and air acting as oxidant gas, obtained from atmosphere, can be effectively supplied through the first and second fluid channels 18 and 19. Thereby, electrochemical reactions can be facilitated in the membrane electrode assembly 13, making highly-efficient electricity production possible. Further, the contact area between the first and second electrode 14, 15 and the base body 16 or the lid body 17 can be increased, leading to a decrease in electrical resistance.

In the invention, at least one of the first and second fluid channels 18 and 19 preferably has its inner wall covered with a hygroscopic member. Since water vapor or water produced through an electrochemical reaction in the membrane electrode assembly 13 is absorbed and removed by the hygroscopic member, a blockage can be prevented from occurring in the first and second fluid channels 18 and 19 acting as fluid paths for air. Thus, the electrode surfaces of the first and second electrodes 14 and 15 can be prevented from being covered by water (H₂O), and air acting as oxidant gas, obtained from atmosphere, can be effectively supplied through the first and second fluid channels 18 and 19. Thereby, electrochemical reactions can be facilitated in the membrane electrode assembly 13, making highly-efficient electricity production possible.

As the hygroscopic member, a highly water (H₂O)-absorbent material is preferably used. The examples thereof include: silica gel; alumina; clay; activated carbon; paper; and wood powder. Powder of inorganic substance such as silica gel, alumina, or clay is particularly desirable in terms of attaining a desired moisture-absorption property. This is because the water (H₂O)-absorbing area can be readily controlled by adjusting the size of the powder particle by pulverization or the like process.

In the case of applying such a hygroscopic member to the inner wall of the first and second fluid channels 18 and 19, all of the first and second fluid channels 18 and 19 should preferably be subjected to application of the hygroscopic member. This makes it possible to maintain uniformity in the flow of the air, as oxidant gas obtained from atmosphere through the first and second fluid channels 18 and 19. Moreover, the thickness of the hygroscopic member should preferably be adjusted to be 10% or below with respect to the opening area in a transverse section of the first, second fluid channel 18, 19. This is because the influence of loss pressure needs to be minimized at the time of supplying air as oxidant gas.

To facilitate evaporation of water from the hygroscopic member by the action of air flow, it is preferable that the first and second fluid channels 18 and 19 have their inner walls fully covered with the hygroscopic member. By so doing, in a case where the fuel cell casing 382 and the fuel cell 381 of the invention is applied to a compact cell system such as a portable DMFC (Direct Methanol Fuel Cell), for example, the cell system can be operated for dozens of hours only with 10 ml of methanol. Regarding the amount of water production, only 1 ml of water (H₂O) is produced per consumption of 1 g methanol. That is, the water (H₂O) absorbed by the hygroscopic member is so small in quantity that it evaporates sufficiently by wind generated by a fan. Thus, the water production does not have any serious effect on continuous operation at all.

With the construction thus far described, it is possible to provide the compact and sturdy fuel cell casing 382 capable of housing the membrane electrode assembly 13 and the fuel cell 381 that allows highly-efficient control according to the invention as shown in FIG. 52.

It should be noted that the invention need not be limited to the above-described embodiments and examples, and therefore various changes and modifications are possible without departing from the spirit or scope of the invention. For example, the first and second fluid channels may alternatively be constructed by forming an inlet on the side surface of the base body or the lid body. In this case, the fuel cell is slenderized as a whole, and the down-sized fuel cell can be effectively adopted in a portable electronic device. Moreover, the other ends of the first and second wiring conductors may be led out toward one common side surfaces of the base body and the lid body, respectively, instead of being led out toward the outer surfaces thereof. In this case, the wiring lines and the ducts can be put together only on one side of the fuel cell. This helps facilitate miniaturization and protection of the externally-connected portions. Thus, the fuel cell can be designed with high reliability, and operated with stability for a longer period of time.

Further, a plurality of membrane electrode assemblys are housed within the concavity of the base body, and these membrane electrode assemblys may be electrically connected to one another by the first and second wiring conductors. In this case, high-voltage or high-current output can be obtained, taken altogether.

FIG. 53 is a sectional view showing a fuel cell casing and a fuel cell employing the same according to still another embodiment of the invention. As seen from FIG. 53, in this embodiment, the membrane electrode assembly 13 is housed in each concavity of the base body 16′ having some concavities. At least one of the first and second fluid channels 18′ and 19′ is provided with an opening portion 384; a coupling portion 385; a fluid introducing portion 386; and a discharge portion (not shown). The opening portion 384 is composed of a plurality of equally-spaced groove-like openings that are identical in length and width. The opening portion is arranged on the bottom surface of the concavity face to face with the lower and upper principal surfaces of the membrane electrode assembly 13. The coupling portion 385 serves to couple together one ends, as well as the other ends, of a plurality of openings. The fluid introducing portion 386 is so formed as to extend from one and the other side of the coupling portion 385 to the outer surface. The first and second electrodes 14 and 15 are electrically connected to the first wiring conductor 20′ and the second wiring conductor 21′, respectively. In this case, a fluid can be readily supplied to the opening portion 384 taking on the form of a plurality of grooves, by the fluid introducing portion 386 and the coupling portion 385. A plurality of groove-like openings constituting the opening portion 384 are identical in length and width, and are equally spaced. Thus, even if a fluid flows at high speed, since the distance between the introducing portion 386 and the discharge portion is short, the resistance as observed in the fluid path is decreased. As a result, the uniform suppliability of the fluid to be supplied to the membrane electrode assembly 13 can be enhanced, and the water (H₂O) produced through chemical reaction can be continuously dried and removed when the air supplied as oxidant gas from atmosphere enters and leave the opening configuration 383. Moreover, since the first and second wiring conductors 20′ and 21′ allow free three-dimensional wiring, a plurality of membrane electrode assemblys 13 can be arbitrarily connected in series or parallel to one another. This makes it possible to efficiently adjust the output voltage and output current as a whole. Thus, there are realized the fuel cell casing 382′ and the fuel cell 381′ with which electricity electrochemically produced in the membrane electrode assemblys 13 can be externally extracted satisfactorily.

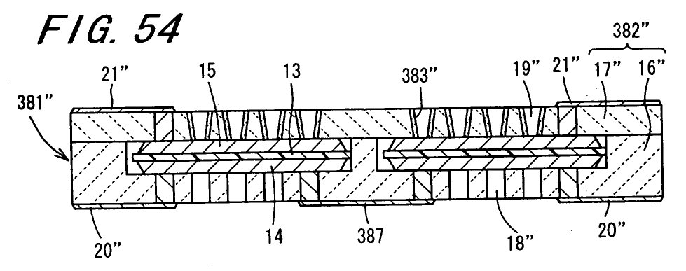

FIG. 54 is a sectional view showing a fuel cell casing and a fuel cell employing the same according to still another embodiment of the invention. As seen from FIG. 54, in this embodiment, the membrane electrode assembly 13 is housed in each concavity of the base body 16″ having a plurality of concavities. Moreover, a third wiring conductor 387 is so disposed as to extend across the region between the adjacent concavities. Thus, in a plurality of membrane electrode assemblys 13, their respective first electrodes 14, as well as their first and second electrodes 14 and 15, are electrically connected with one another. To obtain the overall output through the endmost membrane electrode assemblys 13, the first and second wiring conductors 20″ and 21″ are each electrically connected thereto. In this case, since the first to third wiring conductors 20″, 21″, and 387 allow free three-dimensional wiring, a plurality of membrane electrode assemblys 13 can be arbitrarily connected in series or parallel to one another. This makes it possible to efficiently adjust the entire output voltage and output current. Thus, there are realized the fuel cell casing 382″ and the fuel cell 381″ with which electricity electrochemically produced in the membrane electrode assemblys 13 can be externally extracted satisfactorily.

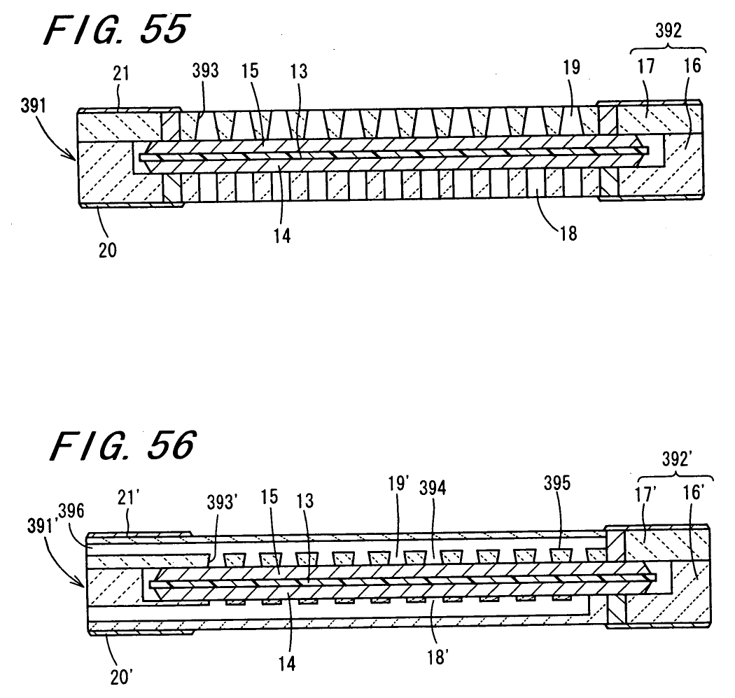

FIG. 55 is a sectional view showing a fuel cell casing and a fuel cell employing the same according to still another embodiment of the invention. In this embodiment, the same components as those of the aforementioned embodiment will be denoted by the same reference numerals, and it will be omitted to describe in detail. In FIG. 55, reference numeral 391 denotes a fuel cell; reference numeral 392 denotes a fuel cell casing; reference numeral 13 denotes a membrane electrode assembly; reference numeral 14 denotes a first electrode; reference numeral 15 denotes a second electrode; reference numeral 16 denotes a base body; reference numeral 17 denotes a lid body; reference numeral 18 denotes a first fluid channel; reference numeral 19 denotes a second fluid channel; reference numeral 20 denotes a first wiring conductor; reference numeral 21 denotes a second wiring conductor; and reference numeral 393 denotes an opening configuration.

The constitution of a fuel cell 391 shown in FIG. 55 is similar to that of the fuel cell 381 shown in FIG. 52. Note that, at least one of the first fluid channels 18 and the second fluid channels 19 is so configured that an opening at its membrane electrode assembly 13 side end is made larger in width than an opening at its other opposite end. In addition, the fuel cell casing 392 comprises the base body 16 and the lid body 17.

It is preferable that the base body 16 and the lid body 17 are made of sintered aluminum oxide of a close-packed substance whose relative density is 95% or more, for example. In this case, for example, firstly, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser or the like, through holes as the first fluid channels 18 and the second fluid channels 19 and through holes for disposing the first connection conductors 20 and the second connection conductors 21 are formed on the green sheet.

At this time, at least one of the first and second fluid channels 18 and 19 is formed in the ceramic green sheet so as to narrow gradually from one principal surface to the other principal surface of the ceramic green sheet at an angle θ from 35 to 70 degrees. Thereby, at least one of the first and second fluid channels 18 and 19 has the opening configuration 393 which is so shaped that its cross-sectional area becomes larger gradually toward the membrane electrode assembly 13.

In the invention, at least one of the first and second fluid channels 18 and 19 is preferably so shaped that its cross-sectional area becomes larger gradually toward the membrane electrode assembly 13. With this construction, since an area of a contact portion between the first wiring conductor 20 and the first electrode 14 and an area of a contact portion between the second wiring conductor 21 and the second electrode 15 become small, when the base body 16 and the lid body 17 is brought into pressure-contact with the membrane electrode assembly 13, it is possible to make larger a load per unit area applied to the contact portion between the first wiring conductor 20 and the first electrode 14 and the contact portion between the second wiring conductor 21 and the second electrode 15, leading to enhancement of the reliability of the connection. As a result, even if a load applied to the base body 16 and the lid body 17 is made small, it is possible to effectively prevent the occurrence of crack or fracture in the base body 16 and the lid body 17.

In addition, since an area where the air and the fuel gas are contacted with the first and second electrodes 14 and 15 can be made larger, electrochemical reactions can be facilitated, which makes highly-efficient electricity production possible.

In the invention, at least one of the first and second fluid channels 18 and 19 preferably has its inner wall covered with a hygroscopic member. Since water vapor or water produced through an electrochemical reaction in the membrane electrode assembly 13 is absorbed and removed by the hygroscopic member, a blockage can be prevented from occurring in the first and second fluid channels 18 and 19 acting as fluid paths for air. Thus, the electrode surfaces of the first and second electrodes 14 and 15 can be prevented from being covered by water (H₂O), and air acting as oxidant gas, obtained from atmosphere, can be effectively supplied through the first and second fluid channels 18 and 19. Thereby, electrochemical reactions can be facilitated in the membrane electrode assembly 13, making highly-efficient electricity production possible.

As the hygroscopic member, a highly water (H₂O)-absorbent material is preferably used. The examples thereof include: silica gel; alumina; clay; activated carbon; paper; and wood powder. Powder of inorganic substance such as silica gel, alumina, or clay is particularly desirable in terms of attaining a desired moisture-absorption property. This is because the water (H₂O)-absorbing area can be readily controlled by adjusting the size of the powder particle by pulverization or the like process.

In the case of applying such a hygroscopic member to the inner wall of the first and second fluid channels 18 and 19, all of the first and second fluid channels 18 and 19 should preferably be subjected to application of the hygroscopic member. This makes it possible to maintain uniformity in the flow of the air, as oxidant gas obtained from atmosphere through the first and second fluid channels 18 and 19. Moreover, the thickness of the hygroscopic member should preferably be adjusted to be 10% or below with respect to the opening area in a transverse section of the first, second fluid channel 18, 19. This is because the influence of loss pressure needs to be minimized at the time of supplying air as oxidant gas.

To facilitate evaporation of water from the hygroscopic member by the action of air flow, it is preferable that the first and second fluid channels 18 and 19 have their inner walls fully covered with the hygroscopic member. By so doing, in a case where the fuel cell casing 392 and the fuel cell 391 of the invention is applied to a compact cell system such as a portable DMFC (Direct Methanol Fuel Cell), for example, the cell system can be operated for dozens of hours only with 10 ml of methanol. Regarding the amount of water production, only 1 ml of water (H₂O) is produced per consumption of 1 g methanol. That is, the water (H₂O) absorbed by the hygroscopic member is so small in quantity that it evaporates sufficiently by wind generated by a fan. Thus, the water production does not have any serious effect on continuous operation at all.

With the construction thus far described, it is possible to provide the compact and sturdy fuel cell casing 392 capable of housing the membrane electrode assembly 13 and the fuel cell 391 that allows highly-efficient control according to the invention as shown in FIG. 55.

It should be noted that the invention need not be limited to the above-described embodiments and examples, and therefore various changes and modifications are possible without departing from the spirit or scope of the invention. For example, the first and second fluid channels may alternatively be constructed by forming an inlet on the side surface of the base body or the lid body. In this case, the fuel cell is slenderized as a whole, and the down-sized fuel cell can be effectively adopted in a portable electronic device. Moreover, the other ends of the first and second wiring conductors may be led out toward one common side surfaces of the base body and the lid body, respectively, instead of being led out toward the outer surfaces thereof. In this case, the wiring lines and the ducts can be put together only on one side of the fuel cell. This helps facilitate miniaturization and protection of the externally-connected portions. Thus, the fuel cell can be designed with high reliability, and operated with stability for a longer period of time.

Further, a plurality of membrane electrode assemblys are housed within the concavity of the base body, and these membrane electrode assemblys may be electrically connected to one another by the first and second wiring conductors. In this case, high-voltage or high-current output can be obtained, taken altogether.

FIG. 56 is a sectional view showing a fuel cell casing and a fuel cell employing the same according to still another embodiment of the invention. As seen from FIG. 56, in this embodiment, the membrane electrode assembly 13 is housed in each concavity of the base body 16′ having some concavities. At least one of the first and second fluid channels 18′ and 19′ is provided with an opening portion 394; a coupling portion 395; a fluid introducing portion 396; and a discharge portion (not shown). The opening portion 394 is composed of a plurality of equally-spaced groove-like openings that are identical in length and width. The opening portion is arranged on the bottom surface of the concavity face to face with the lower and upper principal surfaces of the membrane electrode assembly 13. The coupling portion 395 serves to couple together one ends, as well as the other ends, of a plurality of openings. The fluid introducing portion 396 is so formed as to extend from one and the other side of the coupling portion 395 to the outer surface. The first and second electrodes 14 and 15 are electrically connected to the first wiring conductor 20′ and the second wiring conductor 21′, respectively. In this case, a fluid can be readily supplied to the opening portion 394 taking on the form of a plurality of grooves, by the fluid introducing portion 396 and the coupling portion 395. A plurality of groove-like openings constituting the opening portion 394 are identical in length and width, and are equally spaced. Thus, even if a fluid flows at high speed, since the distance between the introducing portion 396 and the discharge portion is short, the resistance as observed in the fluid path is decreased. As a result, the uniform suppliability of the fluid to be supplied to the membrane electrode assembly 13 can be enhanced, and the water (H₂O) produced through chemical reaction can be continuously dried and removed when the air supplied as oxidant gas from atmosphere enters and leave the opening configuration 393. Moreover, since the first and second wiring conductors 20′ and 21′ allow free three-dimensional wiring, a plurality of membrane electrode assemblys 13 can be arbitrarily connected in series or parallel to one another. This makes it possible to efficiently adjust the output voltage and output current as a whole. Thus, there are realized the fuel cell casing 392′ and the fuel cell 391′ with which electricity electrochemically produced in the membrane electrode assemblys 13 can be externally extracted satisfactorily.

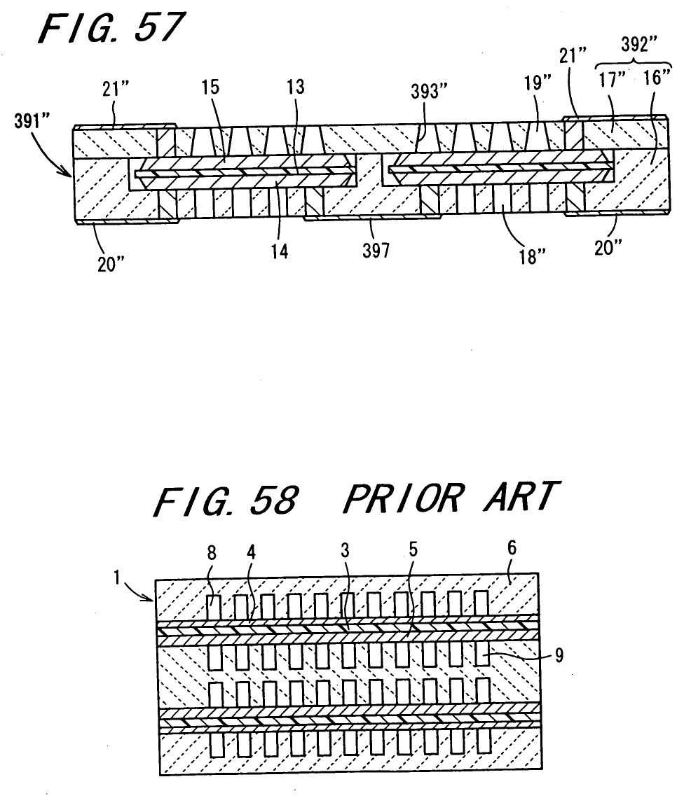

FIG. 57 is a sectional view showing a fuel cell casing and a fuel cell employing the same according to still another embodiment of the invention. As seen from FIG. 57, in this embodiment, the membrane electrode assembly 13 is housed in each concavity of the base body 16″ having a plurality of concavities. Moreover, a third wiring conductor 397 is so disposed as to extend across the region between the adjacent concavities. Thus, in a plurality of membrane electrode assemblys 13, their respective first electrodes 14, as well as their first and second electrodes 14 and 15, are electrically connected with one another. To obtain the overall output through the endmost membrane electrode assemblys 13, the first and second wiring conductors 20″ and 21″ are each electrically connected thereto. In this case, since the first to third wiring conductors 20″, 21″, and 397 allow free three-dimensional wiring, a plurality of membrane electrode assemblys 13 can be arbitrarily connected in series or parallel to one another. This makes it possible to efficiently adjust the entire output voltage and output current. Thus, there are realized the fuel cell casing 392″ and the fuel cell 391″ with which electricity electrochemically produced in the membrane electrode assemblys 13 can be externally extracted satisfactorily.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A fuel cell casing comprising:
a base body made of ceramics having a concavity for housing a membrane electrode assembly formed on one surface thereof, the membrane electrode assembly having a first electrode and a second electrode disposed on one principal surface and another principal surface thereof, respectively;
a first fluid channel formed so as to extend from a bottom surface of the concavity facing the one principal surface of the membrane electrode assembly to an outer surface of the base body; a first wiring conductor having its one end disposed on the bottom surface of the concavity facing the first electrode of the membrane electrode assembly, and its other end led out toward the outer surface of the base body;
a lid body mounted on the one surface of the base body near the concavity so as to cover the concavity, for air-tightly sealing the concavity;
a second fluid channel formed so as to extend from one surface of the lid body facing the the other principal surface of the membrane electrode assembly to an outer surface of the lid body; and a second wiring conductor having its one end disposed on the one surface of the lid body facing the second electrode of the membrane electrode assembly, and its other end led out toward the outer surface of the lid body.

2. The fuel cell casing of claim 1, wherein at least one of the first and second wiring conductors is formed around the opening of the first fluid channel disposed on the bottom surface of the concavity, or around the opening of the second fluid channel disposed on the one surface of the lid body, so as to abut against the first electrode or the second electrode.

3. The fuel cell casing of claim 1, further comprising:
a heating element for heating the one or other principal surface of the membrane electrode assembly, which is formed on the periphery of at least one of the opening of the first fluid channel disposed on the bottom surface of the concavity and the opening of the second fluid channel disposed on the one surface of the lid body.

4. The fuel cell casing of claim 1, further comprising:
a hygroscopic member which is coated on at least one of the inner surface of the first fluid channel and the inner surface of the second fluid channel.

5. The fuel cell casing of claim 1, further comprising:
a heat-insulating layer which is formed in at least one of a part of the base body and a part of the lid body, the parts being in a vicinity of the concavity.

6. The fuel cell casing of claim 1, further comprising:
a hydrophobic coating which is coated on at least one of the inner surface of the first fluid channel and the inner surface of the second fluid channel.

7. The fuel cell casing of claim 1, wherein at least one of the first and second wiring conductors is formed around the opening of the first fluid channel disposed on the bottom surface of the concavity, or around the opening of the second fluid channel disposed on the one surface of the lid body, so as to abut against the first or second electrode, and has its surface coated with a corrosion-resistant metal.

8. The fuel cell casing of claim 1, wherein the first wiring conductor is formed around the opening of the first fluid channel disposed on the bottom surface of the concavity so as to abut against the first electrode; in a part of the base body which is located on another surface side from the first wiring conductor is formed a third wiring conductor in parallel with the first wiring conductor; and a first connecting conductor is formed between the first fluid channels disposed in the base body, for connecting the first wiring conductor to the third wiring conductor,
and wherein the second wiring conductor is formed around the opening of the second fluid channel disposed on the one surface of the lid body so as to abut against the second electrode; in a part of the lid body which is located on another surface side from the second wiring conductor is formed a fourth wiring conductor in parallel with the second wiring conductor; and a second connecting conductor is formed between the second fluid channels disposed in the lid body, for connecting the second wiring conductor to the fourth wiring conductor.

9. The fuel cell casing of claim 1, wherein the first wiring conductor is formed around the opening of the first fluid channel disposed on the bottom surface of the concavity so as to abut against the first electrode; in a part of the base body which is located on another surface side from the first wiring conductor is formed a third wiring conductor in parallel with the first wiring conductor; and a first connecting conductor is formed on the inner circumferential surface of the first fluid channel disposed in the base body, for connecting the first wiring conductor to the third wiring conductor,
and wherein the second wiring conductor is formed around the opening of the second fluid channel disposed on the one surface of the lid body so as to abut against the second electrode; in a part of the lid body which is located on another surface side from the second wiring conductor is formed a fourth wiring conductor in parallel with the second wiring conductor; and a second connecting conductor is formed on the inner circumferential surface of the second fluid channel disposed in the lid body, for connecting the second wiring conductor to the fourth wiring conductor.

10. A fuel cell casing comprising:
a base body made of ceramics for housing therein at least a first electrode of a membrane electrode assembly, the membrane electrode assembly being made of a platy solid electrolyte having the first electrode and a second electrode which are formed on one principal surface and another principal surface thereof, respectively, in such a way that the solid electrolyte overhangs peripherally, the base body having a first concavity formed on one surface thereof, the first concavity having a placement portion formed in an outer periphery thereof for placing thereon an overhanging portion of the solid electrolyte; a first fluid channel formed so as to extend from a bottom surface of the first concavity facing the one principal surface of the membrane electrode assembly to an outer surface of the base body; a first wiring conductor having its one end disposed on the bottom surface of the first concavity facing the first electrode of the membrane electrode assembly, and its other end led out toward the outer surface of the base body;
a lid body mounted on the one surface of the base body near the first concavity so as to cover the first concavity, for housing therein the second electrode, the lid body having a second concavity formed on a bottom surface thereof, the second concavity having an abutment portion formed in an outer periphery thereof so as to abut against the overhanging portion, for allowing the overhanging portion to be grippingly interposed between the abutment portion and the placement portion, the lid body sealing the first concavity hermetically;
a second fluid channel formed so as to extend from one surface of the lid body facing the other principal surface of the membrane electrode assembly to an outer surface of the lid body; and a second wiring conductor having its one end disposed on the one surface of the lid body facing the second electrode of the membrane electrode assembly, and its other end led out toward the outer surface of the lid body.

11. The fuel cell casing of claim 10, wherein at least one of the first and second wiring conductors is formed around the opening of the first fluid channel disposed on the bottom surface of the first concavity, or around the opening of the second fluid channel disposed on a bottom surface of the second concavity, so as to abut against the first electrode or the second electrode.

12. The fuel cell casing of claim 10, further comprising:
a heating element for heating the one or other principal surface of the membrane electrode assembly, which is formed on the periphery of at least one of the opening of the first fluid channel disposed on the bottom surface of the first concavity and the opening of the second fluid channel disposed on the bottom surface of the second concavity.

13. The fuel cell casing of claim 10, further comprising:
a hygroscopic member which is coated on at least one of the inner surface of the first fluid channel and the inner surface of the second fluid channel.

14. The fuel cell casing of claim 10, further comprising:
a heat-insulating layer which is formed in at least one of a part of the base body which part is in a vicinity of the first concavity and a part of the lid body which part is in a vicinity of the second concavity.

15. A fuel cell casing comprising:
a base body made of ceramics for housing therein at least a first electrode of a membrane electrode assembly, the membrane electrode assembly being made of a platy solid electrolyte having the first electrode and a second electrode which are formed on one principal surface and another principal surface thereof, respectively, in such a way that the solid electrolyte overhangs peripherally, the base body having a concavity formed on one surface thereof, the concavity having a placement portion formed in an outer periphery thereof for placing thereon an overhanging portion of the solid electrolyte;
a first fluid channel formed so as to extend from a bottom surface of the concavity facing the one principal surface of the membrane electrode assembly to an outer surface of the base body; a first wiring conductor having its one end disposed on the bottom surface of the concavity facing the first electrode of the membrane electrode assembly, and its other end led out toward the outer surface of the base body;
a lid body mounted on the one surface of the base body near the concavity so as to cover the concavity, for air-tightly sealing the concavity;
a second fluid channel formed so as to extend from one surface of the lid body facing the other principal surface of the membrane electrode assembly to an outer surface of the lid body; and a second wiring conductor having its one end disposed on the one surface of the lid body facing the second electrode of the membrane electrode assembly, and its other end led out toward the outer surface of the lid body.

16. The fuel cell casing of claim 15, wherein at least one of the first and second wiring conductors is formed around the opening of the first fluid channel disposed on the bottom surface of the concavity, or around the opening of the second fluid channel disposed on the one surface of the lid body, so as to abut against the first or second electrode.

17. The fuel cell casing of claim 15, further comprising:
a heating element for heating the one or other principal surface of the membrane electrode assembly, which is formed on the periphery of at least one of the opening of the first fluid channel disposed on the bottom surface of the concavity and the opening of the second fluid channel disposed on the one surface of the lid body.

18. The fuel cell casing of claim 15, further comprising:
a hygroscopic member which is coated on at least one of the inner surface of the first fluid channel and the inner surface of the second fluid channel.

19. The fuel cell casing of claim 15, further comprising:
a heat-insulating layer which is formed in at least one of a part of the base body and a part of the lid body, the parts being in a vicinity of the concavity.

20. A fuel cell comprising:
a membrane electrode assembly having a first electrode and a second electrode disposed on one principal surface and another principal surface thereof, respectively; and
the fuel cell casing of claim 1,
wherein the membrane electrode assembly is housed in the concavity of the fuel cell casing, the one and other principal surfaces of the membrane electrode assembly are arranged such that fluid can be exchanged between the one and other principal surfaces and their corresponding first and second fluid channels, the first and second electrodes are electrically connected to the first and second wiring conductors, respectively, and the lid body is mounted on the one surface of the base body near the concavity so as to cover the concavity.

21. An electronic apparatus comprising:
the fuel cell of claim 20, acting as a power source,
wherein the base body is made of multi-layer ceramics, and an external connection terminal is formed in at least one of the base body and the lid body.

22. The electronic apparatus of claim 21, further comprising:
an internal circuit which is formed in the base body.

23. The electronic apparatus of claim 21, further comprising:
an electronic part which is formed on the surface of the base body so as to be electrically connected to the internal circuit.

24. The electronic apparatus of claim 21, further comprising:
a piezoelectric pump which is disposed partway along one of the first and second fluid channels.

25. A fuel cell comprising:
a membrane electrode assembly made of a platy solid electrolyte having a first electrode and a second electrode which are formed on one principal surface and another principal surface thereof, respectively, in such a way that the solid electrolyte overhangs peripherally; and
the fuel cell casing of claim 10,
wherein the membrane electrode assembly is placed on the placement portion of the fuel cell casing, the one and other principal surfaces of the membrane electrode assembly are arranged such that fluid can be exchanged between the one and other principal surfaces and their corresponding first and second fluid channels, the first and second electrodes are electrically connected to the first and second wiring conductors, respectively, and the lid body is mounted on the one surface of the base body near the first concavity so as to cover the first concavity.

26. An electronic apparatus comprising:
the fuel cell of claim 25, acting as a power source,
wherein the base body is made of multi-layer ceramics, and an external connection terminal is formed in at least one of the base body and the lid body.

27. The electronic apparatus of claim 26, further comprising:
an internal circuit which is formed in the base body.

28. The electronic apparatus of claim 26, further comprising:
an electronic part which is formed on the surface of the base body so as to be electrically connected to the internal circuit.

29. The electronic apparatus of claim 26, further comprising:
a piezoelectric pump which is disposed partway along one of the first and second fluid channels.

30. A fuel cell comprising:
a membrane electrode assembly made of a platy solid electrolyte having a first electrode and a second electrode which are formed on one principal surface and another principal surface thereof, respectively, in such a way that the solid electrolyte overhangs peripherally; and
the fuel cell casing of claim 15,
wherein the membrane electrode assembly is placed on the placement portion of the fuel cell casing, the one and other principal surfaces of the membrane electrode assembly are arranged such that fluid can be exchanged between the one and other principal surfaces and their corresponding first and second fluid channels, the first and second electrodes are electrically connected to the first and second wiring conductors, respectively, and the lid body is mounted on the one surface of the base body near the concavity so as to cover the concavity.

31. An electronic apparatus comprising:
the fuel cell of claim 30, acting as a power source,
wherein the base body is made of multi-layer ceramics, and an external connection terminal is formed in at least one of the base body and the lid body.

32. The electronic apparatus of claim 31, further comprising:
an internal circuit which is formed in the base body.

33. The electronic apparatus of claim 31, further comprising:
an electronic part which is formed on the surface of the base body so as to be electrically connected to the internal circuit.

34. The electronic apparatus of claim 31, further comprising:
a piezoelectric pump which is disposed partway along one of the first and second fluid channels.
